(19) United States
(12) Patent Application Publication
(10) Pub. No.: US 2026/0315317 A1
(43) Pub. Date: Oct. 15, 2026

(54) COMBINED MEDICAL CONTAINER CONTAINING LIQUID MEDICINE, MEDICAL CONTAINER SET, METHOD FOR PRODUCING CONTAINER CONTAINING LIQUID MEDICINE, AND METHOD FOR PRODUCING COMBINED MEDICAL CONTAINER CONTAINING LIQUID MEDICINE

(71) Applicant: DAI NIPPON PRINTING CO., LTD., Tokyo-to (JP)

(72) Inventors: Takuma BABA, Tokyo-to (JP); Yuto MOGI, Tokyo-to (JP); Noriko KUMAZAWA, Tokyo-to (JP); Noriko NAKATA, Tokyo-to (JP); Hiroyuki KOBORI, Tokyo-to (JP); Koichi TATSUMI, Tokyo-to (JP)

(73) Assignee: DAI NIPPON PRINTING CO., LTD., Tokyo-to (JP)

(21) Appl. No.: 19/116,621

(22) PCT Filed: Sep. 28, 2023
(86) PCT No.: PCT/JP2023/035549

§ 371 Date: Nov. 25, 2025

(30) Foreign Application Priority Data
Sep. 28, 2022 (JP) 2022-155598

(51) Int. Cl. A61J 1/06; A61J 1/05; A61J 1/14; A61J 1/16

(52) U.S. Cl. CPC A61J 1/065; A61J 1/05; A61J 1/14; A61J 1/16

(57) ABSTRACT

A combined medical container containing a liquid medicine includes a first container containing the liquid medicine, a second container with an oxygen barrier property and storing the first container, and an oxygen absorber for absorbing oxygen in the second container. The first container includes a container body with an opening portion and a stopper that closes the opening portion. A material constituting the stopper has a first oxygen permeability of 0.00010 (cc×mm/(mm²×day)) or more at a temperature of 23° C. and a relative humidity of 50%. The material constituting the stopper has a first water vapor permeability of 1.0 (mg×mm/(mm²×day)) or less at a temperature of 40° C. and a relative humidity of 90%.

### TECHNICAL FIELD

The present disclosure relates to a combined medical container containing a liquid medicine, a medical container set, a method for producing a container containing a liquid medicine, and a method for producing a medical container containing a liquid medicine.

### BACKGROUND ART

A liquid medicine is a medicine in liquid form. A liquid medicine contains a pharmaceutical ingredient and a liquid medium. A liquid medicine may be stored and distributed in a vial or a syringe. Due to their ease of use, vials and syringes are popular in medical practice.

A pharmaceutical ingredient is susceptible to quality deterioration due to degeneration caused by oxygen. A pharmaceutical ingredient in a liquid medicine is affected not only by oxygen gas in a container but also by oxygen dissolved in the liquid medium. It is also thought that a pharmaceutical ingredient that degenerates easily is handled in the form of a powder formed by lyophilization. A powdered pharmaceutical ingredient is less likely to degenerate. A powdered pharmaceutical ingredient needs to be mixed with a liquid medium to form a liquid medicine with a predetermined concentration before application to a patient. Thus, a pharmaceutical ingredient is preferably handled as a liquid medicine contained in a vial, a syringe, or the like.

As disclosed in Patent Literature 1 to Patent Literature 3, a combined container including a gas-permeable first container and a gas-impermeable second container is known. In this combined container, the first container is stored in the second container together with a deoxidizer. Oxygen in the first container permeates the first container and moves to the second container. The deoxidizer absorbs oxygen in the second container. This reduces the amount of oxygen in the first container. The combined container can suppress oxygen degradation of the content in the first container.
PTL 1: Japanese Unexamined Patent Application Publication No. 05-319459
PTL 2: Japanese Unexamined Patent Application Publication No. 2005-6737
PTL 3: Japanese Unexamined Patent Application Publication No. 04-200465

### SUMMARY OF INVENTION

It is conceivable to address the quality deterioration of a liquid medicine due to oxygen by storing the liquid medicine in a combined container. When an attempt is made to handle a liquid medicine using a combined container, however, quality deterioration occurs in the liquid medicine, which has not been a problem with other contents, such as food. An object of the present disclosure is to stably suppress the quality deterioration of a liquid medicine.

A first combined medical container containing a liquid medicine according to an embodiment of the present disclosure includes:
a first container containing the liquid medicine;
a second container storing the first container and having an oxygen barrier property; and
an oxygen absorber for absorbing oxygen in the second container,
wherein the first container includes a container body with an opening portion and a stopper that closes the opening portion,
a material constituting the stopper has a first oxygen permeability of 0.00010 (cc×mm/(mm²×day)) or more at a temperature of 23° C. and a relative humidity of 50%, and the material constituting the stopper has a first water vapor permeability of 1.0 (mg×mm/(mm²×day)) or less at a temperature of 40° C. and a relative humidity of 90%.

A second combined medical container containing a liquid medicine according to an embodiment of the present disclosure includes:
a first container containing the liquid medicine;
a second container storing the first container and having an oxygen barrier property; and
an oxygen absorber for absorbing oxygen in the second container,
wherein the first container has a second oxygen permeability of 0.010 (cc/day) or more at a temperature of 23° C. and a relative humidity of 50%, and
the first container has a second water vapor permeability of 20 (mg/day) or less at a temperature of 40° C. and a relative humidity of 90%.

A first medical container set according to an embodiment of the present disclosure includes:
a first container for containing a liquid medicine;
a second container for storing the first container, and
an oxygen absorber for absorbing oxygen in the second container,
wherein the second container has an oxygen barrier property,
the first container includes a container body with an opening portion and a stopper that closes the opening portion,
a material constituting the stopper has a first oxygen permeability of 0.00010 (cc×mm/(mm²×day)) or more at a temperature of 23° C. and a relative humidity of 50%, and
the material constituting the stopper has a first water vapor permeability of 1.0 (mg×mm/(mm²×day)) or less at a temperature of 40° C. and a relative humidity of 90%.

A second medical container set according to an embodiment of the present disclosure includes:
a first container for containing a liquid medicine;
a second container for storing the first container, and
an oxygen absorber for absorbing oxygen in the second container,
wherein the second container has an oxygen barrier property,
the first container has a second oxygen permeability of 0.010 (cc/day) or more in a first state at a temperature of 23° C. and a relative humidity of 50%, and
the first container has a second water vapor permeability of 20 (mg/day) or less in the first state at a temperature of 40° C. and a relative humidity of 90%.

A third medical container set according to an embodiment of the present disclosure includes:
a first container for containing a liquid medicine;
a second container for storing the first container, and
an oxygen absorber for absorbing oxygen in the second container,
wherein the second container has an oxygen barrier property,
the first container has a second oxygen permeability of 0.010 (cc/day) or more at a temperature of 23° C. and a relative humidity of 50%, and
the first container has a second water vapor permeability of 20 (mg/day) or less at a temperature of 40° C. and a relative humidity of 90%.

A first method for producing a combined medical container containing a liquid medicine according to an embodiment of the present disclosure is
a method for producing a combined medical container containing a liquid medicine according to an embodiment of the present disclosure, the method including:
closing the opening portion of the container body of the first container containing the liquid medicine with a stopper to prepare the first container containing the liquid medicine; and
storing the first container containing the liquid medicine in the second container.

A second method for producing a combined medical container containing a liquid medicine according to an embodiment of the present disclosure is
a method for producing a combined medical container containing a liquid medicine according to the embodiment of the present disclosure, the method including:
storing the first container in the second container; and
closing the second container.

A method for producing a container containing a liquid medicine according to an embodiment of the present disclosure is
a method for producing a container containing a liquid medicine using a combined medical container containing a liquid medicine according to the embodiment of the present disclosure, the method including:
closing the second container storing the first container;
absorbing oxygen in the second container with the oxygen absorber to adjust an oxygen concentration; and
covering the stopper of the first container with a second stopper, or closing the opening portion with a second stopper with an oxygen barrier property instead of the stopper of the first container,
wherein in the step of adjusting the oxygen concentration, oxygen in the first container permeates the first container, moves to an outside of the first container, and is absorbed by the oxygen absorber in the second container.

The present disclosure can stably suppress the quality deterioration of a liquid medicine.

### BRIEF DESCRIPTION OF DRAWINGS

FIG. 1A is an explanatory view of an embodiment of the present disclosure and is a front view of an example of a combined medical container containing a liquid medicine.

FIG. 1B is a longitudinal sectional view of the combined medical container containing a liquid medicine illustrated in FIG. 1A.

FIG. 1C is a longitudinal sectional view of an example of a first container containing a liquid medicine that can be included in the combined medical container containing a liquid medicine illustrated in FIG. 1A.

FIG. 1D is a view of a modification example of the arrangement of the first container in the combined medical container containing a liquid medicine illustrated in FIG. 1A.

FIG. 1E is a view of a modification example of a seal portion of the combined medical container containing a liquid medicine illustrated in FIG. 1A.

FIG. 2A is an explanatory view of a method for measuring the first oxygen permeability.

FIG. 2B is an explanatory view of a method for measuring the first water vapor permeability.

FIG. 2C is a chemical formula of a siloxane bond with a chain structure.

FIG. 2D is a chemical formula of a siloxane bond with a cyclic structure.

FIG. 2E is a graph of an example of an IR spectrum obtained by ATR-IR.

FIG. 2F is an explanatory view of a method for measuring the oxygen permeability of a stopper.

FIG. 3A is a view of an example of a syringe as a first container that can be included in a combined medical container containing a liquid medicine.

FIG. 3B is a view of another example of a syringe as a first container that can be included in a combined medical container containing a liquid medicine.

FIG. 3C is a view of still another example of a syringe as a first container that can be included in a combined medical container containing a liquid medicine.

FIG. 3D is a partial cross-sectional view of a specific example of the syringe illustrated in FIG. 3C.

FIG. 4A is a front view of an example of a second container.

FIG. 4B is a front view of another example of the second container.

FIG. 4C is a perspective view of still another example of the second container.

FIG. 4D is a perspective view of still another example of the second container.

FIG. 4E is a perspective view of still another example of the second container.

FIG. 4F is a perspective view of still another example of the second container.

FIG. 5A is a cross-sectional view of an example of an oxygen-absorbing member containing an oxygen absorber.

FIG. 5B is a cross-sectional view of an example of an oxygen-absorbing film containing an oxygen absorber.

FIG. 5C is a cross-sectional view of another example of an oxygen-absorbing member containing an oxygen absorber.

FIG. 6A is a view of an example of a method for producing the combined medical container containing a liquid medicine and the first container containing a liquid medicine illustrated in FIGS. 1A to 1C.

FIG. 6B is a view of an example of a method for producing the combined medical container containing a liquid medicine and the first container containing a liquid medicine illustrated in FIGS. 1A to 1C.

FIG. 6C is a view of an example of a method for producing the combined medical container containing a liquid medicine and the first container containing a liquid medicine illustrated in FIGS. 1A to 1C.

FIG. 7A is an explanatory view of a modification example of a method for producing a combined medical container containing a liquid medicine and a first container containing a liquid medicine.

FIG. 7B is an explanatory view of another modification example of a method for producing a combined medical container containing a liquid medicine and a first container containing a liquid medicine.

FIG. 8A is an explanatory view of still another modification example of a method for producing a combined medical container containing a liquid medicine and a first container containing a liquid medicine.

FIG. 8B is an explanatory view of still another modification example of a method for producing a combined medical container containing a liquid medicine and a first container containing a liquid medicine.

FIG. 9 is a view of a method of using the first container containing a liquid medicine in FIG. 1C.

FIG. 10A is an explanatory view of a method for measuring the second oxygen permeability of a stopper.

FIG. 10B is an explanatory view of a method for measuring the second oxygen permeability of a container body.

FIG. 10C is an explanatory view of a method for measuring the second water vapor permeability of a stopper.

FIG. 10D is an explanatory view of a method for measuring the second water vapor permeability of a container body.

FIG. 10E is an explanatory view of a method for measuring the second water vapor permeability of a container body.

FIG. 11A is a longitudinal sectional view of an example of a first container in a second embodiment.

FIG. 11B is a longitudinal sectional view of another example of the first container in the second embodiment.

FIG. 12A is a view of an example of a layer configuration of a laminate that can be used for a second container.

FIG. 12B is a view of another example of a layer configuration of a laminate that can be used for the second container.

FIG. 12C is a view of still another example of a layer configuration of a laminate that can be used for the second container.

FIG. 12D is a view of still another example of a layer configuration of a laminate that can be used for the second container.

FIG. 12E is a view of still another example of a layer configuration of a laminate that can be used for the second container.

FIG. 12F is a view of still another example of a layer configuration of a laminate that can be used for the second container.

### DESCRIPTION OF EMBODIMENTS

Embodiments of the present disclosure relate to the following [1] to [36].

[1] A combined medical container containing a liquid medicine, including:
a first container containing the liquid medicine;
a second container storing the first container and having an oxygen barrier property; and
an oxygen absorber for absorbing oxygen in the second container,
wherein the first container includes a container body with an opening portion and a stopper that closes the opening portion,
a material constituting the stopper has a first oxygen permeability of 0.00010 (cc×mm/(mm²×day)) or more at a temperature of 23° C. and a relative humidity of 50%, and
the material constituting the stopper has a first water vapor permeability of 1.0 (mg×mm/(mm²×day)) or less at a temperature of 40° C. and a relative humidity of 90%.
   [2] The combined medical container containing a liquid medicine according to [1], wherein the stopper has a type A durometer hardness of 25 or more and 60 or less.
   [3] The combined medical container containing a liquid medicine according to [1] or [2], wherein the stopper has a type A durometer hardness of 25 or more and 45 or less.
   [4] The combined medical container containing a liquid medicine according to any one of [1] to [4], wherein a portion of the stopper facing the opening portion has an average thickness of 0.5 mm or more and 10 mm or less.
   [5] The combined medical container containing a liquid medicine according to any one of [1] to [3], wherein the opening portion has an area of 25 mm² or more and 1000 mm² or less.
   [6] The combined medical container containing a liquid medicine according to any one of [1] to [5], wherein the stopper contains a compound with a main backbone of a siloxane bond.
   [7] The combined medical container containing a liquid medicine according to any one of [1] to [6], wherein
the first container includes a vial, and
the container body includes a glass bottle.
   [8] The combined medical container containing a liquid medicine according to any one of [1] to [7], wherein
the first container includes a syringe, and
the syringe includes a cylinder that contains the liquid medicine and constitutes the container body, and a piston that is inserted into the cylinder.
   [9] The combined medical container containing a liquid medicine according to [8], wherein the piston includes a gasket that is inserted into the cylinder and constitutes the stopper.
   [10] The combined medical container containing a liquid medicine according to [8], wherein
the cylinder includes a cylinder body into which the piston is inserted, and a needle that is coupled to the cylinder body and has the opening portion, and
the stopper is punctured with the needle and closes the opening portion of the needle.
   [11] The combined medical container containing a liquid medicine according to [8], wherein
the cylinder includes a cylinder body into which the piston is inserted and that has the opening portion, and a needle that can be fixed to the cylinder body to cover the opening portion, and
the stopper is fixably attached to the cylinder body to close the opening portion.
   [12] The combined medical container containing a liquid medicine according to any one of [1] to [11], wherein
the first container has a second oxygen permeability of 0.010 (cc/day) or more in a first state at a temperature of 23° C. and a relative humidity of 50%, and
the first container has a second water vapor permeability of 20 (mg/day) or less in the first state at a temperature of 40° C. and a relative humidity of 90%.
   [13] The combined medical container containing a liquid medicine according to any one of [1] to [12], wherein
the first container has a second oxygen permeability of 0.010 (cc/day) or more at a temperature of 23° C. and a relative humidity of 50%, and
the first container has a second water vapor permeability of 20 (mg/day) or less at a temperature of 40° C. and a relative humidity of 90%.
   [14] A combined medical container containing a liquid medicine, including:
a first container containing the liquid medicine;
a second container storing the first container and having an oxygen barrier property; and
an oxygen absorber for absorbing oxygen in the second container,
wherein the first container has a second oxygen permeability of 0.010 (cc/day) or more in a first state at a temperature of 23° C. and a relative humidity of 50%, and
the first container has a second water vapor permeability of 20 (mg/day) or less in the first state at a temperature of 40° C. and a relative humidity of 90%.
   [15] A combined medical container containing a liquid medicine, including:
a first container containing the liquid medicine;
a second container storing the first container and having an oxygen barrier property; and
an oxygen absorber for absorbing oxygen in the second container,
wherein the first container has a second oxygen permeability of 0.010 (cc/day) or more at a temperature of 23° C. and a relative humidity of 50%, and
the first container has a second water vapor permeability of 20 (mg/day) or less at a temperature of 40° C. and a relative humidity of 90%.
   [16] The combined medical container containing a liquid medicine according to [14] or [15], wherein the first container includes a container body with an opening portion, a stopper at least partially covering the opening portion, and a cover covering the stopper.
   [17] The combined medical container containing a liquid medicine according to [16], wherein the stopper contains butyl rubber.
   [18] The combined medical container containing a liquid medicine according to [16] or [17], wherein
a material constituting the cover has a first oxygen permeability of 0.00010 (cc×mm/(mm²×day)) or more at a temperature of 23° C. and a relative humidity of 50%, and
the material constituting the cover has a first water vapor permeability of 1.0 (mg×mm/(mm²×day)) or less at a temperature of 40° C. and a relative humidity of 90%.
   [19] The combined medical container containing a liquid medicine according to any one of [14] to [18], wherein
the first container includes a container body with an opening portion and a stopper that closes the opening portion,
a material constituting the container body has a first oxygen permeability of 0.00010 (cc×mm/(mm²×day)) or more at a temperature of 23° C. and a relative humidity of 50%, and
the material constituting the container body has a first water vapor permeability of 1.0 (mg×mm/(mm²×day)) or less at a temperature of 40° C. and a relative humidity of 90%.
   [20] A combined medical container containing a liquid medicine, including:
a first container containing a liquid medicine and having oxygen permeability; and
a second container storing the first container and having an oxygen barrier property,
wherein the second container includes a laminate,
the laminate includes an inner surface facing a storage space of the second container and an outer surface opposite the inner surface, and
the laminate includes a sealant layer, a first barrier layer, a resin layer, and a second barrier layer in this order from the inner surface to the outer surface.
   [21] A combined medical container containing a liquid medicine, including:
a first container containing a liquid and having oxygen permeability; and
a second container storing the first container and having an oxygen barrier property; and
an oxygen-absorbing member stored in the second container,
wherein the oxygen-absorbing member contains an oxygen absorber for absorbing oxygen in the second container,
the second container includes a first film and a second film that stores the first container between the first film and the second film,
the first film and the second film are bonded together at a seal portion,
the seal portion includes a first seal portion facing the first container,
the first seal portion is bent so as to protrude toward a side away from the first container in a direction in which the first seal portion and the first container face each other, and
the first container is located between the first seal portion and the oxygen-absorbing member in the direction in which the first seal portion and the first container face each other.
   [22] The combined medical container containing a liquid medicine according to [21], wherein
the second container is bent with the second film inside so that a first portion of the second container storing the first container and a second portion of the second container overlap,
the second portion is located on one side of the first portion in the direction in which the first seal portion and the first container face each other in a state where the second container before being bent is unfolded, and
the oxygen-absorbing member is bent together with the second container such that an intermediate portion of the oxygen-absorbing member is located on the bent top portion (bent apex portion) of the second film.
   [23] The combined medical container containing a liquid medicine according to [22], wherein
the second container is bent with the second film inside so that the first portion and a third portion of the second container overlap,
the third portion is located on the other side of the first portion in the direction in which the first seal portion and the first container face each other in a state where the second container before being bent is unfolded, and
the first portion, the third portion, and the second portion overlap in this order.
   [24] The combined medical container containing a liquid medicine according to any one of [21] to [23], further including
an outer case for storing the second container,
wherein the second container stores the first container and the oxygen-absorbing member such that one of the stopper and the container body is close to the first seal portion and the other of the stopper and the container body is close to the oxygen-absorbing member,
the second container is bent with the second film inside so that a first portion of the second container storing the first container and a second portion of the second container overlap,
the second container is bent with the second film inside so that the first portion and a third portion of the second container overlap,
the first portion is located between the second portion and the third portion in a state where the second container before being bent is unfolded,
the outer case includes a bottom portion, a top portion facing the bottom portion, and a side wall portion between the bottom portion and the top portion, and
the second container folded such that the first portion, the second portion, and the third portion overlap is stored in the outer case such that the container body of the first container faces the bottom portion of the outer case and the stopper of the first container faces the top portion of the outer case.
   [25] A medical container set including:
a first container for containing a liquid medicine;
a second container for storing the first container, and
an oxygen absorber for absorbing oxygen in the second container,
wherein the second container has an oxygen barrier property,
the first container includes a container body with an opening portion and a stopper that closes the opening portion,
a material constituting the stopper has a first oxygen permeability of 0.00010 (cc×mm/(mm²×day)) or more at a temperature of 23° C. and a relative humidity of 50%, and
the material constituting the stopper has a first water vapor permeability of 1.0 (mg×mm/(mm²×day)) or less at a temperature of 40° C. and a relative humidity of 90%.
   [26] A medical container set including:
a first container for containing a liquid medicine;
a second container for storing the first container, and
an oxygen absorber for absorbing oxygen in the second container,
wherein the second container has an oxygen barrier property,
the first container has a second oxygen permeability of 0.010 (cc/day) or more in a first state at a temperature of 23° C. and a relative humidity of 50%, and
the first container has a second water vapor permeability of 20 (mg/day) or less in the first state at a temperature of 40° C. and a relative humidity of 90%.
   [27] A medical container set including:
a first container for containing a liquid medicine;
a second container for storing the first container, and
an oxygen absorber for absorbing oxygen in the second container,
wherein the second container has an oxygen barrier property,
the first container has a second oxygen permeability of 0.010 (cc/day) or more at a temperature of 23° C. and a relative humidity of 50%, and
the first container has a second water vapor permeability of 20 (mg/day) or less at a temperature of 40° C. and a relative humidity of 90%.
   [28] A medical container set including:
a first container for containing a liquid; and
a second container for storing the first container,
wherein the first container has oxygen permeability,
the second container has an oxygen barrier property,
the second container includes a laminate,
the laminate includes an inner surface facing a storage space of the second container and an outer surface opposite the inner surface, and
the laminate includes a sealant layer, a first barrier layer, a resin layer, and a second barrier layer in this order from the inner surface to the outer surface.
   [29] A medical container set including:
a first container for containing a liquid;
a second container for storing the first container, and
an oxygen-absorbing member stored in the second container,
wherein the first container has oxygen permeability,
the second container has an oxygen barrier property,
the oxygen-absorbing member contains an oxygen absorber for absorbing oxygen in the second container,
the second container includes a first film and a second film that stores the first container between the first film and the second film,
the first film and the second film are bonded together at a seal portion,
the seal portion includes a first seal portion facing the first container,
the first seal portion is bent so as to protrude toward a side away from the first container in a direction in which the first seal portion and the first container face each other, and
the first container is located between the first seal portion and the oxygen-absorbing member in the direction in which the first seal portion and the first container face each other.
   [30] A medical container set including:
a first container for containing a liquid; and
a second container for storing the first container,
wherein the first container has oxygen permeability,
the second container has an oxygen barrier property,
the second container includes a first film and a second film that stores the first container between the first film and the second film,
the first film and the second film are bonded together at a seal portion,
the seal portion includes a first seal portion facing the first container,
the first seal portion is bent so as to protrude toward a side away from the first container in a direction in which the first seal portion and the first container face each other, and
the seal portion further includes a first side seal portion coupled to one end of the first seal portion, a second side seal portion coupled to the other end of the first seal portion, and an additional seal portion between the first container and at least one of the first side seal portion or the second side seal portion.
   [31] A method for producing the combined medical container containing a liquid medicine according to any one of [1] to [24], the method including the steps of:
closing the opening portion of the container body of the first container containing the liquid medicine with a stopper to prepare the first container containing the liquid medicine; and
storing the first container containing the liquid medicine in the second container.
   [32] A method for producing the combined medical container containing a liquid medicine according to any one of [1] to [24], the method including the steps of:
storing the first container in the second container; and
closing the second container.
   [33] A method for producing a container containing a liquid medicine using the combined medical container containing a liquid medicine according to any one of [1] to [24], the method including the steps of:
closing the second container storing the first container; and
absorbing oxygen in the second container with the oxygen absorber to adjust an oxygen concentration,
wherein in the step of adjusting the oxygen concentration, oxygen in the first container permeates the first container, moves to an outside of the first container, and is absorbed by the oxygen absorber in the second container.
   [34] A method for producing a container containing a liquid medicine using the combined medical container containing a liquid medicine according to any one of [1] to [24], the method including the steps of:
closing the second container storing the first container;
absorbing oxygen in the second container with the oxygen absorber to adjust an oxygen concentration; and
covering the stopper of the first container with a second stopper, or closing the opening portion of the container body with a second stopper with an oxygen barrier property instead of the stopper of the first container,
wherein in the step of adjusting the oxygen concentration, oxygen in the first container permeates the first container, moves to an outside of the first container, and is absorbed by the oxygen absorber in the second container.
   [35] A container comprising:
a laminate,
wherein the laminate includes a sealant layer, a first barrier layer, a resin layer, and a second barrier layer in this order from the inner surface to the outer surface.
   [36] A laminate for use in a container, comprising:
a sealant layer, a first barrier layer, a resin layer, and a second barrier layer in this order from the inner surface to the outer surface.

Embodiments of the present disclosure are described below with reference to the accompanying drawings. In the accompanying drawings of the present description, for the sake of illustration and clarity, the scale, the aspect ratio, and the like are appropriately changed and exaggerated from those of real things. Configurations and the like shown in some of the drawings may be omitted in other drawings. In the following description and the drawings used in the following description, the same reference numerals and letters are used for portions that can be configured in common among the illustrated examples, and redundant description is omitted.

Terms, such as “parallel”, “perpendicular”, and “the same”, lengths, angles, and the like in the present description to specify shapes, geometric conditions, and degrees thereof do not necessarily have their strict meanings and are interpreted to include ranges in which similar functions can be expected.

In the present description, when a plurality of upper limit candidates and a plurality of lower limit candidates are described for a certain parameter, the numerical range of the parameter may be configured by combining any one of the upper limit candidates and any one of the lower limit candidates. As an example, consider the description “The parameter B may be A1 or more, A2 or more, or A3 or more. The parameter B may be A4 or less, A5 or less, or A6 or less.” In this example, the numerical range of the parameter B may be A1 or more and A4 or less, A1 or more and A5 or less, A1 or more and A6 or less, A2 or more and A4 or less, A2 or more and A5 or less, A2 or more and A6 or less, A3 or more and A4 or less, A3 or more and A5 or less, or A3 or more and A6 or less.

“Suppress” means to suppress realization, occurrence, or the like, or to prevent realization, occurrence, or the like. “Suppress” means not only completely preventing realization, occurrence, or the like, but also reducing the possibility of realization, occurrence, or the like, making realization, occurrence, or the like less likely to occur, and the like.

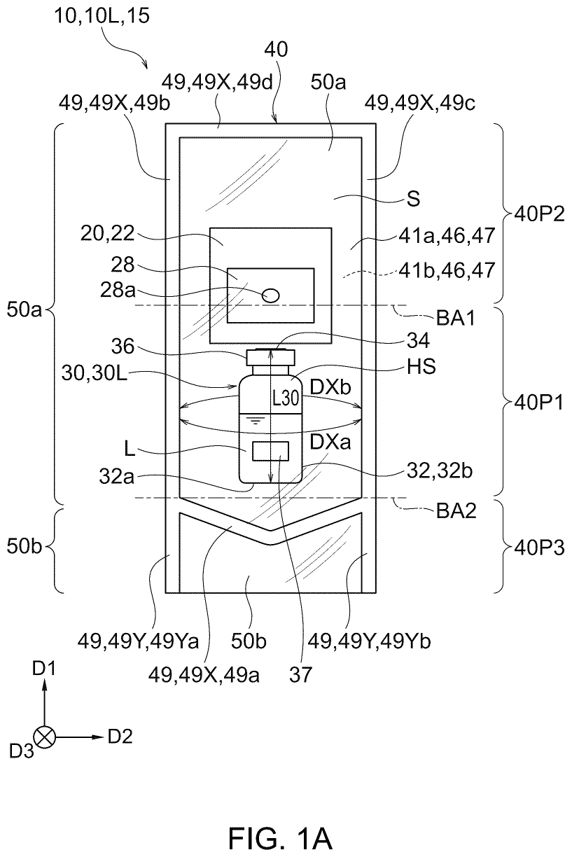

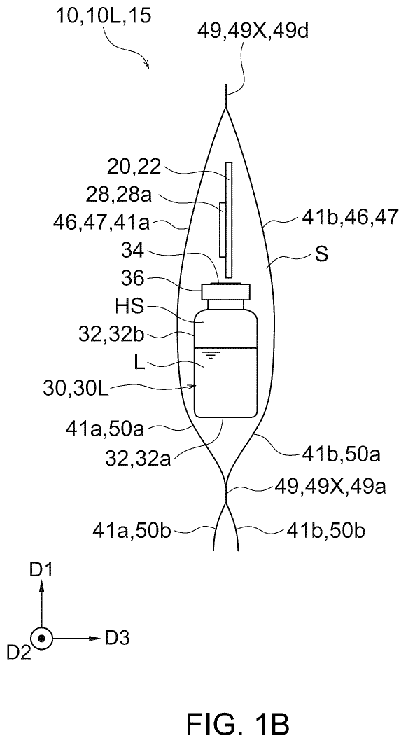

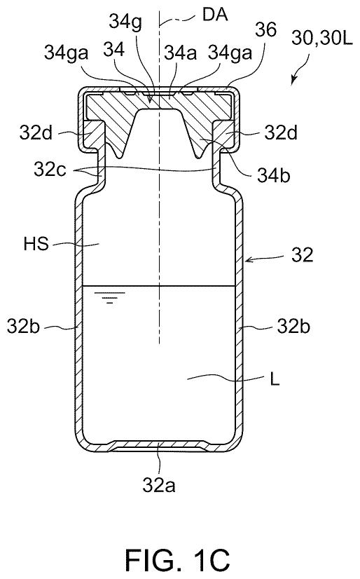

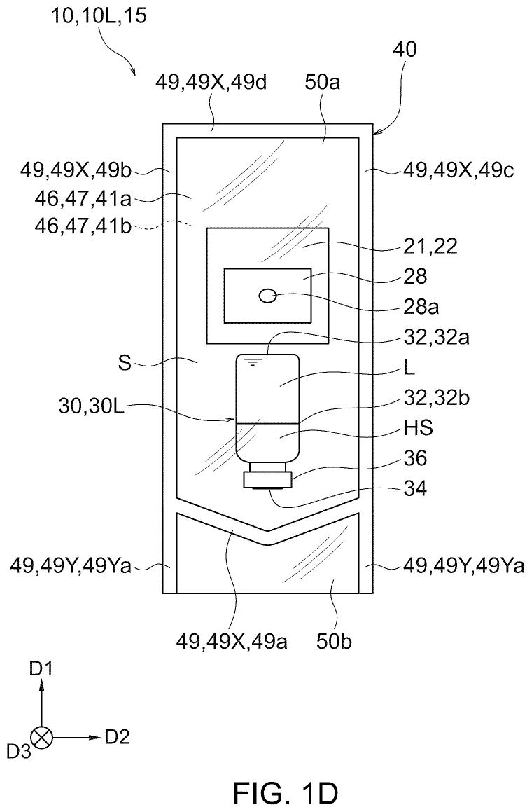

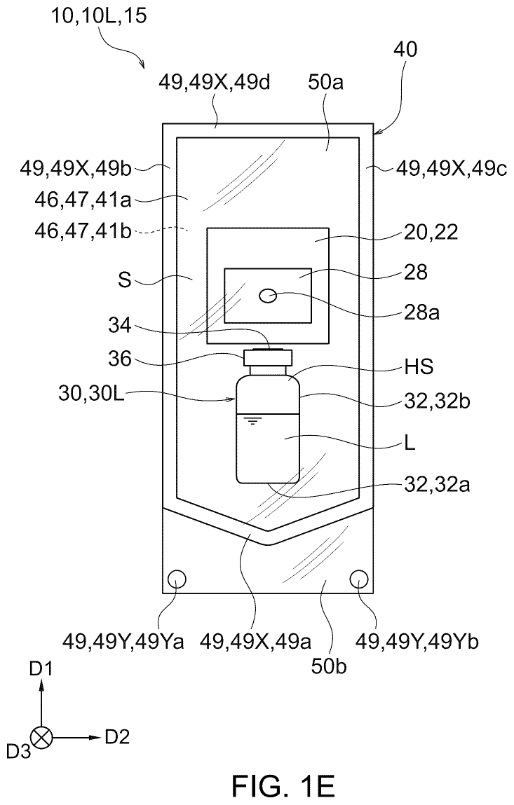

FIGS. 1A to 12F are explanatory views of embodiments of the present disclosure. The medical container set includes a first container, a second container, and an oxygen absorber. The first container containing a liquid medicine includes the first container and a liquid medicine L contained in the first container. The first container containing a liquid medicine is also referred to as a container containing a liquid medicine or a medical container containing a liquid medicine. The first container has oxygen permeability. Oxygen can permeate the first container. The first container includes a portion through which oxygen can at least partially permeate. The second container has an oxygen barrier property. The second container has a storage space S that can store the first container containing a liquid medicine. The combined medical container containing a liquid medicine includes the first container containing a liquid medicine and the second container, and the first container containing a liquid medicine is stored in the second container.

In the combined medical container containing a liquid medicine, the oxygen absorber absorbs oxygen in the second container. The oxygen absorber reduces the concentration of oxygen (%) in a second container 40. When the concentration of oxygen in the second container decreases, oxygen in the first container permeates the first container and moves from the first container to the second container. The movement of oxygen from the first container to the second container reduces the amount of oxygen in the first container. The oxygen absorber maintains the concentration of oxygen (%) in the second container 40 in a lowered state. The amount of oxygen in the first container is maintained in a lowered state. Thus, the combined medical container containing a liquid medicine can suppress the degradation of the liquid medicine in the first container caused by oxygen.

The liquid medicine is a medicine in liquid form. The medicine is intended to be used in the diagnosis, treatment, or prevention of a disease of a human or an animal and is not machinery, instruments, or the like. The medicine may affect the structure or function of the human or animal body. The medicine includes a pharmaceutical agent defined by the Japanese Pharmaceutical Affairs Law or a law or a system in a country other than Japan. The liquid medicine may include a liquid medium. The liquid medicine may contain a pharmaceutical ingredient and a liquid medium. The liquid medium may be a pharmaceutical ingredient. The pharmaceutical ingredient may be an ingredient, compound, article, or the like that may affect the structure or function of the human or animal body. The liquid medium is a medium in which the pharmaceutical ingredient is dispersed. The pharmaceutical ingredient may be dissolved in the liquid medium. The pharmaceutical ingredient may not be dissolved in the liquid medium. The liquid medium may be a liquid. The liquid medium may be a dispersion medium. The dispersion medium may be a liquid material containing a dispersoid, which is dispersed particles. The dispersion medium may include one or more of a sol, a gel, a suspension, and an emulsion.

The liquid medium may be water. The liquid medium may be physiological saline. The liquid medicine L may include two or more liquid media. The liquid medium may be an aqueous liquid medium. The aqueous liquid medium refers to a liquid medium in which the main component with the highest volume ratio is water. The liquid medium may include a non-aqueous liquid medium. The non-aqueous liquid medium refers to a liquid medium in which the main component with the highest volume ratio is other than water. The non-aqueous liquid medium can be used to suppress the hydrolysis of a pharmaceutical ingredient. The non-aqueous liquid medium can be used to impart stability to a pharmaceutical ingredient. The liquid medium other than water is, for example, an alcohol, such as ethanol, poly(ethylene glycol), propylene glycol, glycerin, benzyl alcohol, or N,N-dimethylacetamide. The liquid medium may contain water, poly(ethylene glycol), and the like.

The liquid medicine L may contain one or more of a pH adjuster, a solubilizer, a stabilizer, a surfactant, an antifoaming agent, a solubilizer, a dissolution aid, a dispersant, a preservative, and the like.

The liquid medicine L may be a RTU (Ready To Use) preparation or a RTD (Ready To Dilute) preparation. The liquid medicine L as RTU and RTD is easy to use because preparation before application to a patient can be omitted. The liquid medicine L may be an injection to be administered to a patient using an injector. The injection includes an liquid medicine used for drip infusion. The injection to which the liquid medicine L is applied may be any of intravenous injection, intramuscular injection, and subcutaneous injection. The liquid medicine L may be administered by injection intravascularly, intraperitoneally, intrathecally, intraventricularly, intraurethrally, intrasternally, intracranially, or the like.

A liquid medicine may typically be stored and distributed in a vial or a syringe. Due to their ease of use, vials and syringes are popular in medical practice. A vial or a syringe containing a small amount of liquid medicine is particularly easy to handle the liquid medicine. For example, a liquid medicine in a syringe does not require special preparation and can be used as it is for a patient or the like. A liquid medicine in a vial is transferred into a syringe by puncturing a rubber stopper of the vial with a needle of the syringe and is then used for a patient or the like.

A pharmaceutical ingredient is susceptible to quality deterioration due to degeneration caused by oxygen. For a liquid medicine contained in a small amount in a vial, a syringe, or the like, a slight degeneration can have a serious influence on the quality of the liquid medicine. A pharmaceutical ingredient in a liquid medicine is affected not only by oxygen gas in a container but also by oxygen dissolved in the liquid medium. It is also thought that a pharmaceutical ingredient that degenerates easily is handled in the form of a powder by lyophilization. A powdered pharmaceutical ingredient is less likely to degenerate. A powdered pharmaceutical ingredient needs to be mixed with a liquid medium to form a liquid medicine with a predetermined concentration before application to a patient. This operation also increases the preparation time before the medicine is administered to a patient. Thus, a pharmaceutical ingredient is preferably handled as a liquid medicine contained in a vial, a syringe, or the like.

In such a background, from the perspective of suppressing oxygen degradation of the liquid medicine L, application of the medical container set including the first container, the second container, and the oxygen absorber to the liquid medicine was studied. That is, handling of the liquid medicine L using the combined medical container containing a liquid medicine was studied.

A pharmaceutical ingredient is more susceptible to oxygen degradation than foods and the like. Furthermore, the range in which degeneration of a pharmaceutical ingredient due to oxygen or the like is allowed is significantly narrower than that of foods and the like. From these perspectives, very high oxygen permeability should be imparted to the first container. However, as the oxygen permeates the first container and moves to the second container, the liquid medium may evaporate. When oxygen can permeate the first container, in general, another gas containing the vapor of the liquid medium, for example, water vapor, can also permeate the first container. That is, water vapor generated by evaporation of the liquid medium can also permeate the first container and move to the second container.

A decrease in the amount of the liquid medium of the liquid medicine in the first container results in a change in the concentration of the pharmaceutical ingredient in the liquid medicine and a change in the hydrogen ion concentration pH of the liquid medicine. Thus, there is a concern about the quality deterioration of the pharmaceutical ingredient in the liquid medicine.

In general, the concentration and the like of a pharmaceutical ingredient in a liquid medicine are strictly controlled. A change in the concentration of a pharmaceutical ingredient in a liquid medicine may cause degeneration of the pharmaceutical ingredient. A change in the hydrogen ion concentration of a liquid medicine may result in a change in the degradability and solubility of a pharmaceutical ingredient and also a change in the structure of the pharmaceutical ingredient. Thus, it can be assumed that the expected efficacy of a pharmaceutical ingredient is not achieved. Furthermore, the administration conditions and the like of a liquid medicine are determined based on a predetermined control concentration. Thus, for a liquid medicine with a change in concentration or the like, it is necessary to measure the concentration and to review the administration conditions.

When the liquid medicine contains a non-aqueous liquid medium, water vapor in the second container may move into the first container. In this case, the pharmaceutical ingredient dispersed in a non-aqueous solvent may be hydrolyzed by water transferred into the first container.

The degeneration of the liquid medicine due to water vapor permeation becomes remarkable when the first container contains only a small amount of the liquid medicine. Thus, when a vial or a syringe is used as the first container, a small amount of the liquid medicine in the first container is susceptible to quality deterioration. Thus, for a liquid medicine contained in a small amount in a vial, a syringe, or the like, a slight degeneration can have a serious influence on the quality of the liquid medicine.

As a result of the studies conducted by the present inventors as described above, it has been found that, in the use of a combined container including a first container, a second container, and an oxygen absorber, there is a problem specific to a liquid medicine, which has not been a problem in foods and the like. In particular, when an attempt is made to impart high oxygen permeability to a first container for storing a liquid medicine that is susceptible to oxygen degradation, to promote oxygen permeation, and to more effectively suppress oxygen degradation of the liquid medicine, quality deterioration of the liquid medicine due to water vapor permeation becomes more significant. Thus, to apply a combined container to a liquid medicine and handle the liquid medicine as a combined medical container containing the liquid medicine, it is necessary to address two problems, that is, suppression of degradation due to oxygen and suppression of degradation due to water vapor, which are contradictory to each other in terms of solution means. Thus, in a combined medical container applied to a liquid medicine, it is necessary to impart, to a first container for storing the liquid medicine, characteristics that are usually contradictory to each other, such as promotion of oxygen permeation and suppression of water vapor permeation.

As a result of extensive studies for the purpose of solving such problems, it has been found that permeation characteristics capable of sufficiently promoting oxygen permeation and sufficiently suppressing water vapor permeation can be imparted to a stopper included in a first container, and the stopper to which such permeability is imparted can be used to suppress the quality deterioration of a liquid medicine. A first embodiment is based on such a finding.

More specifically, in the first embodiment, the first container includes a container body with an opening portion, and a stopper that closes the opening portion. A material constituting the stopper has a first oxygen permeability of 0.00010 (cc×mm/(mm²×day)) or more at a temperature of 23° C. and a relative humidity of 50%. The material constituting the stopper has a first water vapor permeability of 1.0 (mg×mm/(mm²×day)) or less at a temperature of 40° C. and a relative humidity of 90%.

In a medical container set and a combined medical container containing a liquid medicine according to the first embodiment, the oxygen permeation through the first container is promoted due to the first oxygen permeability. That is, the movement of oxygen from the first container into the second container maintained in a low oxygen state by an oxygen absorber is promoted. This decreases the concentration of oxygen (%) in the first container and decreases the amount of oxygen dissolved in the liquid medicine (mg/L). This can suppress the degradation of the liquid medicine L due to oxygen. Furthermore, the water vapor permeation through the first container is suppressed due to the first water vapor permeability. This can suppress a change in the concentration of a pharmaceutical ingredient and a change in the hydrogen ion concentration of the liquid medicine L containing the aqueous liquid medium. This can suppress the hydrolysis of the pharmaceutical ingredient dispersed in a non-aqueous liquid medium. Thus, the first embodiment can stably suppress both the oxygen degradation of the liquid medicine L and the quality deterioration of the liquid medicine L due to water vapor permeation.

In the first embodiment, the first oxygen permeability and the first water vapor permeability in predetermined ranges are imparted to the stopper. Thus, in handling the first container, the quality of the combined medical container containing a liquid medicine can be stably managed by observing the state of the stopper, for example, by making the stopper observable from a transparent second container.

As a result of extensive studies, the present inventors have found that the first oxygen permeability and the first water vapor permeability in predetermined ranges can be imparted to the stopper, and at the same time characteristics suitable for use as a medical container can be imparted to the stopper. As an example, a stopper applied to a medical container is required to have a high level of sealability, suitability for puncture with an injection needle, and temperature resistance in consideration of heat sterilization of the stopper and cold storage of a liquid medicine. It has been found that these characteristics required for a stopper of a medical container and the first oxygen permeability and the first water vapor permeability in predetermined ranges can be imparted to the stopper.

In the first embodiment, since the stopper has a predetermined permeability, it is not necessary to adjust the permeability of the container body of the first container. Thus, a container body that has been widely used as a medical container and has high reliability can be used as a container body 32. This makes it possible to more stably manage the quality of the combined medical container containing a liquid medicine.

On the other hand, it has been found that the first container as a whole having a second oxygen permeability in a predetermined range and a second water vapor permeability in a predetermined range can also suppress the quality deterioration of a liquid medicine. A second embodiment is based on such a finding.

More specifically, in the second embodiment, the first container has the following permeability. The first container has a second oxygen permeability of 0.010 (cc/day) or more at a temperature of 23° C. and a relative humidity of 50%. The first container has a second water vapor permeability of 20 (mg/day) or less at a temperature of 40° C. and a relative humidity of 90%.

In a medical container set and a combined medical container containing a liquid medicine according to the second embodiment, the second oxygen permeability promotes the oxygen permeation through the first container. That is, the movement of oxygen from the first container into the second container maintained in a low oxygen state by an oxygen absorber is promoted. This decreases the concentration of oxygen (%) in the first container and decreases the amount of oxygen dissolved in the liquid medicine (mg/L). This can suppress the degradation of the liquid medicine L due to oxygen. Furthermore, the water vapor permeation through the first container is suppressed due to the second water vapor permeability. This can suppress a change in the concentration of a pharmaceutical ingredient and a change in the hydrogen ion concentration of a liquid medicine using the aqueous liquid medium. This can suppress the hydrolysis of the pharmaceutical ingredient dispersed in a non-aqueous liquid medium. Thus, the second embodiment can also suppress both the oxygen degradation of the liquid medicine L and the quality deterioration of the liquid medicine L due to water vapor permeation.

In the first embodiment, the material constituting the stopper may have the first oxygen permeability and the first water vapor permeability, and the first container including the stopper may have the second oxygen permeability. In the first embodiment, the material constituting the stopper may have the first oxygen permeability and the first water vapor permeability, and the first container including the stopper may have the second water vapor permeability. In the first embodiment, the material constituting the stopper may have the first oxygen permeability and the first water vapor permeability, and the first container including the stopper may have the second oxygen permeability and the second water vapor permeability.

Details of the first embodiment and the second embodiment are described below with reference to specific examples illustrated in FIG. 1A, FIG. 1B, and the like. FIG. 1A is a front view of a specific example of a combined medical container 10L containing a liquid medicine. FIG. 1B is a longitudinal sectional view of the combined medical container 10L containing a liquid medicine illustrated in FIG. 1A.

As described above, a first container 30L containing a liquid medicine includes a first container 30 and a liquid medicine L contained in the first container 30. The first container 30 has oxygen permeability. The first container 30 can be sealed to contain the liquid medicine L. The first container 30 is permeable to oxygen but impermeable to the liquid medicine L.

The first container 30 may also be an air-tight container. The air-tight refers to a container without gas leakage detected by an immersion method specified in JAS Z 2330: 2012. More specifically, when a container containing a gas is immersed in water, a container that can prevent bubbles from leaking is considered to be an air-tight container. An air-tight container is also determined to be in an air-tight state when leakage of bubbles from the container containing a gas immersed in water is not observed. In an immersion test, a container to be tested is immersed to a depth of 10 cm or more and 30 cm or less from the water surface. The presence or absence of bubbles is judged by visual observation for 10 minutes.

The interior of the first container 30 may be a sterile state. The liquid medicine L may be a liquid medicine to be kept a sterile state. The liquid medicine L to be kept in a sterile state may be highly sensitive. A highly sensitive liquid medicine L is likely to be degraded by post-sterilization (also referred to as terminal sterilization) performed after production. A highly sensitive liquid medicine cannot be post-sterilized. The post-sterilization is, for example, a high-pressure steam sterilization, dry-heat sterilization, radiation sterilization, ethylene oxide gas sterilization, hydrogen peroxide gas plasma sterilization, or the like. The highly sensitive liquid medicine L refers to a liquid medicine in which 5% or more by weight of all pharmaceutical ingredients in the liquid medicine are decomposed by post-sterilizing the liquid medicine L, and 1% or more by weight of one or more active ingredients in the liquid medicine are decomposed by post-sterilizing the liquid medicine L. A highly sensitive liquid medicine L that cannot be post-sterilized can be produced using production lines in a sterile environment. Thus, the highly sensitive liquid medicine L can be produced by an aseptic manipulation method. The highly sensitive liquid medicine L is, for example, an anticancer agent, an antiviral agent, a vaccine, an antipsychotic agent, or the like.

To adjust the amount of oxygen in the liquid medicine L produced by the aseptic manipulation method, the entire space in which the production lines of the liquid medicine L are disposed may be replaced with an inert gas. However, setting the entire space in which the production lines of the liquid medicine L are disposed to be an inert gas atmosphere involves a huge capital investment and may cause a concern about the safety of workers. From the above background, the amount of oxygen in the liquid medicine L has typically been adjusted by replacing the atmosphere in the first container containing the liquid medicine L with an inert gas, bubbling the liquid medicine L with an inert gas, or the like. On the other hand, the combined medical container 10L containing a liquid medicine can store the first container 30L containing a liquid medicine in the second container 40 to reduce the amount of oxygen in the first container 30L containing a liquid medicine.

A product (liquid medicine L) and the inside of a container containing the product described as “sterilized”, “sterile”, or the like, and a product (liquid medicine L), such as a pharmaceutical agent, and the inside of a container containing the product for which “sterile” is a condition for commercialization correspond to the “sterile state” as used herein. A product (liquid medicine L) and the inside of a container containing the product satisfying a sterility assurance level (SAL) of 10-6 defined in JIS T0806: 2014 also correspond to the “sterile state” as used herein. A product and the inside of a container containing the product in which bacteria do not grow when stored at a temperature equal to or higher than room temperature (for example, 20° C.) for 4 weeks also correspond to the “sterile state” as used herein. A product and the inside of a container containing the product in which bacteria do not grow when stored in a refrigeration state (for example, 8° C. or less) for 8 weeks or more also correspond to the “sterile state” as used herein. A chemical and the inside of a container containing the chemical in which bacteria do not grow when stored at a temperature of 28° C. or more and 32° C. or less for 2 weeks also correspond to the “sterile state” as used herein.

As illustrated in FIG. 1C, the first container 30 may include the container body 32 and a stopper 34. The container body 32 includes an opening portion 33. The stopper 34 may be retained in the opening portion 33. The stopper 34 closes the opening portion 33. The stopper 34 restricts the leakage of the liquid medicine L from the opening portion 33. The stopper 34 may hermetically close the opening portion 33.

The stopper 34 is not particularly limited and may have various configurations. In the example illustrated in FIG. 1C, the stopper 34 is inserted into the opening portion 33 of the container body 32 to close the opening portion 33. The stopper 34 illustrated in FIG. 1C includes a plate-like portion 34a with a plate shape and an insertion protrusion 34b extending from the plate-like portion 34a. The insertion protrusion 34b may be tubular. The insertion protrusion 34b is, for example, cylindrical. A plurality of insertion protrusions 34b may be provided on the circumference. The insertion protrusion 34b is inserted into the opening portion 33. The plate-like portion 34a includes a flange portion extending radially outward from the insertion protrusion 34b. The flange portion of the plate-like portion 34a is placed on a head portion 32d of the container body 32. The stopper 34 may have an outer helix and an inner helix. The stopper 34 may be attached to the container body 32 by helical engagement.

The present inventors have found that, for example, a material or production conditions for the stopper 34 with a function of closing the opening portion can be devised to impart a predetermined first oxygen permeability and a predetermined first water vapor permeability to the stopper 34.

The first oxygen permeability of a material constituting the stopper 34 is 0.00010 (cc×mm/(mm²×day)) or more and may be 0.00050 (cc×mm/(mm²×day)) or more, 0.00075 (cc×mm/(mm²×day)) or more, 0.0010 (cc×mm/(mm²×day)) or more, 0.0020 (cc×mm/(mm²×day)) or more, 0.0050 (cc×mm/(mm²×day)) or more, 0.010 (cc×mm/(mm²×day)) or more, 0.025 (cc×mm/(mm²×day)) or more, 0.027 (cc×mm/(mm²×day)) or more, 0.050 (cc×mm/(mm²×day)) or more, 0.057 (cc×mm/(mm²×day)) or more, 0.076 (cc×mm/(mm²×day)) or more, or 0.082 (cc×mm/(mm²×day)) or more. The first oxygen permeability is a characteristic at a temperature of 23° C. and a relative humidity of 50%. The lower limit of the first oxygen permeability of a material constituting the stopper 34 can be set in this manner to sufficiently promote the oxygen permeation through the first container 30 and suppress the oxygen degradation of the liquid medicine L. The first oxygen permeability may be 10 (cc×mm/(mm²×day)) or less, 5.0 (cc×mm/(mm²×day)) or less, or 1.0 (cc×mm/(mm²×day)) or less.

When the stopper 34 is composed of a plurality of layers of different materials, it is the permeability of a material that substantially determines the permeability of the entire stopper. When there is no material that substantially determines the permeability of the entire stopper, the permeability of a material constituting the stopper 34 refers to the permeability of a material constituting the layer with the highest volume ratio among the plurality of layers.

A material constituting the stopper 34 may have a first oxygen permeability of 0.00010 (cc×mm/(mm²×day)) or more and 10 (cc×mm/(mm²×day)) or less, 0.00010 (cc×mm/(mm²×day)) or more and 5.0 (cc×mm/(mm²×day)) or less, or 0.00010 (cc×mm/(mm²×day)) or more and 1.0 (cc×mm/(mm²×day)) or less. A material constituting the stopper 34 may have a first oxygen permeability of 0.00050 (cc×mm/(mm²×day)) or more and 10 (cc×mm/(mm²×day)) or less, 0.00050 (cc×mm/(mm²×day)) or more and 5.0 (cc×mm/(mm²×day)) or less, or 0.00050 (cc×mm/(mm²×day)) or more and 1.0 (cc×mm/(mm²×day)) or less. A material constituting the stopper 34 may have a first oxygen permeability of 0.00075 (cc×mm/(mm²×day)) or more and 10 (cc×mm/(mm²×day)) or less, 0.00075 (cc×mm/(mm²×day)) or more and 5.0 (cc×mm/(mm²×day)) or less, or 0.00075 (cc×mm/(mm²×day)) or more and 1.0 (cc×mm/(mm²×day)) or less. A material constituting the stopper 34 may have a first oxygen permeability of 0.0010 (cc×mm/(mm²×day)) or more and 10 (cc×mm/(mm²×day)) or less, 0.0010 (cc×mm/(mm²×day)) or more and 5.0 (cc×mm/(mm²×day)) or less, or 0.0010 (cc×mm/(mm²×day)) or more and 1.0 (cc×mm/(mm²×day)) or less. A material constituting the stopper 34 may have a first oxygen permeability of 0.0020 (cc×mm/(mm²×day)) or more and 10 (cc×mm/(mm²×day)) or less, 0.0020 (cc×mm/(mm²×day)) or more and 5.0 (cc×mm/(mm²×day)) or less, or 0.0020 (cc×mm/(mm²×day)) or more and 1.0 (cc×mm/(mm²×day)) or less. A material constituting the stopper 34 may have a first oxygen permeability of 0.0050 (cc×mm/(mm²×day)) or more and 10 (cc×mm/(mm² xday)) or less, 0.0050 (cc×mm/(mm²×day)) or more and 5.0 (cc×mm/(mm²×day)) or less, or 0.0050 (cc×mm/(mm²×day)) or more and 1.0 (cc×mm/(mm²×day)) or less. A material constituting the stopper 34 may have a first oxygen permeability of 0.010 (cc×mm/(mm²×day)) or more and 10 (cc×mm/(mm²×day)) or less, 0.010 (cc×mm/(mm²×day)) or more and 5.0 (cc×mm/(mm²×day)) or less, or 0.010 (cc×mm/(mm²×day)) or more and 1.0 (cc×mm/(mm²×day)) or less. A material constituting the stopper 34 may have a first oxygen permeability of 0.025 (cc×mm/(mm²×day)) or more and 10 (cc×mm/(mm²×day)) or less, 0.025 (cc×mm/(mm²×day)) or more and 5.0 (cc×mm/(mm²×day)) or less, or 0.025 (cc×mm/(mm²×day)) or more and 1.0 (cc×mm/(mm²×day)) or less. A material constituting the stopper 34 may have a first oxygen permeability of 0.027 (cc×mm/(mm²×day)) or more and 10 (cc×mm/(mm²×day)) or less, 0.027 (cc×mm/(mm²×day)) or more and 5.0 (cc×mm/(mm²×day)) or less, or 0.027 (cc×mm/(mm²×day)) or more and 1.0 (cc×mm/(mm²×day)) or less. A material constituting the stopper 34 may have a first oxygen permeability of 0.050 (cc×mm/(mm²×day)) or more and 10 (cc×mm/(mm²×day)) or less, 0.050 (cc×mm/(mm²×day)) or more and 5.0 (cc×mm/(mm²×day)) or less, or 0.050 (cc×mm/(mm²×day)) or more and 1.0 (cc×mm/(mm²×day)) or less. A material constituting the stopper 34 may have a first oxygen permeability of 0.057 (cc×mm/(mm²×day)) or more and 10 (cc×mm/(mm²×day)) or less, 0.057 (cc×mm/(mm²×day)) or more and 5.0 (cc×mm/(mm²×day)) or less, or 0.057 (cc×mm/(mm²×day)) or more and 1.0 (cc×mm/(mm²×day)) or less. A material constituting the stopper 34 may have a first oxygen permeability of 0.076 (cc×mm/(mm²×day)) or more and 10 (cc×mm/(mm²×day)) or less, 0.076 (cc×mm/(mm²×day)) or more and 5.0 (cc×mm/(mm²×day)) or less, or 0.076 (cc×mm/(mm²×day)) or more and 1.0 (cc×mm/(mm²×day)) or less. A material constituting the stopper 34 may have a first oxygen permeability of 0.082 (cc×mm/(mm²×day)) or more and 10 (cc×mm/(mm²×day)) or less, 0.082 (cc×mm/(mm²×day)) or more and 5.0 (cc×mm/(mm²×day)) or less, or 0.082 (cc×mm/(mm²×day)) or more and 1.0 (cc×mm/(mm²×day)) or less.

The first oxygen permeability is a characteristic related to oxygen permeation depending on the material. The first oxygen permeability refers to the volume of oxygen that permeates, per unit time, a measurement object with a unit thickness and a unit area that separates a region substantially free of oxygen from a region where air containing oxygen is present. The unit length is 1 mm. The unit area is 1 mm². The unit time is one day or 24 hours. The unit of the volume of oxygen is “cc”.

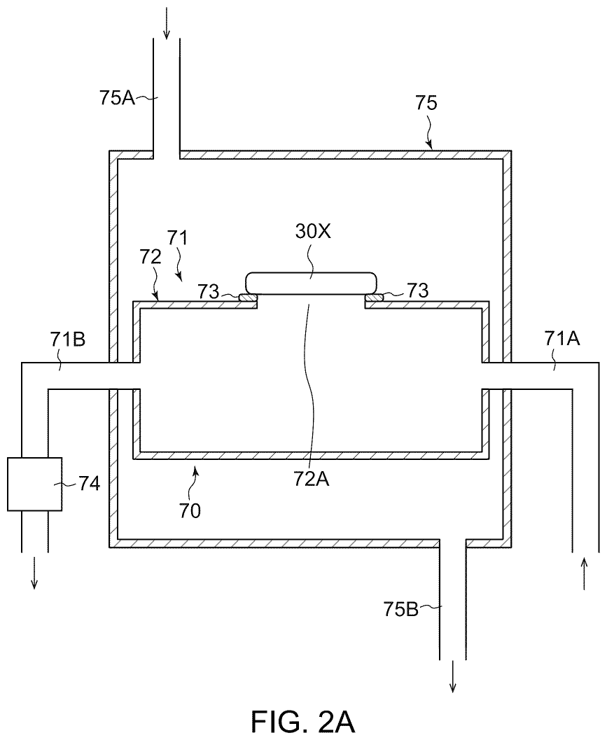

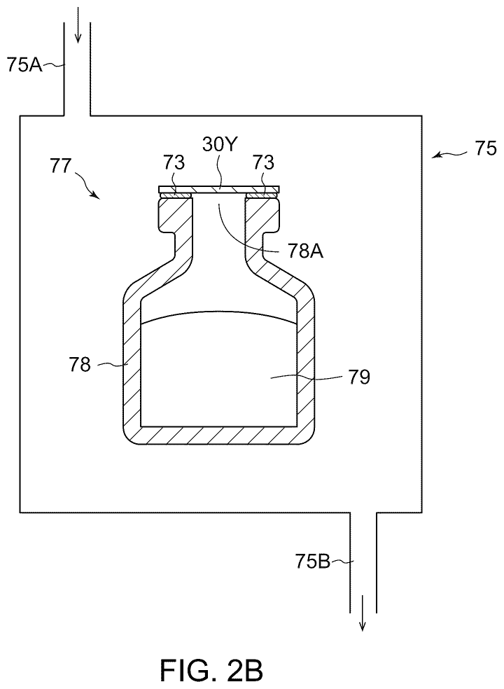

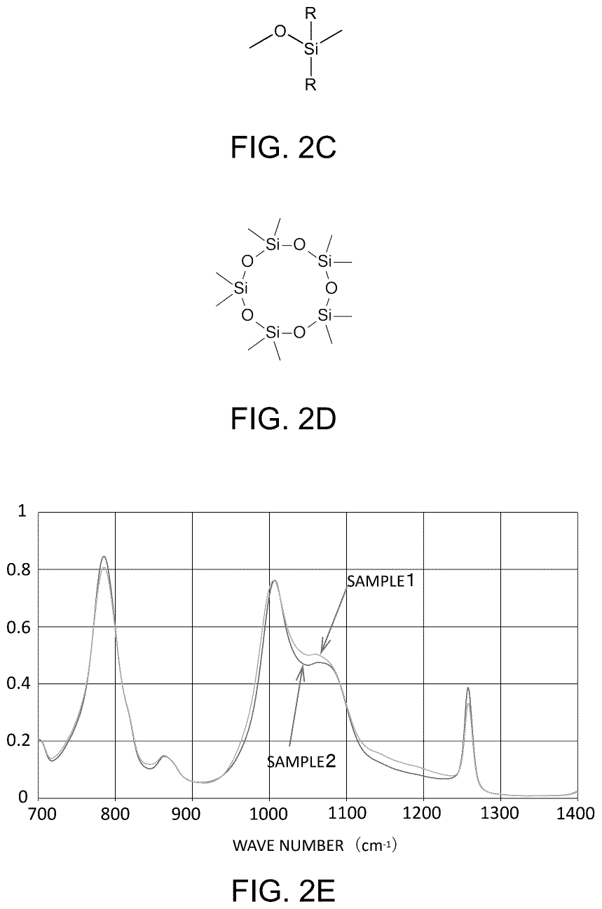

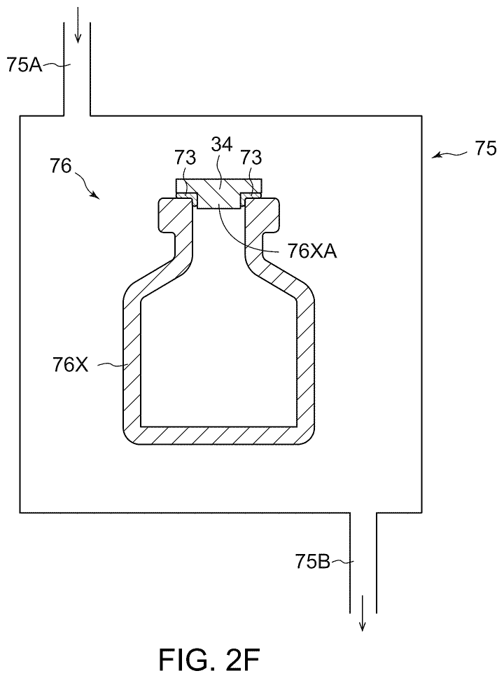

As illustrated in FIG. 2A, the first oxygen permeability is measured using a test container 70 including a test sheet 30X. The test sheet 30X is constituted by a material to be measured. The test sheet 30X is prepared by reducing the thickness of the stopper 34 to be measured by cutting so as to have a constant thickness in a region facing a through-hole 72A described later. The test sheet 30X in the region facing the through-hole 72A has a thickness of 1.0 mm. For a measurement object that cannot have a thickness of 1.0 mm in the region facing the through-hole 72A, the test sheet 30X is prepared to have the maximum thickness in the region.

The test container 70 includes a partition wall portion 71. The test container 70 includes an internal space defined by the partition wall portion 71 and the test sheet 30X. The partition wall portion 71 includes a main wall portion 72 with an oxygen barrier property. The main wall portion 72 has the through-hole 72A. The test sheet 30X faces the through-hole 72A. The through-hole 72A is closed with the test sheet 30X. The peripheral portion of the test sheet 30X is hermetically bonded to the peripheral portion of the through-hole 72A of the main wall portion 72 via a barrier bonding material 73 with an oxygen barrier property.

The concentration of oxygen in the test container 70 is adjusted to 0.05% or less. Thus, the test container 70 is substantially free of oxygen. The test container 70 is connected to a first flow path 71A and a second flow path 71B. The second flow path 71B is coupled to an oxygen meter 74 to measure the amount of oxygen. The oxygen meter 74 can measure the amount of oxygen (cc) flowing through the second flow path 71B. The oxygen meter 74 is an oxygen content meter incorporated in OXTRAN (2/61) manufactured by MOCON, Inc., U.S.A. An oxygen-free gas is supplied to the test container 70 through the first flow path 71A. Nitrogen is supplied through the first flow path 71A. A gas in the test container 70 is discharged through the second flow path 71B. The first flow path 71A and the second flow path 71B have an oxygen barrier property. The first flow path 71A and the second flow path 71B maintain the inside of the test container 70 in a substantially oxygen-free state.

The test container 70 is placed in a test atmosphere with a temperature of 23° C. and a relative humidity of 50%. The test atmosphere is an air atmosphere at atmospheric pressure. The concentration of oxygen in the test atmosphere is 20.95%. When the test container 70 is placed in the test atmosphere, oxygen is transferred from the test atmosphere into the test container 70 through the test sheet 30X. The gas in the test container 70 is discharged through the second flow path 71B. The oxygen permeation amount per day (cc/day) through the test sheet 30X in an atmosphere with a temperature of 23° C. and a relative humidity of 50% can be determined by measuring the amount of oxygen flowing through the second flow path 71B with the oxygen meter 74. The measured oxygen permeation amount per day is divided by the opening area (mm²) of the through-hole 72A and is then multiplied by the thickness (mm) of the test sheet 30X to determine the first oxygen permeability (cc×mm/(mm²×day)). The thickness (mm) of the test sheet 30X is an average value of the thicknesses of the test sheet 30X measured at five measurement points in a portion facing the through-hole 72A.

As illustrated in FIG. 2A, the test container 70 is disposed in a test chamber 75. The atmosphere in the test chamber 75 is adjusted to a temperature of 23° C. and a relative humidity of 50%. The atmosphere in the test chamber 75 is an air atmosphere at atmospheric pressure. The test chamber 75 is supplied with air through a supply path 75A. The gas in the test chamber 75 is discharged through a discharge path 75B. The air is circulated through the supply path 75A and the discharge path 75B to maintain the concentration of oxygen in the test chamber 75 at 20.95%.

In the example illustrated in FIG. 2A, a pump for circulating air may be provided in one of the supply path 75A and the discharge path 75B. As long as the concentration of oxygen in the test chamber 75 can be kept equal to that in the air atmosphere, the supply path 75A and the discharge path 75B in FIG. 2A may be opened to the air atmosphere at atmospheric pressure.

The first water vapor permeability of a material constituting the stopper 34 is 1.0 (mg×mm/(mm²×day)) or less and may be 0.80 (mg×mm/(mm²×day)) or less, 0.60 (mg×mm/(mm²×day)) or less, 0.45 (mg×mm/(mm²×day)) or less, 0.41 (mg×mm/(mm²×day)) or less, 0.25 (mg×mm/(mm²×day)) or less, 0.15 (mg×mm/(mm²×day)) or less, 0.11 (mg×mm/(mm²×day)) or less, or 0.10 (mg×mm/(mm²×day)) or less. The first water vapor permeability is a characteristic at a temperature of 40° C. and a relative humidity of 90%. The upper limit of the first water vapor permeability of a material constituting the stopper 34 can be set in this manner to sufficiently suppress the water vapor permeation through the first container 30 and suppress the quality deterioration of the liquid medicine L due to the water vapor permeation. The first water vapor permeability may be 0.0010 (mg×mm/(mm²×day)) or more, 0.0050 (mg×mm/(mm²×day)) or more, or 0.010 (mg×mm/(mm²×day)) or more.

A material constituting the stopper 34 may have a first water vapor permeability of 0.0010 (mg×mm/(mm²×day)) or more and 1.0 (mg×mm/(mm²×day)) or less, 0.0010 (mg×mm/(mm²×day)) or more and 0.80 (mg×mm/(mm²×day)) or less, 0.0010 (mg×mm/(mm²×day)) or more and 0.60 (mg×mm/(mm²×day)) or less, 0.0010 (mg×mm/(mm²×day)) or more and 0.45 (mg×mm/(mm²×day)) or less, 0.0010 (mg×mm/(mm²×day)) or more and 0.41 (mg×mm/(mm²×day)) or less, 0.0010 (mg×mm/(mm²×day)) or more and 0.25 (mg×mm/(mm²×day)) or less, 0.0010 (mg×mm/(mm²×day)) or more and 0.15 (mg×mm/(mm²×day)) or less, 0.0010 (mg×mm/(mm²×day)) or more and 0.11 (mg×mm/(mm²×day)) or less, or 0.0010 (mg×mm/(mm²×day)) or more and 0.10 (mg×mm/(mm²×day)) or less. A material constituting the stopper 34 may have a first water vapor permeability of 0.0050 (mg×mm/(mm²×day)) or more and 1.0 (mg×mm/(mm²×day)) or less, 0.0050 (mg×mm/(mm²×day)) or more and 0.80 (mg×mm/(mm²×day)) or less, 0.0050 (mg×mm/(mm²×day)) or more and 0.60 (mg×mm/(mm²×day)) or less, 0.0050 (mg×mm/(mm²×day)) or more and 0.45 (mg×mm/(mm²×day)) or less, 0.0050 (mg×mm/(mm²×day)) or more and 0.41 (mg×mm/(mm²×day)) or less, 0.0050 (mg×mm/(mm²×day)) or more and 0.25 (mg×mm/(mm²×day)) or less, 0.0050 (mg×mm/(mm²×day)) or more and 0.15 (mg×mm/(mm²×day)) or less, 0.0050 (mg×mm/(mm²×day)) or more and 0.11 (mg×mm/(mm²×day)) or less, or 0.0050 (mg×mm/(mm²×day)) or more and 0.10 (mg×mm/(mm²×day)) or less. A material constituting the stopper 34 may have a first water vapor permeability of 0.010 (mg×mm/(mm²×day)) or more and 1.0 (mg×mm/(mm²×day)) or less, 0.010 (mg×mm/(mm²×day)) or more and 0.80 (mg×mm/(mm²×day)) or less, 0.010 (mg×mm/(mm²×day)) or more and 0.60 (mg×mm/(mm²×day)) or less, 0.010 (mg×mm/(mm²×day)) or more and 0.45 (mg×mm/(mm²×day)) or less, 0.010 (mg×mm/(mm²×day)) or more and 0.41 (mg×mm/(mm²×day)) or less, 0.010 (mg×mm/(mm²×day)) or more and 0.25 (mg×mm/(mm²×day)) or less, 0.010 (mg×mm/(mm²×day)) or more and 0.15 (mg×mm/(mm²×day)) or less, 0.010 (mg×mm/(mm²×day)) or more and 0.11 (mg×mm/(mm²×day)) or less, or 0.010 (mg×mm/(mm²×day)) or more and 0.10 (mg×mm/(mm²×day)) or less.

The first water vapor permeability is a characteristic related to water vapor permeation depending on the material. The first water vapor permeability refers to the volume of water vapor that permeates, per unit time, a measurement object with a unit thickness and a unit area that separates a region substantially free of water vapor from a region where air containing water vapor is present. The unit length is 1 mm. The unit area is 1 mm². The unit time is one day or 24 hours. The volume of water vapor is expressed in “mg”.

As illustrated in FIG. 2B, the first water vapor permeability is measured by using a test container 77 including a test sheet 30Y. The test sheet 30Y is constituted by a material to be measured. The test sheet 30Y is prepared by reducing the thickness of the stopper 34 to be measured so as to have a constant thickness in a region facing an opening portion 78A described later. The test sheet 30Y in the region facing the opening portion 78A has a thickness of 1.0 mm. For a measurement object that cannot have a thickness of 1.0 mm in the region facing the opening portion 78A, the test sheet 30Y is prepared to have the maximum thickness in the region.

The test container 77 includes a test storage portion 78. The test storage portion 78 is a container with the opening portion 78A. The test sheet 30Y faces the opening portion 78A. The opening portion 78A is closed with the test sheet 30Y. The peripheral portion of the test sheet 30Y is hermetically bonded to the peripheral portion of the opening portion 78A of the test storage portion 78 via the barrier bonding material 73 with a water vapor barrier property. With reference to the provisions of JIS Z 0208-1976, the mass of calcium chloride 79 is determined so that the test is completed before the calcium chloride 79 absorbs 10% by mass of water based on the mass of the calcium chloride 79. The test container 77 with a volume of 1 mL or more and 50 mL or less typically stores approximately 10 g of calcium chloride. When the mass of calcium chloride is determined in this manner, water vapor that has permeated the test sheet 30Y can be absorbed to maintain the inside of the test container 77 in a substantially water-vapor-free state.

The test container 77 is placed in a test atmosphere adjusted to a temperature of 40° C. and a relative humidity of 90%. The test atmosphere is an air atmosphere at atmospheric pressure. When the test container 77 is placed in the test atmosphere, water vapor is transferred from the test atmosphere into the test container 77 through the test sheet 30Y. In the test container 77, water vapor is absorbed as water by the calcium chloride 79. The amount of water vapor (mg) permeating the test sheet 30Y can be measured in an atmosphere with a temperature of 40° C. and a relative humidity of 90% by measuring the increase in weight of the test container 77. Immediately after closing the opening portion 78A of the test storage portion 78 with the test sheet 30Y to close the test container 77, water vapor may be present in the test container 77. To remove the influence of the water vapor, the water vapor permeation amount per day (mg/day) through the test sheet 30Y can be determined by dividing the change in weight between the weight of the test container 77 after one day from the closing of the test container 77 and the weight of the test container 77 after 11 days from the closing of the test container 77 by 10 (days). The measured water vapor permeation amount per day is divided by the opening area (mm²) of the opening portion 78A and is then multiplied by the thickness (mm) of the test sheet 30Y to determine the first water vapor permeability (cc×mm/(mm²×day)). The thickness (mm) of the test sheet 30Y is an average value of the thicknesses of the test sheet 30Y measured at five measurement points in the region facing the through-hole 72A.

As illustrated in FIG. 2B, the test container 77 is disposed in the test chamber 75. The atmosphere in the test chamber 75 is adjusted to a temperature of 40° C. and a relative humidity of 90%. The atmosphere in the test chamber 75 is an air atmosphere at atmospheric pressure. The test chamber 75 is supplied with air through a supply path 75A. The gas in the test chamber 75 is discharged through a discharge path 75B. The supply path 75A and the discharge path 75B maintain the test chamber 75 in the test atmosphere.

The portion of the stopper 34 with the first oxygen permeability and the first water vapor permeability facing the opening portion 33 has an average thickness of 0.50 mm or more, 0.70 mm or more, 1.0 mm or more, 1.5 mm or more, or 2.0 mm or more. The portion of the stopper 34 facing the opening portion 33 may have an average thickness of 10 mm or less, 8.0 mm or less, 6.0 mm or less, or 5.0 mm or less.

The portion of the stopper 34 facing the opening portion 33 may have an average thickness of 0.50 mm or more and 10 mm or less, 0.50 mm or more and 8.0 mm or less, 0.50 mm or more and 6.0 mm or less, or 0.50 mm or more and 5.0 mm or less. The portion of the stopper 34 facing the opening portion 33 may have an average thickness of 0.70 mm or more and 10 mm or less, 0.70 mm or more and 8.0 mm or less, 0.70 mm or more and 6.0 mm or less, or 0.70 mm or more and 5.0 mm or less. The portion of the stopper 34 facing the opening portion 33 may have an average thickness of 1.0 mm or more and 10 mm or less, 1.0 mm or more and 8.0 mm or less, 1.0 mm or more and 6.0 mm or less, or 1.0 mm or more and 5.0 mm or less. The portion of the stopper 34 facing the opening portion 33 may have an average thickness of 1.50 mm or more and 10 mm or less, 1.50 mm or more and 8.0 mm or less, 1.50 mm or more and 6.0 mm or less, or 1.50 mm or more and 5.0 mm or less. The portion of the stopper 34 facing the opening portion 33 may have an average thickness of 2.0 mm or more and 10 mm or less, 2.0 mm or more and 8.0 mm or less, 2.0 mm or more and 6.0 mm or less, or 2.0 mm or more and 5.0 mm or less.

As illustrated in FIG. 1C, the average thickness of the portion of the stopper 34 facing the opening portion 33 refers to the average thickness, in the direction DA, of the portion of the stopper that overlaps the opening portion 33 in the direction DA in which the stopper 34 is inserted into the opening portion 33. Thus, the portion of the stopper 34 facing the opening portion 33 includes the portion of the stopper 34 facing the opening portion 33 in the direction DA and a portion of the stopper 34 located in the opening portion 33. When the stopper 34 with the first oxygen permeability and the first water vapor permeability has an average thickness in such a range in the portion facing the opening portion 33, the stopper 34 can sufficiently promote the oxygen permeation through the first container 30 and sufficiently suppress the water vapor permeation through the first container 30. This can sufficiently suppress both the quality deterioration of the liquid medicine L due to the oxygen permeation and the quality deterioration of the liquid medicine L due to the water vapor permeation.

When the average thickness of the portion of the stopper 34 overlapping the opening portion 33 is not constant, the average thickness of the portion of the stopper 34 facing the opening portion 33 is determined by the following method.

(1) The density (g/mm³) of the stopper is measured by a measurement method described later.
(2) The portion of the stopper facing the opening portion is cut out to measure the weight (g) of the portion of the stopper facing the opening portion.
(3) The weight (g) of the portion of the stopper facing the opening portion is divided by the density (g/mm³) of the stopper to calculate the volume (mm³) of the portion of the stopper facing the opening portion.
(4) The area (mm²) of the opening portion of the container body is measured, and the volume (mm³) of the portion of the stopper facing the opening portion is divided by the area (mm²) of the opening portion to determine the average thickness (mm) of the portion of the stopper facing the opening portion.

In the case that the first container 30 is a vial, or a vial bottle, the opening portion 33 of the container body 32 may have an opening area of 25 mm² or more, 50 mm² or more, 100 mm² or more, or 150 mm² or more. In the case that the first container 30 is a vial, the opening portion 33 of the container body 32 may have an opening area of 1000 mm² or less, 800 mm² or less, 500 mm² or less, 400 mm² or less, 300 mm² or less, or 200 mm² or less

In the case that the first container 30 is a vial, the opening portion 33 of the container body 32 may have the following opening area. That is, the opening portion 33 may have an opening area of 25 mm² or more and 1000 mm² or less, 25 mm² or more and 800 mm² or less, 25 mm² or more and 500 mm² or less, 25 mm² or more and 400 mm² or less, 25 mm² or more and 300 mm² or less, or 25 mm² or more and 200 mm² or less. The opening portion 33 may have an opening area of 50 mm² or more and 1000 mm² or less, 50 mm² or more and 800 mm² or less, 50 mm² or more and 500 mm² or less, 50 mm² or more and 400 mm² or less, 50 mm² or more and 300 mm² or less, or 50 mm² or more and 200 mm² or less. The opening portion 33 may have an opening area of 100 mm² or more and 1000 mm² or less, 100 mm² or more and 800 mm² or less, 100 mm² or more and 500 mm² or less, 100 mm² or more and 400 mm² or less, 100 mm² or more and 300 mm² or less, or 100 mm² or more and 200 mm² or less. The opening portion 33 may have an opening area of 150 mm² or more and 1000 mm² or less, 150 mm² or more and 800 mm² or less, 150 mm² or more and 500 mm² or less, 150 mm² or more and 400 mm² or less, 150 mm² or more and 300 mm² or less, or 150 mm² or more and 200 mm² or less.

In the case that the first container 30 is a syringe, the opening portion 33 of the container body 32 may have an opening area of 0.50 mm² or more, 1.0 mm² or more, 5.0 mm² or more, 25 mm² or more, 50 mm² or more, or 100 mm² or more. In the case that the first container 30 is a syringe, the opening portion 33 of the container body 32 may have an opening area of 800 mm² or less, 500 mm² or less, 400 mm² or less, 300 mm² or less, or 200 mm² or less.

In the case that the first container 30 is a syringe, the opening portion 33 of the container body 32 may have the following opening area. That is, the opening portion 33 may have an opening area of 0.50 mm² or more and 800 mm² or less, 0.50 mm² or more and 500 mm² or less, 0.50 mm² or more and 400 mm² or less, 0.50 mm² or more and 300 mm² or less, or 0.50 mm² or more and 200 mm² or less. The opening portion 33 may have an opening area of 1.0 mm² or more and 800 mm² or less, 1.0 mm² or more and 500 mm² or less, 1.0 mm² or more and 400 mm² or less, 1.0 mm² or more and 300 mm² or less, or 1.0 mm² or more and 200 mm² or less. The opening portion 33 may have an opening area of 5.0 mm² or more and 800 mm² or less, 5.0 mm² or more and 500 mm² or less, 5.0 mm² or more and 400 mm² or less, 5.0 mm² or more and 300 mm² or less, or 5.0 mm² or more and 200 mm² or less. The opening portion 33 may have an opening area of 25 mm² or more and 800 mm² or less, 25 mm² or more and 500 mm² or less, 25 mm² or more and 400 mm² or less, 25 mm² or more and 300 mm² or less, or 25 mm² or more and 200 mm² or less. The opening portion 33 may have an opening area of 50 mm² or more and 800 mm² or less, 50 mm² or more and 500 mm² or less, 50 mm² or more and 400 mm² or less, 50 mm² or more and 300 mm² or less, or 50 mm² or more and 200 mm² or less. The opening portion 33 may have an opening area of 100 mm² or more and 800 mm² or less, 100 mm² or more and 500 mm² or less, 100 mm² or more and 400 mm² or less, 100 mm² or more and 300 mm² or less, or 100 mm² or more and 200 mm² or less.

When the opening portion 33 closed with the stopper 34 with the first oxygen permeability and the first water vapor permeability has an area in such a range, the opening portion 33 can sufficiently promote the oxygen permeation through the first container 30 and sufficiently suppress the water vapor permeation through the first container 30. This can sufficiently suppress both the quality deterioration of the liquid medicine L due to the oxygen permeation and the quality deterioration of the liquid medicine L due to the water vapor permeation.

A material of the stopper 34 with the first oxygen permeability and the first water vapor permeability may be a compound with a main backbone of a siloxane bond. Thus, the stopper 34 may contain a compound with a main backbone of a siloxane bond (—R—Si—). The entire stopper 34 may be composed of a compound with a main backbone of a siloxane bond. Only a portion of the stopper 34 may be composed of a compound with a main backbone of a siloxane bond.

A compound with a main backbone of a siloxane bond is also referred to as silicone. The silicone in the stopper 34 is solid in an environment in which the first container 30 is to be used. The silicone in the stopper 34 may not contain a silicone that is liquid in a room temperature environment, such as silicone oil. The stopper 34 may contain a silicone elastomer. The stopper 34 may contain a silicone rubber. The silicone rubber refers to a rubber-like material composed of silicone. The silicone rubber is a synthetic resin composed mainly of silicone and is a rubber-like substance. The silicone rubber is a rubber-like substance with a siloxane bond as a main chain. The silicone rubber may be a thermosetting compound with a siloxane bond. The silicone rubber is, for example, methyl silicone rubber, methyl vinyl silicone rubber, phenylmethyl silicone rubber, dimethyl silicone rubber, phenyl vinyl methyl silicone rubber, fluorosilicone rubber, or the like.

The first container 30 containing the liquid medicine may be placed in an environment with the temperature range of 5° C. or more and 40° C. or less. It is assumed that the first container 30L containing a liquid medicine is refrigerated for an extended period in an environment with a temperature as low as approximately 5° C. The stopper 34 is expected to maintain the function as a stopper in the temperature range of 5° C. or more and 40° C. or less. The stopper 34 is expected to keep the first container 30 air-tight in the temperature range of 5° C. or more and 40° C. or less. The dimensions of the stopper 34 preferably do not change greatly with a change in temperature in the temperature range of 5° C. or more and 40° C. or less. The hardness of the stopper 34 preferably does not change greatly with a change in temperature in the temperature range of 5° C. or more and 40° C. or less. From such a perspective, a compound with a main backbone of a siloxane bond may contain one or more of dimethyl silicone, methyl vinyl silicone, dimethyl silicone rubber, and methyl vinyl silicone rubber.

At least a portion of the stopper 34 may be composed of silicone. More specifically, the entire stopper 34 may be composed of silicone or a silicone rubber. A portion of the stopper 34 may be composed of silicone or a silicone rubber. For example, a portion of the stopper 34 may be composed of silicone or a silicone rubber over the entire thickness thereof. The portion may be a central portion of the stopper 34 or all or part of the peripheral portion surrounding the central portion.

The rubber stopper of the vial is typically composed of butyl rubber. Silicone and silicone rubber typically have an oxygen permeability coefficient approximately 20 times that of natural rubber and a hydrogen permeability coefficient approximately 10 times that of natural rubber. Silicone and silicone rubber typically have an oxygen permeability coefficient approximately 40 times or more that of butyl rubber and a hydrogen permeability coefficient approximately 70 times or more that of butyl rubber.

In the case that the measurement object does not contain rubber and is not a molded container, the oxygen permeability coefficient is measured in accordance with JIS K 7126-2: 2006 in an environment with a temperature of 23° C. and a relative humidity of 50% using a permeability measuring instrument OXTRAN (2/21) manufactured by MOCON, Inc., USA. If the measurement object is at least one of a rubber-containing object and a molded container, the oxygen permeability coefficient is measured in accordance with ASTM D3985. In this case, the oxygen permeability coefficient is a value measured in an environment with a temperature of 23° C. and a relative humidity of 50% using the permeability measuring instrument OXTRAN (2/61) manufactured by MOCON, Inc., U.S.A.

A sample for measurement is prepared by cutting the stopper 34 to be measured so as to have a constant thickness. A sample for measurement has a thickness of 1.0 mm. For a measurement object for which the thickness of 1.0 mm cannot be ensured, a sample to be measured is prepared so as to have the maximum thickness.

By adjusting the structure, hardness, density, and the like of the stopper 34 containing a compound with a main backbone of a siloxane bond, the first water vapor permeability of a material constituting the stopper 34 can be stably maintained at a low level against a change in environmental conditions while maintaining the suitability as the stopper 34. When the first water vapor permeability of a material constituting the stopper 34 can be stably maintained at a low level, the second water vapor permeability of the stopper 34 containing the material can also be stably maintained at a low level, and the second water vapor permeability of the first container 30 including the stopper 34 containing the material can also be maintained at a low level.

A compound with a main backbone of a siloxane bond includes a siloxane bond constituting a chain structure illustrated in FIG. 2C and a siloxane bond constituting a cyclic structure illustrated in FIG. 2D as an example. A compound with a siloxane bond constituting a chain structure is, for example, hexamethylcyclotrisiloxane (C₆H₁₈O₃Si₃), octamethylcyclotetrasiloxane (C₃H₂₄O₄Si₄), or decamethylcyclopentasiloxane (C₁₀H₃₀O₅Si₅). A siloxane bond constituting a chain structure makes a stopper soft and easy to stretch. The use of a siloxane bond constituting a chain structure enhances the function as a stopper. The proportion of the chain structure can be adjusted, for example, via the polymerization conditions or the vulcanization conditions. A siloxane bond for use in a rubber stopper typically includes a large number of siloxane bonds constituting a chain structure.

Fourier transform infrared spectroscopy, also referred to as FT-IR, is known as a method for evaluating a compound. A known method of Fourier transform infrared spectroscopy is infrared spectroscopy by an attenuated total reflection method, which is also referred to as attenuated total reflection-infrared spectroscopy (ATR-IR). ATR-IR can be used to quantitatively evaluate the amount of a compound with a siloxane bond constituting a chain structure and the amount of a compound with a siloxane bond constituting a cyclic structure.

ATR-IR can be used to quantitatively evaluate the amount of a compound with a siloxane bond constituting a chain structure. The intensity of the absorbance derived from a Si—O—Si stretching vibration of a siloxane bond constituting a chain structure is specified as the maximum of the absorbance in the wave number range of 1000 cm⁻¹ or more and 1020 cm⁻¹ or less in an IR spectrum. On the other hand, the intensity of the absorbance derived from a Si—O—Si stretching vibration of a siloxane bond constituting a cyclic structure is specified as the maximum of the absorbance in the wave number range of 1060 cm⁻¹ or more and 1100 cm⁻¹ or less in an IR spectrum. The absorbance in the wave number range of 1060 cm⁻¹ or more and 1100 cm⁻¹ or less is not only the intensity of the absorbance derived from a Si—O—Si stretching vibration of a siloxane bond constituting a cyclic structure but also the intensity of the absorbance derived from a Si—O—Si stretching vibration in silica particles SiO₂.

In the analysis of the stopper 34 by ATR-IR, a flat portion of the surface of the stopper 34 is targeted. For a coated stopper 34, the analysis is performed on an uncoated flat portion of the surface of the stopper 34. If there is no flat portion or no uncoated flat surface, the analysis is performed on a flat surface exposed by removing the coating.

Investigation by the present inventors showed the following matters with respect to the “cyclic and silica particle/chain ratio” calculated based on an infrared spectrum of a stopper obtained by ATR-IR. The term “cyclic and silica particle/chain ratio”, as used herein, refers to the ratio of the maximum in the wave number range of 1060 cm⁻¹ or more and 1100 cm⁻¹ or less to the maximum in the wave number range of 1000 cm⁻¹ or more and 1020 cm⁻¹ or less in an infrared spectrum of a stopper obtained by the infrared spectroscopy by the attenuated total reflection method. In other words, the “cyclic and silica particle/chain ratio” refers to the ratio of the intensity of the absorbance derived from a Si—O—Si stretching vibration of a siloxane bond constituting a cyclic structure and a Si—O—Si stretching vibration in silica particles SiO₂ to the intensity of the absorbance derived from a Si—O—Si stretching vibration of a siloxane bond constituting a chain structure. A Si—O—Si stretching vibration of a siloxane bond constituting a chain structure is an antisymmetric stretching vibration, which is observed in a silicone resin and is not observed in silica particles.

It was found that the first water vapor permeability of a material constituting the stopper and the second water vapor permeability of the stopper can be reduced by increasing the cyclic and silica particle/chain ratio as compared with the range usually adopted. The first water vapor permeability of a material constituting the stopper and the second water vapor permeability of the stopper decreased as the cyclic and silica particle/chain ratio increased. That is, as the cyclic and silica particle/chain ratio increased, it became more difficult for water vapor to permeate the stopper 34. Furthermore, increasing the cyclic and silica particle/chain ratio as compared with the range usually adopted could suppress the variation in the first water vapor permeability of a material constituting the stopper and the second water vapor permeability of the stopper in the temperature range of 5° C. or more and 40° C. or less described above. It is surmised that the upper limit of the cyclic and silica particle/chain ratio can be set to increase the ratio of a siloxane bond constituting a cyclic structure and the ratio of the silica particles, which are inorganic particles, and stably maintain low water vapor permeability.

The cyclic and silica particle/chain ratio may be 0.63 or more, 0.64 or more, 0.65 or more, or 0.66 or more. Thus, the lower limit of the cyclic and silica particle/chain ratio can be set to reduce the first water vapor permeability of a material constituting the stopper and the second water vapor permeability of the stopper. Furthermore, the lower limit of the cyclic and silica particle/chain ratio can be set as described above to suppress the variation in the first water vapor permeability of a material constituting the stopper and the second water vapor permeability of the stopper in the temperature range of 5° C. or more and 40° C. or less.

The cyclic and silica particle/chain ratio may be 0.85 or less, 0.80 or less, or 0.75 or less. A stopper with an upper limit of the cyclic and silica particle/chain ratio set as described above applied to a vial with a volume of 1 mL or more and 200 mL or less including a glass container body can sufficiently ensure the air tightness of the vial in the temperature range of 5° C. or more and 40° C. or less.

The cyclic and silica particle/chain ratio may be 0.63 or more and 0.85 or less, 0.63 or more and 0.80 or less, or 0.63 or more and 0.75 or less. The cyclic and silica particle/chain ratio may be 0.64 or more and 0.85 or less, 0.64 or more and 0.80 or less, or 0.64 or more and 0.75 or less. The cyclic and silica particle/chain ratio may be 0.65 or more and 0.85 or less, 0.65 or more and 0.80 or less, or 0.65 or more and 0.75 or less. The cyclic and silica particle/chain ratio may be 0.66 or more and 0.85 or less, 0.66 or more and 0.80 or less, or 0.66 or more and 0.75 or less.

Thus, the ratio of the maximum in the wave number range of 1060 cm⁻¹ or more and 1100 cm⁻¹ or less to the maximum in the wave number range of 1000 cm⁻¹ or more and 1020 cm⁻¹ or less (cyclic and silica particle/chain ratio) in an infrared spectrum of a stopper obtained by the infrared spectroscopy by the attenuated total reflection method may be 0.64 or more, 0.65 or more, or 0.66 or more. The ratio of the maximum in the wave number range of 1060 cm⁻¹ or more and 1100 cm⁻¹ or less to the maximum in the wave number range of 1000 cm⁻¹ or more and 1020 cm⁻¹ or less may be 0.85 or less, 0.80 or less, or 0.75 or less.

It was found that the hardness of a stopper containing a compound with a main backbone of a siloxane bond affects the first water vapor permeability of a material constituting the stopper and the second water vapor permeability of the stopper.

When the influence of the hardness of a stopper was studied, the following technical matters were found. An increase in the type A durometer hardness of a stopper containing a compound with a main backbone of a siloxane bond resulted in a decrease in the first water vapor permeability of a material constituting the stopper and the second water vapor permeability of the stopper. Furthermore, as the type A durometer hardness of a stopper containing a compound with a main backbone of a siloxane bond increased, the first water vapor permeability of a material constituting the stopper and the second water vapor permeability of the stopper decreased. From the perspective of reducing the first water vapor permeability of a material constituting the stopper and the second water vapor permeability of the first container, a lower limit may be set for the type A durometer hardness of the stopper containing the compound with the main backbone of the siloxane bond. The stopper may have a type A durometer hardness of 25 or more, 30 or more, 35 or more, or 40 or more. When a stopper containing a compound with a main backbone of a siloxane bond has a type A durometer hardness of 25 or more, the first water vapor permeability of a material constituting the stopper can be 1.0 (mg×mm/(mm²×day)) or less at a temperature of 40° C. and a relative humidity of 90%. When a stopper containing a compound with a main backbone of a siloxane bond has a type A durometer hardness of 25 or more, the first container can have a second water vapor permeability of 20 (mg/day) or less at a temperature of 40° C. and a relative humidity of 90%.

Furthermore, an increase in the type A durometer hardness of a stopper containing a compound with a main backbone of a siloxane bond could suppress the variation in the first water vapor permeability of a material constituting the stopper and the second water vapor permeability of the stopper in the temperature range of 5° C. or more and 40° C. or less. From this perspective, the stopper containing the compound with the main backbone of the siloxane bond may have a type A durometer hardness of 40 or more, 45 or more, 48 or more, or 50 or more.

A stopper containing a compound with a main backbone of a siloxane bond may have a type A durometer hardness of 60 or less, 58 or less, or 55 or less. A stopper with an upper limit of the type A durometer hardness set as described above applied to a vial with a volume of 1 mL or more and 200 mL or less including a glass container body can ensure the air tightness of the vial in the temperature range of 5° C. or more and 40° C. or less.

From the above perspective, the type A durometer hardness of a stopper containing a compound with a main backbone of a siloxane bond may be set as described below. The stopper may have a type A durometer hardness of 25 or more and 60 or less, 25 or more and 58 or less, or 25 or more and 55 or less. The stopper may have a type A durometer hardness of 30 or more and 60 or less, 30 or more and 58 or less, or 30 or more and 55 or less. The stopper may have a type A durometer hardness of 35 or more and 60 or less, 35 or more and 58 or less, or 35 or more and 55 or less. The stopper may have a type A durometer hardness of 40 or more and 60 or less, 40 or more and 58 or less, or 40 or more and 55 or less. The stopper may have a type A durometer hardness of 45 or more and 60 or less, 45 or more and 58 or less, or 45 or more and 55 or less. The stopper may have a type A durometer hardness of 48 or more and 60 or less, 48 or more and 58 or less, or 48 or more and 55 or less. The stopper may have a type A durometer hardness of 50 or more and 60 or less, 50 or more and 58 or less, or 50 or more and 55 or less.

The type A durometer hardness of a stopper refers to the type A durometer hardness of a portion of the stopper facing an opening portion of a container body as a measurement region. The type A durometer hardness of a stopper is measured as described below.

A measurement sample is prepared by removing a protrusion or the like of a stopper by cutting so that the measurement region has a constant thickness. For example, for the stopper 34 illustrated in FIG. 1C, the insertion protrusion 34b is removed to prepare a measurement sample. The measurement sample is placed on a flat table to measure the hardness. The measurement sample includes an inner surface that faces the storage space of the first container when the measurement sample is attached as a stopper to the container body, and an outer surface that is the outside of the first container when the measurement sample is attached as a stopper to the container body. The measurement sample is placed on the flat table so that the inner surface faces the flat table to measure the hardness on the outer surface.

When the measurement sample has a thickness of less than 6 mm, a plurality of measurement samples are stacked on the flat table so that the total thickness is 6 mm or more and less than 9 mm. When cutting the stopper to prepare a measurement sample, the stopper is not excessively cut so that the number of stacked pieces is minimized. All measurement samples should be placed in the same orientation with their inner surfaces facing the flat table. When the thickness changes outside the measurement region of a measurement sample, for example, when a chamfered portion is present in the peripheral portion of the stopper, a gap may occur between measurement samples stacked at the time of hardness measurement. When such a gap is formed, the outside of the measurement region of the measurement samples is cut off to make the thickness of the measurement sample constant.

An apparatus and conditions are set in consideration of the provisions of JIS K 6253-3: 2012. The indentation speed is 3.2 mm/s or less. The hardness is measured at arbitrary 10 points, and the average value of the 10 measured values is defined as the type A durometer hardness.

It has been found that the density of a stopper containing a compound with a main backbone of a siloxane bond affects the first water vapor permeability of a material constituting the stopper and the second water vapor permeability of the stopper. In general, the lower the density of the stopper, the softer and more extensible the stopper. From the perspective of enhancing the function as a stopper, a stopper with a low density has been used. As a result of studying the influence of the density of a stopper on such related art, the following technical matters were found. It has been found that an increase in the density of a stopper containing a compound with a main backbone of a siloxane bond resulted in a decrease in the first water vapor permeability of a material constituting the stopper and the second water vapor permeability of the stopper. As the density of a stopper containing a compound with a main backbone of a siloxane bond increased, the first water vapor permeability of a material constituting the stopper and the second water vapor permeability of the stopper decreased. Furthermore, when the density of a stopper containing a compound with a main backbone of a siloxane bond was increased, it was possible to suppress the variation in the first water vapor permeability of a material constituting the stopper and the second water vapor permeability of the stopper in the temperature range of 5° C. or more and 40° C. or less. From this perspective, a stopper containing a compound with a main backbone of a siloxane bond may have a density of 1.02 g/mm³ or more, may be 1.04 g/mm³ or more, may be 1.06 g/mm³ or more, 1.08 g/mm³ or more, 1.10 g/mm³ or more, 1.12 g/mm³ or more, 1.14 g/mm³ or more, or 1.16 g/mm³ or more. The density of a stopper is measured in accordance with Method A specified in JIS K 6268.

A stopper containing a compound with a main backbone of a siloxane bond may have a density of 1.24 g/mm³ or less or 1.20 g/mm³ or less. When a stopper with an upper limit of the density set in this manner is applied to a vial with a volume of 1 mL or more and 200 mL or less including a glass container body, the air tightness of the vial can be ensured in the temperature range of 5° C. or more and 40° C. or less.

From the above perspective, the density of a stopper containing a compound with a main backbone of a siloxane bond may be set as described below. A stopper may have a density of 1.02 g/mm³ or more and 1.24 g/mm³ or less or 1.02 g/mm³ or more and 1.20 g/mm³ or less. A stopper may have a density of 1.04 g/mm³ or more and 1.24 g/mm³ or less or 1.04 g/mm³ or more and 1.20 g/mm³ or less. A stopper may have a density of 1.06 g/mm³ or more and 1.24 g/mm³ or less or 1.06 g/mm³ or more and 1.20 g/mm³ or less. A stopper may have a density of 1.08 g/mm³ or more and 1.24 g/mm³ or less or 1.08 g/mm³ or more and 1.20 g/mm³ or less. A stopper may have a density of 1.10 g/mm³ or more and 1.24 g/mm³ or less or 1.10 g/mm³ or more and 1.20 g/mm³ or less. A stopper may have a density of 1.12 g/mm³ or more and 1.24 g/mm³ or less or 1.12 g/mm³ or more and 1.20 g/mm³ or less. A stopper may have a density of 1.14 g/mm³ or more and 1.24 g/mm³ or less or 1.14 g/mm³ or more and 1.20 g/mm³ or less. A stopper may have a density of 1.16 g/mm³ or more and 1.24 g/mm³ or less or 1.16 g/mm³ or more and 1.20 g/mm³ or less.

The type A durometer hardness and density of a stopper containing a compound with a main backbone of a siloxane bond can be adjusted by selection of materials, adjustment of polymerization conditions, vulcanization conditions, and the like.

Here, for samples 1 and 2 of a stopper containing a compound with a main backbone of a siloxane bond, investigation results of the variation in permeability depending on temperature conditions are described.

The samples 1 and 2 of a stopper of a compound with a main backbone of a siloxane bond were prepared. The stoppers were not sterilized. The stopper had the external shape illustrated in FIG. 1C. The plate-like portion of the stopper was in the shape of a disc with a diameter of 13 mm. The thickness in a to-be-punctured portion 34g located in the portion of the stopper facing the opening portion was 2.7 mm.

The to-be-punctured portion 34g is a portion that is scheduled to be punctured with a needle of a syringe. The to-be-punctured portion 34g is a portion that is scheduled to be punctured with a needle. The to-be-punctured portion 34g is located at the portion of the stopper 34 facing the opening portion 33. The to-be-punctured portion 34g may be exposed from a fixture 36. That is, the to-be-punctured portion 34g may not be covered with the fixture 36. As illustrated in FIG. 1C, the to-be-punctured portion 34g may be a portion with the smallest thickness in the portion of the stopper 34 facing the opening portion 33. The to-be-punctured portion 34g may be a portion located at the center of the portion of the stopper 34 facing the opening portion 33. As illustrated in FIG. 1C, the to-be-punctured portion 34g may be made visible by a raised portion 34ga or a recessed portion. The to-be-punctured portion 34g may be a portion surrounded by a plurality of raised portions 34ga or recessed portions. The to-be-punctured portion 34g may be a portion surrounded by a linear raised portion 34ga or recessed portion. The linear raised portion 34ga or recessed portion may extend perimetrically. The linear raised portion 34ga or recessed portion may extend circumferentially. The to-be-punctured portion 34g may be located on an extension line of the linear raised portion 34ga or recessed portion.

In the present description, the phrase “a portion of a stopper facing an opening portion” used in relation to the thickness includes not only the portion of the stopper facing the opening portion in the direction DA (see FIG. 1C) in which the stopper is attached to the container body to close the opening portion, but also a portion of the stopper located in the opening portion in a state where the stopper closes the opening portion of the container body. Unless otherwise specified, the thickness of the stopper is the thickness of the stopper not compressed.

The thickness of the stopper at the to-be-punctured portion 34g is measured using a measuring tool. However, when it is difficult to perform measurement as it is using a measuring tool, a value measured from an observed image of a cross section is used.

For the samples 1 and 2, the cyclic and silica particle/chain ratio was investigated. First, infrared spectra of the samples 1 and 2 were obtained by the infrared spectroscopy by the attenuated total reflection method. FIG. 2E shows the infrared spectra. In the IR spectra in FIG. 2E, the ratio of the intensity of the absorbance derived from a Si—O—Si stretching vibration of a siloxane bond constituting a cyclic structure and a Si—O—Si stretching vibration in the silica particles to the intensity of the absorbance derived from a Si—O—Si stretching vibration of a siloxane bond constituting a chain structure (an antisymmetric stretching vibration observed in the silicone resin and not observed in the silica particles) is the cyclic and silica particle/chain ratio to be specified. The intensity of the absorbance derived from the Si—O—Si stretching vibration of the siloxane bond constituting the cyclic structure and the Si—O—Si stretching vibration in the silica particles was the maximum absorbance in the wave number range of 1060 cm⁻¹ or more and 1100 cm⁻¹ or less in the IR spectra. The intensity of the absorbance derived from the Si—O—Si stretching vibration of the siloxane bond constituting the chain structure was defined as the maximum absorbance in the wave number range of 1000 cm⁻¹ or more and 1020 cm⁻¹ or less in the IR spectra. The ratio of the maximum absorbance in the wave number range of 1060 cm⁻¹ or more and 1100 cm⁻¹ or less to the maximum absorbance in the wave number range of 1000 cm⁻¹ or more and 1020 cm⁻¹ or less was taken as the cyclic and silica particle/chain ratio of each sample. The cyclic and silica particle/chain ratio of each sample is shown in the column of “Cyclic and silica particle/chain ratio” in Table 1.

The infrared spectroscopy by the attenuated total reflection method was performed under the following conditions.

### (System Configuration)

Apparatus: Nicolet 6700 Fourier transform infrared spectrometer (FT-IR) manufactured by Thermo SCIENTIFIC
Auxiliary equipment: single-reflection ATR measurement attachment (iS50 ATR) diamond ATR crystal
Measurement method: attenuated total reflection method (ATR method) (Measurement Conditions)
Detector: DTGS detector
Resolution: 4 cm⁻¹
Number of scans: 32
Incident angle: 45 degrees

### (Measurement Sample)

A silicone rubber block was pressed against a diamond crystal with a dedicated indenter of the iS50 ATR module to perform the measurement.

The type A durometer hardness of the samples 1 and 2 was measured by the method described above. Two measurement samples with a thickness of approximately 3 mm were prepared and stacked to measure the durometer hardness. The durometer hardness was measured with Asker rubber hardness meter type A manufactured by Kobunshi Keiki Co., Ltd. The type A durometer hardness of each sample is shown in the column of “Hardness” in Table 1.

The density (g/mm³) of each sample was measured in accordance with Method A specified in JIS K 6268. An electronic densimeter MD-300S manufactured by Alfa Mirage Co., Ltd. was used to measure the density. The density of each sample is shown in the column of “Density” in Table 1.

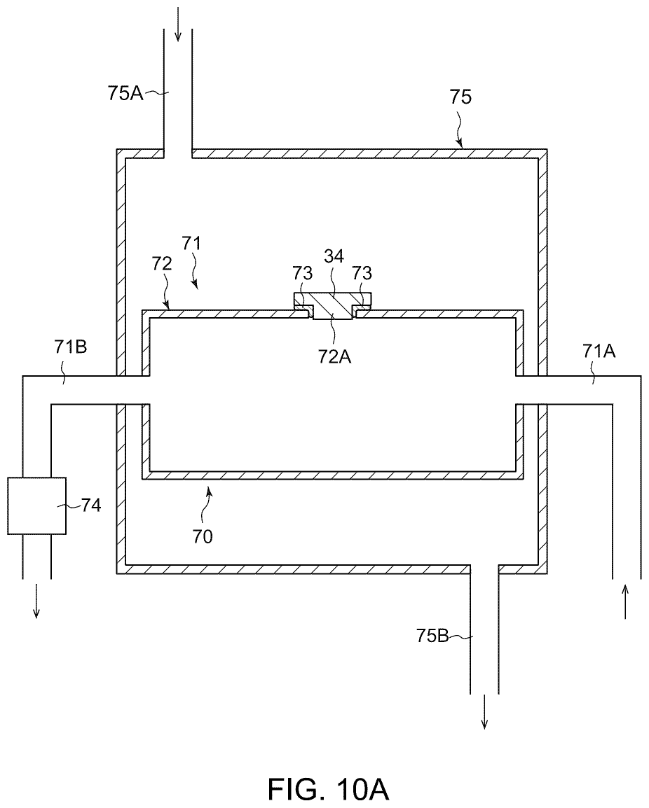

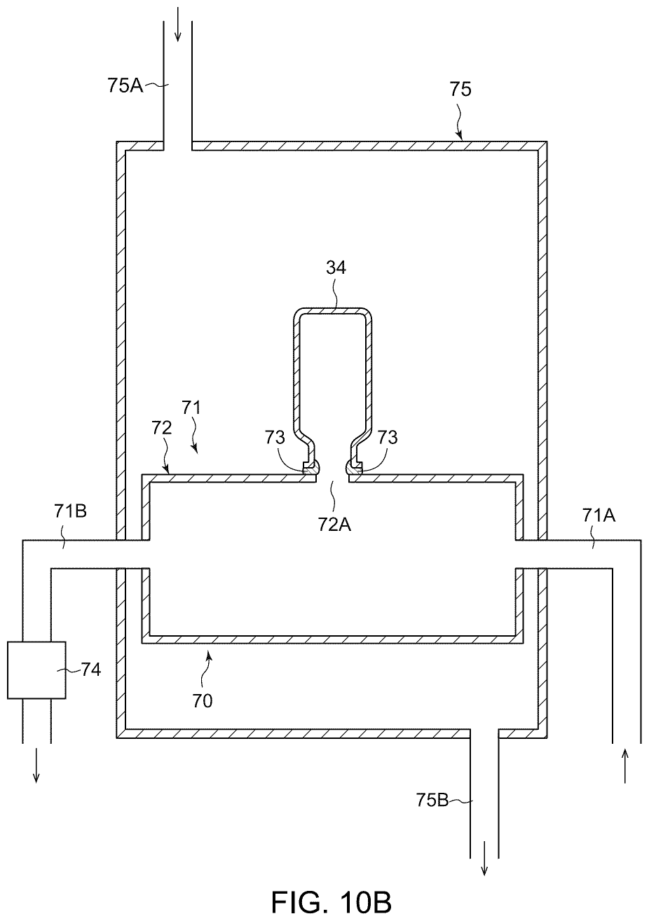

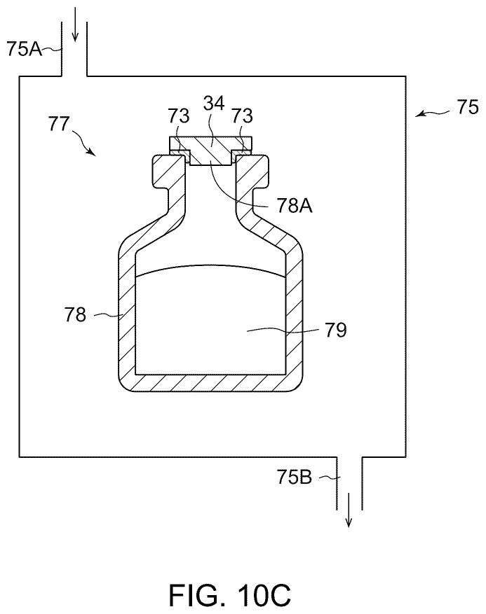

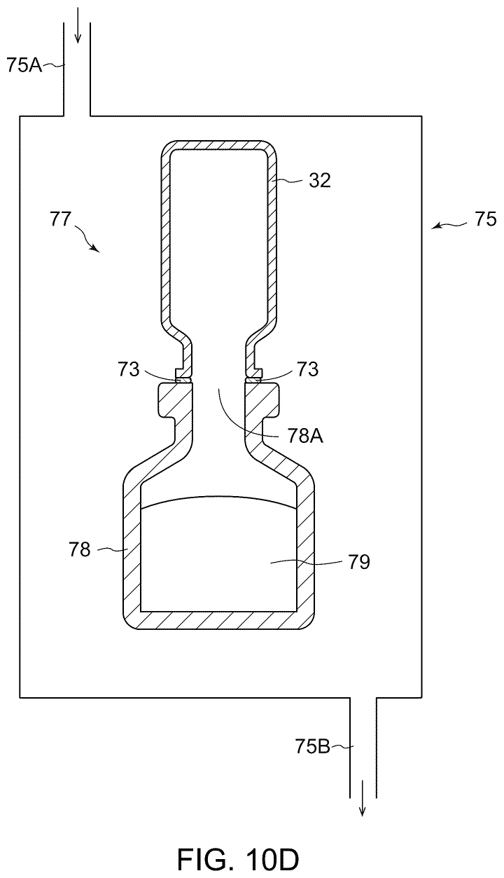

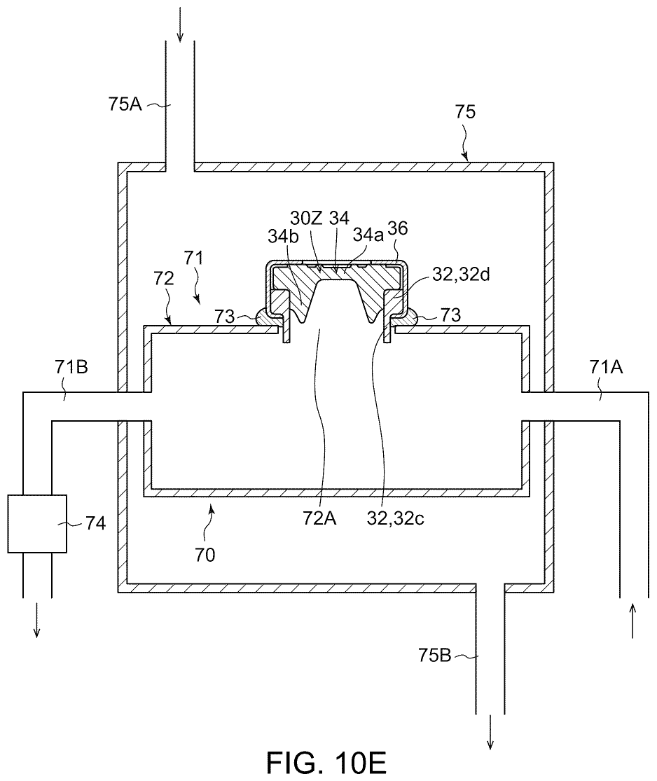

For each sample, the second water vapor permeability (mg/day) of the stopper under the environmental conditions 1 and the second water vapor permeability (mg/day) of the stopper under the environmental conditions 2 were measured. The environmental conditions 1 were a temperature of 40° C. and a relative humidity of 90%. The environmental conditions 2 were a temperature of 5° C. and a relative humidity of 90%. A method for measuring the second water vapor permeability of a stopper is described in detail later with reference to FIG. 10C. The second water vapor permeability of the first container is an indicator of the water vapor permeation amount per day through the entire first container. The second water vapor permeability of the stopper is an indicator of the water vapor permeation amount per day through the stopper incorporated in the first container. Thus, the second water vapor permeability (mg/day) of the stopper can also be said to be the water vapor permeation amount (mg/day) of the stopper.

As illustrated in FIG. 10C, the test container 77 for measuring the second water vapor permeability of the stopper is different from the test container 77 illustrated in FIG. 2B in that the stopper 34 is used instead of the test sheet 30Y. Otherwise, an apparatus for measuring the second water vapor permeability of the stopper 34 has the same configuration as the configuration of the apparatus for measuring the first water vapor permeability illustrated in FIG. 2B. In the test container 77 illustrated in FIG. 10C, the test storage portion 78 of the test container 77 is a container with an opening portion 78A. The test storage portion 78 has a water vapor barrier property. The stopper 34 faces the opening portion 78A. The opening portion 78A is closed with the stopper 34. The stopper 34 is hermetically bonded to the peripheral portion of the opening portion 78A of the test storage portion 78 by using the barrier bonding material 73 with a water vapor barrier property. The portion of the test container 77 facing the opening portion 78A of the stopper 34 is the portion of the stopper 34 facing the opening portion 33 in normal use of the first container 30. The portion of the stopper 34 in contact with the barrier bonding material 73 is the portion of the stopper 34 in contact with the container body 32 in normal use of the first container 30. The test container 77 contains the calcium chloride 79. The second water vapor permeability is evaluated as an increase in the weight of the test container 77. From a change in the weight of the test container 77, the water vapor permeation amount per day (mg/day) through the stopper 34 is the second water vapor permeability of the stopper.

The second water vapor permeability of the stopper of each sample is shown in the column of “Water vapor permeability” in Table 1. The column of “Water vapor permeability” shows the second water vapor permeability (mg/day) of the stopper under the environmental conditions 1 and the environmental conditions 2. The column of “Water vapor permeability” also shows the rate of change as the ratio of the second water vapor permeability of the stopper under the environmental conditions 1 to the second water vapor permeability of the stopper under the environmental conditions 2 (=“Water vapor permeability of stopper under environmental conditions 1”/“water vapor permeability of stopper under environmental conditions 2”).

For each sample, the oxygen permeability (third oxygen permeability) (cc/day) of the stopper under the environmental conditions 1 and the oxygen permeability (third oxygen permeability) (cc/day) of the stopper under the environmental conditions 2 were measured. The environmental conditions 1 were a temperature of 40° C. and a relative humidity of 90%. The environmental conditions 2 were a temperature of 5° C. and a relative humidity of 90%. Here, the oxygen permeability (cc/day) of the stopper to be measured is an indicator of the amount of oxygen permeating the stopper incorporated in the first container per day. Thus, the oxygen permeability (cc/day) of the stopper can also be said to be the oxygen permeation rate (cc/day) of the stopper.

As illustrated in FIG. 2F, the oxygen permeability of a stopper was measured using a test container 76 including the stopper. The test container 76 includes a test storage portion 76X. The test storage portion 76X is a container with an opening portion 76XA. The test storage portion 76X has an oxygen barrier property. The stopper 34 faces the opening portion 76XA. The opening portion 76XA is closed with the stopper 34. The stopper 34 is hermetically bonded to the peripheral portion of the opening portion 76XA of the test storage portion 76X by using the barrier bonding material 73 with an oxygen barrier property. The portion of the test container 76 facing the opening portion 76XA of the stopper 34 is the portion of the stopper 34 facing the opening portion 33 in normal use of the first container 30. The portion of the stopper 34 in contact with the barrier bonding material 73 is the portion of the stopper 34 in contact with the container body 32 in normal use of the first container 30.

The test container 76 has a volume of 9.2 mm³. The test container 76 contains only air. The concentration of oxygen in the test container 76 at the beginning of the experiment was 20.95%. The test container 76 was placed in the test atmosphere immediately after the test storage portion 76X filled with air was closed with the stopper 34. The test atmosphere was the environmental conditions 1 or the environmental conditions 2. The test atmosphere was an inert gas atmosphere substantially free of oxygen. As illustrated in FIG. 2F, the test container 76 was placed in the test chamber 75. The test chamber 75 was maintained in the test atmosphere. The test chamber 75 was supplied with an inert gas through the supply path 75A. The gas in the test chamber 75 is discharged through the discharge path 75B. After the start of the experiment, oxygen in the test container 76 disposed in the test atmosphere in the test chamber 75 permeated the stopper 34 and moved out of the test container 76. The oxygen that has moved to the outside of the test container 76 is discharged through the discharge path 75B. Using the supply path 75A and the discharge path 75B, the atmosphere in the test chamber 75 was maintained to be an inert gas atmosphere substantially free of oxygen.

The concentration of oxygen in the test container 76 was measured one day (24 hours) after the test container 76 was placed in the test atmosphere. The oxygen permeation amount per day (cc/day) through the stopper 34 was determined from the volume (mm³) of the test container 76 and the change in the oxygen concentration (%). This oxygen permeation rate was defined as the oxygen permeability (third oxygen permeability) (cc/day) of the stopper. The oxygen permeability (cc/day) of the stopper of each sample is shown in the column of “Oxygen permeability” in Table 1. The column of “Oxygen permeability” shows the oxygen permeability (cc/day) of the stopper under the environmental conditions 1 and the environmental conditions 2. The column of “Oxygen permeability” also shows the rate of change as the ratio of the oxygen permeability of the stopper under the environmental conditions 1 to the oxygen permeability of the stopper under the environmental conditions 2 (=“Oxygen permeability of stopper under environmental conditions 1”/“oxygen permeability of stopper under environmental conditions 2”).

The concentration of oxygen in the test container 76 was measured with a non-destructive, non-contact, and high-sensitivity oxygen meter OXY-1 SMA trace manufactured by PreSens, Germany. This oxygen meter is a fluorescent non-contact oxygen amount measuring device. An oxygen sensor was placed in advance in a container to be measured. The oxygen sensor emits light by itself when receiving light in a specific wavelength region. The amount of light emitted by the oxygen sensor increases with the amount of oxygen around the sensor. The oxygen amount measuring device OXY-1 SMA trace can emit light of a specific wavelength for which the oxygen sensor emits light by itself, and can measure the self-emission amount of the oxygen sensor to determine the oxygen concentration (%).

As a preliminary examination, the oxygen permeability of the stopper was measured under standard environmental conditions. The standard environmental conditions were a temperature of 23° C. and a relative humidity of 50%. As the oxygen permeability of the stopper under the standard environmental conditions, two abilities, that is, the third oxygen permeability by the measurement method using the test container 76 described with reference to FIG. 2F and the second oxygen permeability by the measurement method using the test container 70 described later with reference to FIG. 10A, were measured. The third oxygen permeability (cc/day) measured by the measurement method using the test container 76 described with reference to FIG. 2F and the second oxygen permeability (cc/day) of the stopper measured by the measurement method described later using the test container 70 illustrated in FIG. 10A were almost the same with no significant differences.

TABLE 1
Evaluation results

| | | Sam- | Sam- |
|---|---|---|---|
| | | ple 1 | ple 2 |
| Cyclic and silica particle/chain ratio | | 0.68 | 0.64 |
| Type A durometer hardness | | 53 | 30 |
| Density (mg/mm³) | | 1.162 | 1.095 |
| Water vapor | Environmental conditions 1 (40 °C) | 3.77 | 5.57 |
| permeability | Environmental conditions 2 (40 °C) | 1.21 | 1.39 |
| (mg/day) | Rate of change | 3.12 | 4.01 |
| Oxygen | Environmental conditions 1 (40 °C) | 0.43 | 0.89 |
| permeability | Environmental conditions 2 (40 °C) | 0.28 | 0.52 |
| (cc/day) | Rate of change | 1.54 | 1.71 |

The evaluation results in Table 1 show that both the water vapor permeability and the oxygen permeability increased with the temperature. As the ambient temperature increased, oxygen and water vapor were more likely to permeate the stopper. For a stopper of a compound with a main backbone of a siloxane bond, the variation in water vapor permeability with environmental conditions was greater than the variation in oxygen permeability with environmental conditions. Thus, the variation in the water vapor permeability at a temperature of 5° C. or more and 40° C. or less at which the first container 30L containing a liquid medicine is assumed to be placed for storage or the like can be reduced to stabilize the quality of the liquid medicine L.

The ratio of the second water vapor permeability (mg/day) of the stopper at a temperature of 40° C. and a relative humidity of 90% to the second water vapor permeability (mg/day) of the stopper at a temperature of 5° C. and a relative humidity of 90%, that is, the rate of change, may be 4.4 or less, 4.2 or less, 4.0 or less, 3.7 or less, 3.5 or less, 3.3 or less, or 3.1 or less. The rate of change may be 1.0 or more. The rate of change may be 1.0 or more and 4.4 or less, 1.0 or more and 4.2 or less, 1.0 or more and 4.0 or less, 1.0 or more and 3.7 or less, 1.0 or more and 3.5 or less, 1.0 or more and 3.3 or less, or 1.0 or more and 3.1 or less.

The ratio of the third oxygen permeability (cc/day) of the stopper at a temperature of 40° C. and a relative humidity of 90% to the third oxygen permeability (cc/day) of the stopper at a temperature of 5° C. and a relative humidity of 90%, that is, the rate of change, may be 2.0 or less, 1.8 or less, 1.7 or less, 1.6 or less, or 1.5 or less The rate of change may be 1.0 or more. The rate of change may be 1.0 or more and 2.0 or less, 1.0 or more and 1.8 or less, 1.0 or more and 1.7 or less, 1.0 or more and 1.6 or less, or 1.0 or more and 1.5 or less.

The first container 30L containing a liquid medicine is refrigerated for an extended period in an environment with a temperature as low as approximately 5° C. Thus, the stopper with a sufficiently low water vapor permeability (mg/day) at a temperature of 5° C. or more and a relative humidity of 90% can effectively suppress quality deterioration of the liquid medicine L. In this regard, the second water vapor permeability of the stopper at a temperature of 5° C. and a relative humidity of 90% may be 1.45 mg/day or less, 1.42 mg/day or less, 1.39 (mg/day) or less, 1.35 (mg/day) or less, 1.30 (mg/day) or less, 1.25 (mg/day) or less, or 1.21 (mg/day) or less. The water vapor permeability of the stopper may be 0 (mg/day) or more at a temperature of 5° C. and a relative humidity of 90%. Thus, the water vapor permeability of the stopper at a temperature of 5° C. and a relative humidity may be 90%, 0 mg/day or more and 1.45 mg/day or less, 0 mg/day or more and 1.42 mg/day or less, 0 mg/day or more and 1.39 mg/day or less, 0 mg/day or more and 1.35 mg/day or less, 0 mg/day or more and 1.30 mg/day or less, 0 mg/day or more and 1.25 mg/day or less, or 0 mg/day or more and 1.21 mg/day or less.

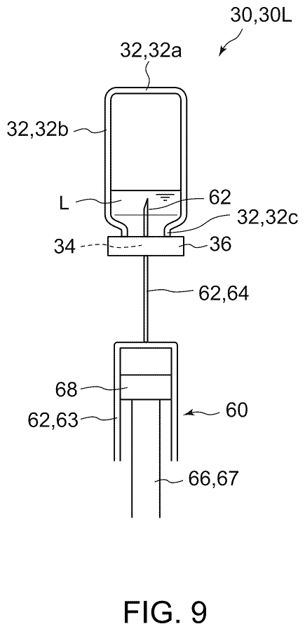

The stopper 34 is provided with specific oxygen permeability and water vapor permeability required in application to the first container 30L containing a liquid medicine. The stopper 34 that closes the opening portion 33 of the container body 32 of the first container 30 containing the liquid medicine is required to have a performance as a stopper specific to the liquid medicine, which is different from a stopper of a container containing food or the like, in addition to the specific permeabilities. As described later with reference to FIG. 9, when the liquid medicine L is taken out from a syringe 60, it can be assumed that a needle 64 of the syringe 60 punctures the stopper 34. When the stopper 34 is punctured with the needle 64, part of the stopper 34 may be separated from the other part as a fragment of the stopper. The stopper 34 of the first container 30 containing the liquid medicine L is required to suppress the formation of a fragment of the stopper. When the formation of a rubber fragment (a fragment of the stopper) at the time of puncturing with the needle 64 was examined for the stopper 34 composed of a silicone rubber with a main backbone of a siloxane bond, it was found that the formation of a rubber fragment can be suppressed due to the hardness of the stopper 34 and the thickness of the stopper 34 in the to-be-punctured portion 34g.

As described above, the to-be-punctured portion 34g is a portion to be punctured with a needle. The to-be-punctured portion 34g is included in the portion of the stopper 34 facing the opening portion 33. The to-be-punctured portion 34g may be exposed from the fixture 36. As illustrated in FIG. 1C, the to-be-punctured portion 34g may be a portion with the smallest thickness in the portion of the stopper 34 facing the opening portion 33.

In this experiment, a plurality of samples A1 to A5, B1 to B4, C1 to C4, and D1 to D4 of the first container were prepared. As illustrated in FIG. 1C, the first container serving as each sample included the container body and the stopper. The stopper closed the opening portion of the container body. The stopper was a silicone rubber stopper with a main backbone of a siloxane bond. In the plurality of samples, the hardness of the stopper and the thickness of the stopper in the to-be-punctured portion 34g were different. The rubber stopper of each sample was punctured with an injection needle 1 (made of stainless steel, 23G, regular bevel) and an injection needle 2 (made of stainless steel, 18G, regular bevel). The injection needle 2 is a thick needle used for blood transfusion. The to-be-punctured portion 34g was punctured with the injection needle in the direction DA (see FIG. 1C) in which the stopper was inserted into the opening portion. The stopper was punctured with the injection needle from above in the vertical direction. The stopper was punctured with the injection needle and was checked for the presence or absence of a rubber fragment. Each sample was punctured 20 times with each injection needle, and a sample in which a rubber fragment was formed twice or more was judged to be unacceptable, and a sample in which a rubber fragment was formed once or less (5% or less) was judged to be acceptable. The results evaluated according to the following criteria are shown in the column of “Rating” in Table 2. The column of “Hardness” in Table 2 shows the type A durometer hardness of the stopper used for each sample. The column of “Thickness” in Table 2 shows the thickness (mm) of the silicone rubber stopper in the to-be-punctured portion 34g of each sample.
Rating AA: Acceptable in both experiments using the injection needle 1 and the injection needle 2
Rating A: Acceptable only in the experiment using the injection needle 1
Rating B: Unacceptable in the experiment using the injection needle 1

TABLE 2
Evaluation results of rubber fragment

| | Thickness | | |
|---|---|---|---|
| Sample | (mm) | Hardness | Rating |
| A1 | 2.76 | 53 | A |
| A2 | 2.38 | 53 | A |
| A3 | 1.43 | 53 | AA |
| A4 | 1.02 | 53 | AA |
| A5 | 0.54 | 53 | AA |
| B1 | 2.81 | 50 | A |
| B2 | 2.14 | 50 | A |
| B3 | 1.47 | 50 | AA |
| B4 | 0.70 | 50 | AA |
| C1 | 2.80 | 42 | A |
| C2 | 1.96 | 42 | A |
| C3 | 1.28 | 42 | AA |
| C4 | 0.71 | 42 | AA |
| D1 | 2.75 | 30 | AA |
| D2 | 2.03 | 30 | AA |
| D3 | 1.44 | 30 | AA |
| D4 | 0.70 | 30 | AA |

The hardness of the stopper was a type A durometer hardness measured by the measurement method described above. The thickness of the stopper refers to a thickness in the direction DA in which the stopper is inserted into the opening portion in the to-be-punctured portion 34g, and was an arithmetic mean at five measurement points in the to-be-punctured portion 34g. The thickness of the stopper at the to-be-punctured portion 34g was the thickness of the stopper not compressed. The thickness of the stopper at the to-be-punctured portion 34g was measured with a measuring tool.

As is understood from the results shown in Table 2, when the type A durometer hardness of the stopper containing the compound with the main backbone of the siloxane bond was increased, a rubber fragment tended to be easily formed. From this perspective, to suppress the formation of a rubber fragment, it is effective to set an upper limit to the type A durometer hardness of the stopper containing the compound with the main backbone of the siloxane bond. The type A durometer hardness of the stopper 34 can be set to 60 or less to sufficiently suppress the formation of a rubber fragment. From the perspective of more effectively suppressing the formation of a rubber fragment, the stopper 34 may have a type A durometer hardness of 25 or more and 45 or less, 25 or more and 42 or less, 25 or more and 40 or less, 25 or more and 35 or less, or 25 or more and 30 or less.

As the thickness of the stopper containing the compound with the main backbone of the siloxane bond increased at the to-be-punctured portion 34g, a rubber fragment tended to be more easily formed. From this perspective, to suppress the formation of a rubber fragment, it is effective to set an upper limit to the thickness of the silicone rubber stopper containing the compound with the main backbone of the siloxane bond at the to-be-punctured portion 34g. From the perspective of suppressing the formation of a rubber fragment, the thickness of the rubber stopper containing the compound with the main backbone of the siloxane bond at the to-be-punctured portion 34g may be 4.0 mm or less, 3.9 mm or less, 3.0 mm or less, 2.8 mm or less, 1.5 mm or less, 1.2 mm or less, or 1.0 mm or less. For example, the thickness at the to-be-punctured portion 34g may be 0.50 mm or more and 4.0 mm or less, 0.50 mm or more and 3.9 mm or less, 0.50 mm or more and 3.0 mm or less, 0.50 mm or more and 2.8 mm or less, 0.50 mm or more and 1.5 mm or less, 0.50 mm or more and 1.2 mm or less, or 0.50 mm or more and 1.0 mm or less.

The United States Pharmacopeia 381 specifies a coring test for checking for the formation of a rubber fragment due to puncture with an injection needle. The conditions of the coring test described in the USP 381 are severer than the conditions of the test whose results are shown above in Table 2. Samples E1 to E4 of the first container were prepared to perform the coring test based on the USP 381 as described below.

The samples E1 to E4 of the first container were vials with a volume of 4 ml. As illustrated in FIG. 1C, the samples E1 to E4 of the first container included a container body, a stopper, and a fixture. The stopper was a silicone rubber stopper with a main backbone of a siloxane bond. The rubber stopper had a thickness of (2.7) mm. Rubber stoppers with different hardnesses were used for the samples E1 to E4.

For each of the samples E1 to E4, twelve rubber stoppers produced under the same conditions were prepared. For example, twelve rubber stoppers produced under the same conditions were prepared as the sample E1. Thus, twelve vials were evaluated for each of the samples E1 to E4.

The rubber stopper was attached to the container body, and the fixture was then wound around the container body. The first container of each sample was allowed to stand for 16 hours after the fixture was fastened. The rubber stopper of the first container of each sample was then punctured with an injection needle, and 1 ml of water was injected into the first container through the injection needle. The rubber stopper of each first container was punctured four times with the injection needle, and a total of 4 ml of water was injected.

The to-be-punctured portion 34g was punctured with the injection needle in the direction DA (see FIG. 1C) in which the stopper was inserted into the opening portion. The stopper was punctured with the injection needle from above in the vertical direction. The four puncture positions in one rubber stopper were separated as far as possible in the to-be-punctured portion. The injection needle was changed after every four punctures. The rubber stopper of the same first container was punctured with the same injection needle.

In the USP 381, the use of a 21G needle as an injection needle is prescribed. Thus, an injection needle 3 (made of stainless steel, 21G, regular bevel) was used as the 21G injection needle in the coring test. The coring test was also performed using an injection needle 1 (made of stainless steel, 23G, regular bevel) and an injection needle 2 (made of stainless steel, 18G, regular bevel), which are out of the regulation of the USP 381. The test using the injection needles 1 to 3 was performed on different rubber stoppers.

After puncturing four times, the presence or absence of a rubber fragment in the first container was examined. More specifically, water in the first container after the test was filtered through a membrane filter to collect rubber fragments on the membrane filter. The membrane filter had a pore size of 0.45 μm. When a rubber fragment with a maximum length of 50 μm or more was collected, it was determined that a rubber fragment was formed in the first container.

Table 3 shows the results of the coring test on each of the samples E1 to E4 using the injection needles 1 to 3. Table 3 shows the number of rubber fragments formed in twelve first containers in the coring test using each of the injection needles 1 to 3.

The type A durometer hardness of the silicone rubber stoppers with the main backbone of the siloxane bond constituting the samples E1 to E4 was measured by the method described above. The rubber stopper of the sample E1 had a type A durometer hardness of 27. The rubber stopper of the sample E2 had a type A durometer hardness of 31. The rubber stopper of the sample E3 had a type A durometer hardness of 41. The rubber stopper of the sample E4 had a type A durometer hardness of 54.

Infrared spectra of the samples E1 to E4 were obtained by the infrared spectroscopy by the attenuated total reflection method. The conditions used in the infrared spectroscopy by the attenuated total reflection method for the samples E1 to E4 were identical to the conditions used in the infrared spectroscopy by the attenuated total reflection method for the samples 1 and 2. The peak intensity ratio for the samples E1 to E4 was calculated based on the obtained infrared spectra. The peak intensity ratio is the ratio of the maximum in the wave number range of 1060 cm⁻¹ or more and 1100 cm⁻¹ or less to the maximum in the wave number range of 1240 cm⁻¹ or more and 1280 cm⁻¹ or less in an infrared spectrum of the stopper obtained by the infrared spectroscopy by the attenuated reflection method. The peak intensity ratio is in the range of 0 or more and 1 or less.

As described above, the maximum in the wave number range of 1060 cm⁻¹ or more and 1100 cm⁻¹ or less includes the intensity of the absorbance derived from a Si—O—Si stretching vibration of a siloxane bond constituting a cyclic structure and the intensity of the absorbance derived from a Si—O—Si stretching vibration in silica particles SiO₂. On the other hand, the maximum in the wave number range of 1240 cm⁻¹ or more and 1280 cm⁻¹ or less includes the peak intensity derived from the vibration of Si—CH₃ constituting a chain structure of a siloxane bond. The peak intensity ratio can be an indicator of “the peak intensity derived from silica”/“the peak intensity derived from Si—CH₃”, in other words, the magnitude of the silica particle ratio.

For each of the samples E1 to E4, the peak intensity derived from the silica particles in the infrared spectrum, that is, the maximum in the wave number range of 1060 cm⁻¹ or more and 1100 cm⁻¹ or less, was measured. The maximum (peak intensity) was described in the column of “First intensity” in Table 3.

For each of the samples E1 to E4, the peak intensity derived from Si—CH₃ in the infrared spectrum, that is, the maximum in the wave number range of 1240 cm⁻¹ or more and 1280 cm⁻¹ or less, was measured. The maximum (peak intensity) was shown in the column of “Second intensity” in Table 3.

For each of the samples E1 to E4, a peak intensity ratio as the ratio of “First intensity” to “Second intensity” was calculated. The calculated peak intensity ratio is shown in the column of “Intensity ratio” in Table 3.

For the rubber stopper of the sample E1, the first intensity including the peak intensity derived from silica was 0.483, the second intensity, which is the peak intensity derived from Si—CH₃, was 0.568, and the peak intensity ratio was 0.850. For the rubber stopper of the sample E2, the first intensity was 0.433, the second intensity was 0.650, and the peak intensity ratio was 0.666. For the rubber stopper of the sample E3, the first intensity was 0.417, the second intensity was 0.641, and the peak intensity ratio was 0.651. For the rubber stopper of the sample E4, the first intensity was 0.416, the second intensity was 0.680, and the peak intensity ratio was 0.612.

TABLE 3
Evaluation results of rubber fragment 2

| | | Sample | | | |
|---|---|---|---|---|---|
| | | E1 | E2 | E3 | E4 |
| Injection needle 1 (23G) | | 0 | 0 | 0 | 0 |
| Injection needle 3 (21G) | | 0 | 0 | 0 | 22 |
| Injection needle 2 (18G) | | 0 | 0 | 16 | Untested |
| Hardness | | 27 | 31 | 41 | 54 |
| ATR-IR | First intensity | 0.483 | 0.433 | 0.417 | 0.416 |
| | Second intensity | 0.568 | 0.650 | 0.641 | 0.680 |
| | Intensity ratio | 0.850 | 0.666 | 0.651 | 0.612 |

According to the USP 381, the acceptable number of rubber fragments in twelve first containers using the 21G injection needle 3 is 5 or less.

The results in Table 3 show that, when the type A durometer hardness of the rubber stopper with the main backbone of the siloxane bond was increased, a rubber fragment tended to be easily formed. From this perspective, to suppress the formation of a rubber fragment, it is effective to set an upper limit to the type A durometer hardness of the rubber stopper. The type A durometer hardness of the stopper can be set to 60 or less to sufficiently suppress the formation of a rubber fragment. From the perspective of more effectively suppressing the formation of a rubber fragment, the stopper may have a type A durometer hardness of 45 or less, 41 or less, 40 or less, 35 or less, 31 or less, or 30 or less.

The type A durometer hardness of the rubber stopper with the main backbone of the siloxane bond can be set to 25 or more to reduce the first water vapor permeability of a material constituting the stopper to 1.0 (mg×mm/(mm²×day)) or less at a temperature of 40° C. and a relative humidity of 90%. The type A durometer hardness of the rubber stopper with the main backbone of the siloxane bond can be set to 25 or more to reduce the second water vapor permeability of a material constituting the stopper to 20 (mg/day) or less at a temperature of 40° C. and a relative humidity of 90%.

From these perspectives, the type A durometer hardness of the stopper with the main backbone of the siloxane bond may be set as described below. The stopper may have a type A durometer hardness of 25 or more and 45 or less, 25 or more and 41 or less, 25 or more and 40 or less, 25 or more and 35 or less, 25 or more and 31 or less, or 25 or more and 30 or less.

Furthermore, from the results of the peak intensity ratio as “Intensity ratio” shown in Table 3, the proportion of the silica particles could be increased (the peak intensity ratio could be increased) to suppress the formation of a rubber fragment. From this perspective, to suppress the formation of a rubber fragment, the peak intensity ratio calculated by “First intensity”/“Second intensity” specified by ATR-IR for the rubber stopper may be set as described below. The stopper may have a peak intensity ratio of 0.620 or more, 0.630 or more, 0,640 or more, 0,645 or more, 0.651 or more, 0.655 or more, or 0.666 or more.

The first intensity including “Intensity derived from silica” could be made smaller than the second intensity, which is “Intensity derived from Si—CH₃”, to suppress the formation of a rubber fragment. More specifically, the peak intensity ratio could be less than 1 to suppress the formation of a rubber fragment. Although the reason for this phenomenon is not clear in detail, one possible reason is that the first intensity including “Intensity derived from silica” higher than the second strength, which is “Intensity derived from Si—CH₃”, results in a brittle rubber stopper.

The peak intensity ratio, which is the ratio of the maximum in the wave number range of 1060 cm⁻¹ or more and 1100 cm⁻¹ or less to the maximum in the wave number range of 1240 cm⁻¹ or more and 1280 cm⁻¹ or less in an infrared spectrum of the stopper obtained by the infrared spectroscopy by the attenuated total reflection method, may be set as described below. The peak intensity ratio may be 0.620 or more and less than 1.0, 0.630 or more and less than 1.0, 0.640 or more and less than 1.0, 0.645 or more and less than 1.0, 0.651 or more and less than 1.0, 0.655 or more and less than 1.0, or 0.666 or more and less than 1.0.

A compound with a main backbone of a siloxane bond is usually produced by various vulcanization reactions. For example, it is produced by an addition reaction using a peroxide or an addition reaction using a platinum catalyst. In such a production method, in particular, production using a peroxide is simple because reaction control using heat is easy, and is high in stability when a rubber with a low hardness is produced. Thus, the production method involving a reaction with a peroxide can more stably produce a compound that has both low hardness, which reduces the likelihood of rubber fragment formation, and a high peak intensity ratio, which also reduces the likelihood of rubber fragment formation.

Furthermore, the stopper 34 that closes the opening portion 33 of the container body 32 of the first container 30 containing the liquid medicine is required to suppress liquid leakage and gas leakage when the needle 64 of the syringe 60 is inserted. Thus, even in a state where the stopper 34 is punctured with the needle 64, the first container 30 is preferably liquid-tight and air-tight. When the occurrence of liquid leakage or gas leakage at the time of puncturing with the needle 64 was examined for the stopper 34 composed of the silicone rubber with the main backbone of the siloxane bond, it was found that the occurrence of the leakage can be suppressed due to the hardness of the stopper 34 and the thickness of the stopper 34 in the to-be-punctured portion 34g.

In this experiment, a plurality of samples A1 to A4, B1 to B4, C1 to C4, and D1 to D4 of the first container were prepared. The samples A1 to A4, B1 to B4, C1 to C4, and D1 to D4 used in the leakage experiment were respectively identical to the samples A1 to A4, B1 to B4, C1 to C4, and D1 to D4 used in the confirmatory experiment of a rubber fragment. In this experiment, the first container contained water.

In a first experiment, the presence or absence of liquid leakage and gas leakage was examined in a state in which the rubber stopper of each sample was punctured with the injection needle 1 (made of stainless steel, 23G, regular bevel). The piston of the syringe was moved relative to the cylinder in a state in which the stopper was punctured with the needle, and the presence or absence of liquid leakage and gas leakage was examined from the feeling of operating the piston. Furthermore, regarding the liquid leakage, in the state illustrated in FIG. 9, that is, in a state in which the syringe was located below the first container in the vertical direction in a state where the stopper was punctured with the needle, it was also examined whether or not the liquid was leaked at the needle puncture position of the stopper. Regarding the gas leakage, in the state illustrated in FIG. 9, it was also examined whether or not the gas passing through the stopper appeared as bubbles in the water. In the first experiment, all the samples had no gas leakage or liquid leakage.

As a second experiment, the presence or absence of liquid leakage and gas leakage was examined in a state in which the rubber stopper of the sample after the first experiment was punctured again with the injection needle 1. In the second experiment, the injection needle 1 was inserted at a position different from the position in the rubber stopper punctured with the injection needle 1 in the first experiment. All the samples had no gas leakage or liquid leakage at the needle puncture position in the second experiment. In some samples, however, gas leakage occurred at the needle puncture position of the first experiment during the second experiment.

The results of the leakage test are shown in the column of “Rating” in Table 4. Table 4 shows the evaluation results based on the following criteria. The column of “Hardness” in Table 4 shows the type A durometer hardness of the stopper used for each sample. The column of “Thickness” in Table 4 shows the thickness (mm) of the silicone rubber stopper in the to-be-punctured portion 34g of each sample.
AA: No leakage occurred in both the first experiment and the second experiment
A: No leakage occurred in the first experiment, but in the second experiment gas leakage occurred from the needle puncture position of the first experiment
B: Leakage occurred in the first experiment

TABLE 4
Evaluation results of leakage

| | Thickness | | |
|---|---|---|---|
| Sample | (mm) | Hardness | Rating |
| A1 | 2.76 | 53 | A |
| A2 | 2.38 | 53 | A |
| A3 | 1.43 | 53 | A |
| A4 | 1.02 | 53 | A |
| B1 | 2.81 | 50 | A |
| B2 | 2.14 | 50 | A |
| B3 | 1.47 | 50 | A |
| B4 | 0.70 | 50 | A |
| C1 | 2.80 | 42 | AA |
| C2 | 1.96 | 42 | AA |
| C3 | 1.28 | 42 | AA |
| C4 | 0.71 | 42 | A |
| D1 | 2.75 | 30 | AA |
| D2 | 2.03 | 30 | AA |
| D3 | 1.44 | 30 | AA |
| D4 | 0.70 | 30 | A |

An increase in the type A durometer hardness of the stopper containing the compound with the main backbone of the siloxane bond tends to result in a higher risk of leakage. From this perspective, it is effective to set an upper limit to the type A durometer hardness of the stopper containing the compound with the main backbone of the siloxane bond in order to suppress the leakage. From the perspective of suppressing the leakage, the stopper can have a type A durometer hardness of 60 or less to sufficiently suppress the leakage. From the perspective of more effectively suppressing the leakage, the stopper may have a type A durometer hardness of 25 or more and 45 or less, 25 or more and 42 or less, 25 or more and 40 or less, 25 or more and 35 or less, or 25 or more and 30 or less.

The stopper containing the compound with the main backbone of the siloxane bond having a smaller thickness at the to-be-punctured portion 34g tends to have a higher risk of the leakage. From this perspective, to suppress the leakage, it is effective to set a lower limit to the thickness of the stopper containing the compound with the main backbone of the siloxane bond at the to-be-punctured portion 34g. From the perspective of suppressing the leakage, the stopper containing the compound with the main backbone of the siloxane bond at the to-be-punctured portion 34g may have a minimum thickness of 0.70 mm or more, 0.90 mm or more, 1.0 mm or more, or 1.2 mm or more. The stopper containing the compound with the main backbone of the siloxane bond may have a minimum thickness of 3.0 mm or less or 2.8 mm or less at the to-be-punctured portion 34g. The minimum thickness at the to-be-punctured portion 34g may be 0.70 mm or more and 3.0 mm or less, 0.90 mm or more and 3.0 mm or less, 1.0 mm or more and 3.0 mm or less, or 1.2 mm or more and 3.0 mm or less. The minimum thickness at the to-be-punctured portion 34g may be 0.70 mm or more and 2.8 mm or less, 0.90 mm or more and 2.8 mm or less, 1.0 mm or more and 2.8 mm or less, 1.2 mm or more and 2.8 mm or less.

Since the stopper 34 has oxygen permeability, the container body 32 may have an oxygen barrier property. As illustrated in FIG. 1C, the container body 32 may include a bottom portion 32a, a trunk portion 32b, a neck portion 32c, and a head portion 32d in this order. As illustrated in FIG. 1C, a storage space S for the liquid medicine L is formed mainly by the bottom portion 32a and the trunk portion 32b. The head portion 32d forms an end portion of the container body 32. The head portion 32d is thicker than other portions. The neck portion 32c is located between the trunk portion 32b and the head portion 32d. The neck portion 32c has a smaller width, particularly a smaller diameter, relative to the trunk portion 32b and the head portion 32d.

The container body 32 may include a transparent portion. The transparent portion of the container body 32 enables the stored liquid medicine L to be observed from the outside of the container body 32. The term “transparent” means that a target portion has a transmission haze of 80.0 or less so that the inside of the target portion can be observed from the outside. At least part of the container body 32 may have a transmission haze of 58.0% or less, 29.0% or less, 14.5% or less, 7.0% or less, 3.5% or less, or 1.0% or less so that the target portion can be more clearly observed from the outside.

A light source simulating the spectrum of D65 standard light (hereinafter referred to as a “D65 standard light source”) is used to measure the transmission haze. Before measuring the transmission haze, the D65 standard light source is turned on for 15 minutes to stabilize the output of the D65 standard light source. The incident angle to the sample to measure the transmission haze is 0 degrees. The test environment for measuring the transmission haze is a temperature of 23° C.±2° C. and a relative humidity of 50%±5%. The sample is placed in the test environment for 16 hours before the test. The other conditions for measuring the transmission haze are in accordance with JAS K 7136: 2000. The transmission haze is an arithmetic mean of five measured values. The five measured values are measured at five measurement positions of a measurement sample to be evaluated.

The first container 30 illustrated in FIG. 1C further includes the fixture 36. The fixture 36 restrains the stopper 34 from coming off the container body 32. The fixture 36 is attached to the head portion 32d of the container body 32. As illustrated in FIG. 1C, the fixture 36 covers the periphery of the plate-like portion 34a of the stopper 34. The fixture 36 presses the flange portion of the plate-like portion 34a toward the head portion 32d. Thus, the fixture 36 restrains the stopper 34 from coming off the container body 32 while exposing part of the stopper 34. This can also make the space between the stopper 34 and the container body 32 liquid-tight and air-tight. The fixture 36 makes the first container 30 air-tight. The fixture 36 may be a sheet-like metal fixed to the head portion 32d. The fixture 36 may be a cap screwed to the head portion 32d. The fixture 36 made of a metal may have an oxygen barrier property.

The first container 30 may have a volume of 1.0 mL or more, 3.0 mL or more, or 5.0 mL or more. The first container 30 may have a volume of 200 mL or less, 100 mL or less, 50 mL or less, 30 mL or less, or 20 mL or less.

Incidentally, the first container 30 illustrated in FIG. 1C is a vial. The container body 32 of the first container 30 may be a glass bottle. The glass bottle is a container made of glass. The glass bottle may be colorless or colored. The container body 32 is formed of, for example, borosilicate glass. The container body 32 as a glass bottle may have an oxygen barrier property and a water vapor barrier property. The vial is a container including a container body, a stopper inserted into an opening portion of the container body, and a seal as a fixture 36 for fixing the stopper, and the seal is swaged together with the stopper to a head portion of the container body by using a hand gripper or the like.

The first container 30 as a vial may have a volume of 1.0 mL or more or 3.0 mL or more. The first container 30 as a vial may have a volume of 200 mL or less, 100 mL or less, 50 mL or less, 30 mL or less, or 20 mL or less.

The first container 30 as a vial may have a volume of 1.0 mL or more and 200 mL or less, 1.0 mL or more and 100 mL or less, 1.0 mL or more and 50 mL or less, 1.0 mL or more and 30 mL or less, or 1.0 mL or more and 20 mL or less. The first container 30 as a vial may have a volume of 200 mL or less, 3.0 mL or more and 100 mL or less, 3.0 mL or more and 50 mL or less, 3.0 mL or more and 30 mL or less, or 3.0 mL or more and 20 mL or less.

An oxygen-permeable portion of the first container 30 can promote oxygen permeation in a state of being in contact with a gas in the headspace HS or the like rather than being in contact with the liquid medicine L. An oxygen-permeable and water-vapor-permeable portion of the first container 30 can suppress water vapor permeation in a state of being in contact with the liquid medicine L rather than being in contact with a gas in the headspace HS or the like. From the perspective of promoting oxygen permeation through the first container 30, the oxygen-permeable portion of the first container 30 is preferably not in contact with the liquid medicine L. When the liquid medicine L is not in contact with the stopper 34 in the normal posture of the first container 30 including the container body 32 and the stopper 34, the quality deterioration of the liquid medicine L can be stably suppressed by making the stopper 34 oxygen-permeable and imparting the first oxygen permeability in the predetermined range and the second oxygen permeability in the predetermined range to the stopper. In this regard, the first container 30 as a vial can be stably placed on a placement surface by bringing the bottom portion 32a of the container body 32 into contact with the placement surface. At this time, the stopper 34 is away from the liquid medicine L. The stopper 34 is not in contact with the liquid medicine L. Thus, in a normal storage state of the first container 30, permeation of oxygen in the first container 30 through the first container 30 can be promoted.

The first container 30 illustrated in FIG. 1C can maintain a negative internal pressure while being subjected to atmospheric pressure. The first container 30 can contain a gas at a negative pressure while being subjected to atmospheric pressure. The first container 30 may also contain a gas at a positive pressure while being subjected to atmospheric pressure. In these examples, the first container 30 may have sufficient rigidity to maintain its shape. However, the first container 30 may be deformed to some extent at atmospheric pressure when the internal pressure is maintained at a negative pressure or a positive pressure. The first container 30 that can maintain the internal pressure at a negative pressure or a positive pressure is, for example, the vial described above or a can made of metal.

The phrase “can contain a gas at a negative pressure while being subjected to atmospheric pressure” means that the gas can be stored without breakage while the internal pressure is maintained at a negative pressure of 0.80 atm or more. A container that can contain a gas at a negative pressure while being subjected to atmospheric pressure may be in an air-tight state when the internal pressure is 0.80 atm. In a container that can contain a gas at a negative pressure while being subjected to atmospheric pressure, the volume at an internal pressure of 0.80 atm may be maintained at 95% or more of the volume at an internal pressure of 1.0 atm. The phrase “can contain a gas at a positive pressure while being in the atmosphere” means that the gas can be stored without breakage while the internal pressure is maintained at a positive pressure of 1.2 atm or less. A container that can contain a gas at a positive pressure while being subjected to atmospheric pressure may be in an air-tight state when the internal pressure is 1.20 atm. In a container that can contain a gas at a positive pressure while being subjected to atmospheric pressure, the volume at an internal pressure of 1.2 atm may be maintained at 105% or less of the volume at an internal pressure of 1.0 atm.

The first container 30 is intended to be stored in the second container 40. The first container 30 stored in the second container 40 may be able to store the gas without breakage when the difference between the internal pressure of the first container 30 and the internal pressure of the second container 40 is 0.2 atm or less. The first container 30 stored in the second container 40 may be in an air-tight state when the difference between the internal pressure of the first container 30 and the internal pressure of the second container 40 is 0.2 atm or less. When the difference between the internal pressure of the first container 30 and the internal pressure of the second container 40 is 0.2 atm or less, the first container 30 stored in the second container 40 may have a volume of 95% or more and 105% or less of the volume of the first container 30 when the internal pressure of the first container 30 is equal to the internal pressure of the second container 40. In these states in which the first container 30 is stored in the second container 40, the internal pressure of the first container 30 may be lower than the internal pressure of the second container 40, or the internal pressure of the first container 30 may be higher than the internal pressure of the second container 40.

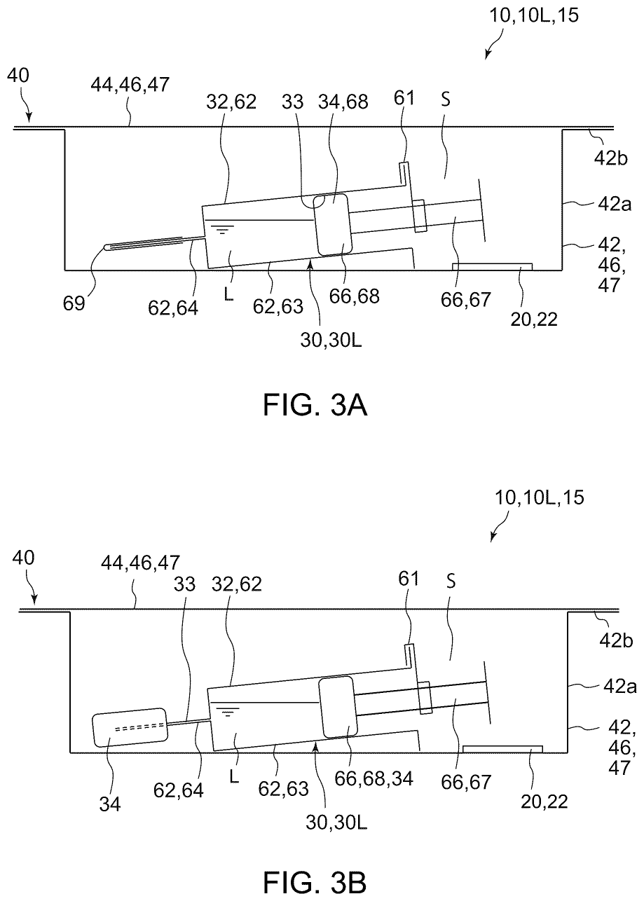

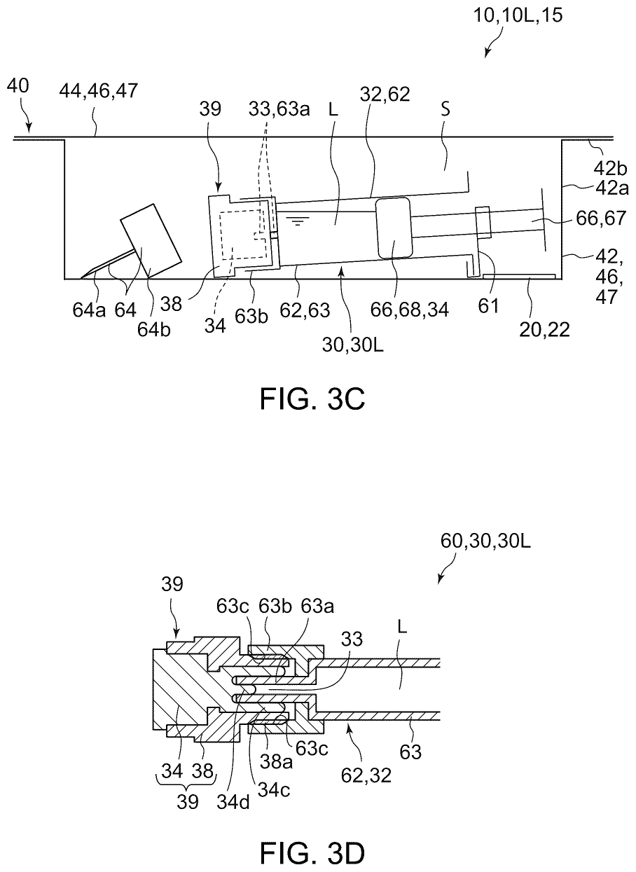

The first container 30 is not limited to a vial. As an example, the first container 30 may include the syringe 60. As illustrated in FIGS. 3A to 3C, the syringe 60 constituting the first container 30 may include a cylinder 62 and a piston 66. The cylinder 62 stores the liquid medicine L. The cylinder 62 constitutes the container body 32. The piston 66 is partially inserted into the cylinder 62.

As illustrated in FIG. 3A, the cylinder 62 may include a glass or plastic cylinder body 63 and a metal needle 64. The cylinder 62 is the container body 32 of the first container 30 and forms the storage space S for the liquid medicine L. The piston 66 may include a glass or resin piston body 67 and a gasket 68 disposed in the opening portion 33 of the cylinder 62.

The gasket 68 may constitute the stopper 34 of the first container 30. The gasket 68 may close the opening portion 33 of the cylinder 62 constituting the container body 32. The opening portion 33 of the cylinder 62 is open on the side opposite the needle 64. The piston 66 is inserted into the cylinder 62 through the opening portion 33. The storage space S for the liquid medicine L is defined between the cylinder 62 and the gasket 68. The syringe 60 may further include a cap 69. The cap 69 is removably attached to the needle 64. The cap 69 seals the syringe 60 to enclose the liquid medicine L and restricts the leakage of the liquid medicine L from the needle 64. In the example illustrated in FIG. 3A, the syringe 60 can be used as the first container 30 to use the syringe 60 taken out from the second container 40 for a patient or the like as it is.

In the example illustrated in FIG. 3A, the first oxygen permeability and the first water vapor permeability of a material constituting the gasket 68, which is the stopper 34, may be set in the above ranges. A material of the gasket 68 can be the same as the material of the stopper 34 described above. The gasket 68 may include silicone or silicone rubber. The cylinder 62 may have an oxygen barrier property or a water vapor barrier property.

As in the example illustrated in FIG. 3B, the cylinder 62 may include the cylinder body 63 into which the piston 66 is inserted, and the needle 64 coupled to the cylinder body 63 and including the opening portion 33. The needle 64 constitutes the opening portion 33. The syringe 60 as the first container 30 may further include the stopper 34 that closes the opening portion 33 provided in the cylinder 62. In this example, the stopper 34 with the predetermined first oxygen permeability and first water vapor permeability may be punctured with the needle 64, and the stopper 34 may close the opening portion 33 opened at an end of the needle 64.

As in the example illustrated in FIG. 3C, the cylinder 62 may include the cylinder body 63, which includes the opening portion 33 and into which the piston 66 is inserted, and the needle 64 that can be attached to the cylinder body 63 to cover the opening portion 33. The syringe 60 constituting the first container 30 may be stored in the second container 40 in a state where the needle 64 is removed. As illustrated in FIG. 3C, the cylinder body 63 may include a protruding tip 63a. An opening portion 33 is formed in the protruding tip 63a. The cylinder body 63 including the protruding tip 63a may be made of glass or resin. The cylinder body 63 including the protruding tip 63a may have an oxygen barrier property. The cylinder body 63 including the protruding tip 63a may have a water vapor barrier property.

The needle 64 can be attached to the protruding tip 63a to cover the opening portion 33. The needle 64 can be fixed to the cylinder body 63 to cover the opening portion 33. The syringe 60 may include the stopper 34 that can be fixed to the cylinder body 63. The stopper 34 may be attachable to the protruding tip 63a. The stopper 34 with the predetermined first oxygen permeability and first water vapor permeability may close the opening portion 33 in a state of being fixed to the cylinder body 63.

FIG. 3D is a partial cross-sectional view of a specific example of the syringe 60 illustrated in FIG. 3C. In the specific example illustrated in FIG. 3D, the cylinder 62 may further include a cylinder holder 63b located around the protruding tip 63a of the cylinder body 63. The cylinder holder 63b may include an inside screw 63c. The cylinder holder 63b may be a seamless integral component with the cylinder body 63. The cylinder holder 63b may be configured as a component separate from the cylinder body 63. The cylinder body 63 is made of, for example, glass. The cylinder body 63 may have an oxygen barrier property. The cylinder body 63 may have a water vapor barrier property. The cylinder holder 63b may have a resin material. The cylinder holder 63b may have oxygen permeability.

The stopper 34 may be handled as a stopper member 39 together with a stopper holder 38. The stopper holder 38 is tubular. The stopper holder 38 holds the stopper 34 therein. The stopper holder 38 may be formed of a resin material. The stopper holder 38 may have oxygen permeability. The stopper holder 38 is removably attached to the cylinder 62. In a state where the stopper holder 38 is attached to the cylinder body 63, the stopper 34 held by the stopper holder 38 closes the opening portion 33 in the protruding tip 63a. The stopper holder 38 holds the stopper 34 so as not to be relatively movable in the axial direction. The stopper holder 38 may include an outside screw 38a that mates with the inside screw 63c of the cylinder holder 63b. The stopper 34 includes a tubular portion 34c that comes into contact with the periphery of the protruding tip 63a, and an insertion closing portion 34d that is inserted into the opening portion 33 of the protruding tip 63a. The tubular portion 34c and the insertion closing portion 34d can be pressed against the protruding tip 63a to hermetically close the opening portion 33. In this example, due to the elasticity of the cylinder holder 63b, the cylinder holder 63b pushes the stopper member 39 toward the protruding tip 63a. This stably maintains the air tightness of the opening portion 33. From the perspective of promoting the oxygen permeation through the stopper 34, as illustrated in FIG. 3D, the stopper 34 may not be at least partially covered with the stopper holder 38. In other words, the stopper 34 may be at least partially exposed from the stopper holder 38.

In the example illustrated in FIG. 3C, the needle 64 may include a tubular needle portion 64a and a holding portion 64b that holds the needle portion 64a. The holding portion 64b may include an outside screw that mates with the inside screw 63c of the cylinder holder 63b.

In the examples shown in FIGS. 3B to 3D, the first oxygen permeability and the first water vapor permeability of a material constituting the stopper 34 may be set within the above ranges. A material of the stopper 34 can be the same as the material of the stopper 34 described above. The stopper 34 may include silicone or silicone rubber. The cylinder 62 may have an oxygen barrier property or a water vapor barrier property.

In the examples shown in FIGS. 3B to 3D, the first oxygen permeability and the first water vapor permeability of a material constituting the gasket 68 may be set within the above ranges. A material constituting the gasket 68 can be the same as the material of the stopper 34 described above. The gasket 68 may include silicone or silicone rubber.

In the example shown in FIGS. 3A to 3D, oxygen in the storage space defined by the syringe 60, the gasket 68, the stopper 34, and the like can permeate the stopper 34 and the gasket 68. The oxygen that has moved out of the syringe 60 can be absorbed by an oxygen absorber 22 in the second container 40. This can reduce the oxygen content of the syringe 60, which is the first container 30, and suppress the oxygen degradation of the liquid medicine L. This also suppresses water vapor permeation through the stopper 34 and the gasket 68. Thus, it is possible to suppress the occurrence of a change in concentration due to a decrease in water from the liquid medium of the liquid medicine L and suppress the hydrolysis of a pharmaceutical ingredient of the liquid medicine L due to the movement of the water vapor in the second container 40 into the syringe 60. Thus, the quality deterioration of the liquid medicine L due to the water vapor permeation can be suppressed.

The second container 40 has a volume for storing the first container 30. The second container 40 can be sealed, for example, by welding, such as heat sealing or ultrasonic bonding, or by bonding using a bonding material, such as a tackifier or an adhesive material. The second container 40 may be an air-tight container. The second container 40 may have a volume of, for example, 5 mL or more and 1200 mL or less. In the case that the first container 30 is a small container, such as a vial, for example, a container with a volume of 1 mL or more and 20 mL or less, the second container may have a volume of 1.5 mL or more and 500 mL or less.

The second container 40 has an oxygen barrier property. An object with an oxygen barrier property means that the material constituting the object has an oxygen permeation rate (mL/(m²×day×atm)) of 10000 or less. The material constituting an object with an oxygen barrier property, for example, a container, may have an oxygen permeation rate (mL/(m²×day×atm)) of 10 or less, 5.0 or less, 1.0 or less, 0.50 or less, or 0.10 or less. The oxygen permeation rate is measured in an environment with a temperature of 23° C. and a relative humidity of 50% using the permeability measuring instrument OXTRAN (2/61) manufactured by MOCON, Inc., U.S.A. An object with an oxygen barrier property has no particular lower limit for the oxygen permeation rate (mL/(m²×day×atm)). An object with an oxygen barrier property may have an oxygen permeation rate (mL/(m²×day×atm)) of 0.010 or more.

In the case that the measurement object does not contain rubber and is not a molded container, the oxygen permeation rate is measured in accordance with JAS K 7126-2: 2006 in an environment with a temperature of 23° C. and a relative humidity of 50% using the permeability measuring instrument OXTRAN (2/21) manufactured by MOCON, Inc., U.S.A.

In the case that the measurement object is at least one of a rubber-containing object and a molded container, the oxygen permeation rate is measured in accordance with ASTM D3985. In this case, the oxygen permeation rate is measured in an environment with a temperature of 23° C. and a relative humidity of 50% using the permeability measuring instrument OXTRAN (2/61) manufactured by MOCON, Inc., U.S.A.

The second container 40 with an oxygen barrier property can usually sufficiently suppress water vapor permeation. The second container 40 may have a water vapor barrier property. An object with a water vapor barrier property means that the material constituting the object has a water vapor permeation rate (g/(m²×day)) of 1000 or less. The material constituting an object with a water vapor barrier property, for example, a container, may have a water vapor permeation rate (g/(m²×day)) of 10 or less, 5.0 or less, 1.0 or less, 0.50 or less, or 0.20 or less. The water vapor permeation rate is measured in accordance with JIS K 7129-2: 2019. The water vapor permeation rate is measured in an environment with a temperature of 40° C. and a relative humidity of 90% using a permeability measuring instrument PERMATRAN (3/33) manufactured by MOCON, Inc., U.S.A. An object with a water vapor barrier property has no particular lower limit for the water vapor permeation rate (g/(m²×day)). An object with a water vapor barrier property may have a water vapor permeation rate (g/(m²×day)) of 0.0010 or more.

The second container 40 with an oxygen barrier property is, for example, a can made of a metal, a container with a metal layer formed by vapor deposition or transfer, or a glass bottle. As in the example illustrated in FIGS. 1A and 1B, the second container 40 may be a film container. The film container is a container made of a film. The film constituting the film container may be a laminate including a layer with an oxygen barrier property. The laminate may include a resin layer with an oxygen barrier property, such as an ethylene-vinyl alcohol copolymer (EVOH) or poly(vinyl alcohol) (PVA), or a metallized film. The second container 40 may include a transparent portion. Part of the second container 40 may be transparent. The entire second container 40 may be transparent. Transparency as well as an oxygen barrier property can be imparted to the second container 40 using the laminate and the second container 40 using glass or resin. By imparting transparency to the second container 40, the first container 30L containing a liquid medicine stored therein can be examined from the outside of the second container 40.

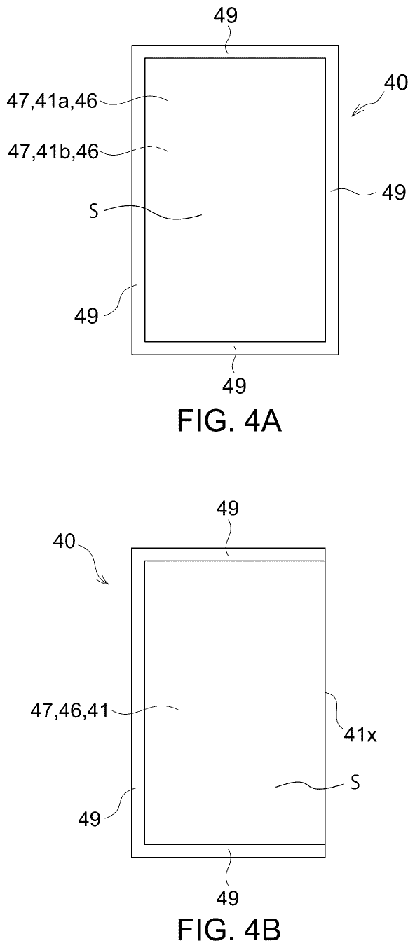

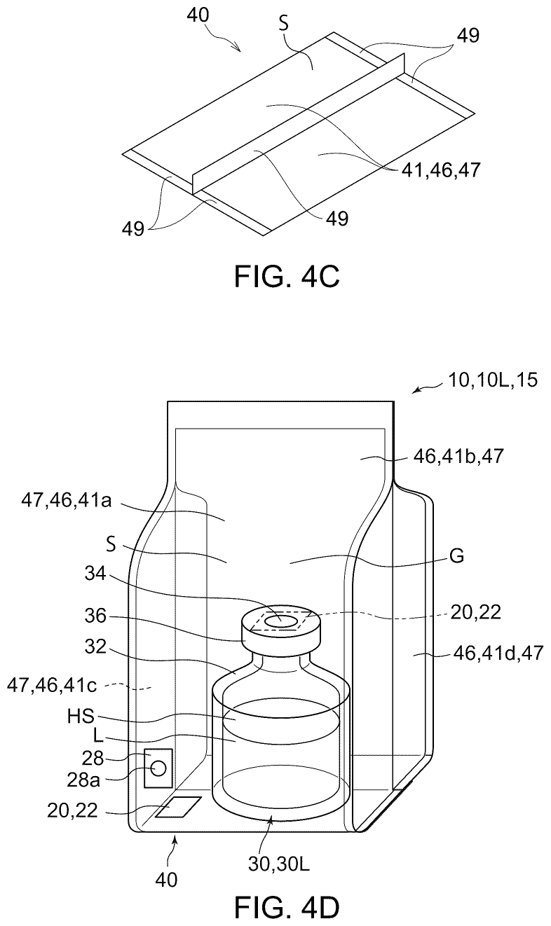

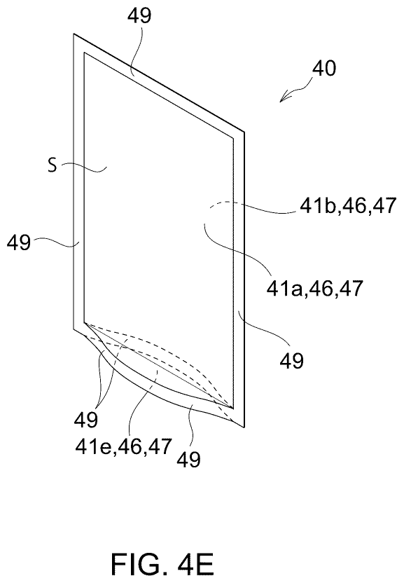

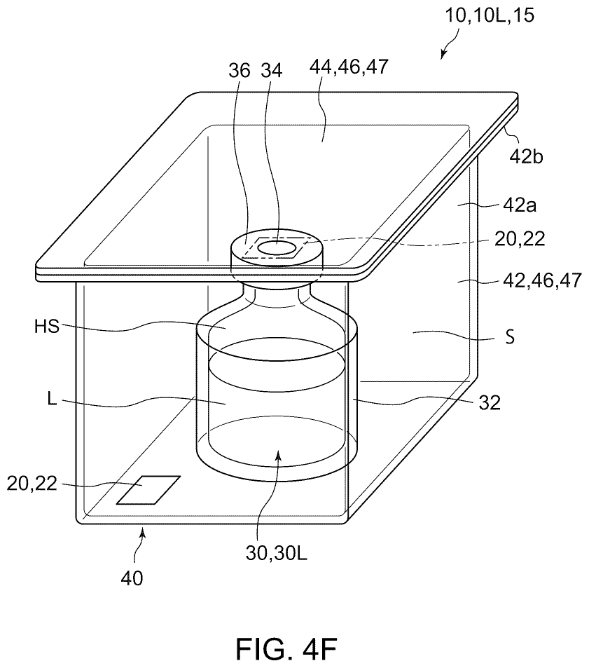

In the examples illustrated in FIGS. 1A and 1B, the second container 40 is a film container. The second container includes a first film (first main film) 41a and a second film (second main film) 41b. The first film 41a and the second film 41b are disposed to face each other. The first film 41a and the second film 41b may be different films. The first film 41a and the second film 41b may be a single film folded back as described later with reference to FIGS. 4B and 4C. The first film 41a and the second film 41b are bonded together at a linear seal portion 49. The bonding at the seal portion 49 may be, for example, welding, such as heat sealing or ultrasonic bonding, or bonding using a tackifier or an adhesive material. A storage space S for storing the first container 30 is formed between the first film 41a and the second film 41b.

The first film 41a and the second film 41b can be peeled off at the seal portion 49. A user applies a force to peel off the first film 41a and the second film 41b and separate the first film 41a and the second film 41b from each other at the seal portion 49. The seal portion 49 can be peeled off by adjusting the processing conditions at the time of bonding, the material or thickness of the bonding material (sealant layer), or the like. The seal portion 49 may be linear.

The term “peelable” means that a user of the combined medical container 10L containing a liquid medicine can manually grasp the second container 40 and peel the first film 41a and the second film 41b from each other without using an apparatus or an assistive apparatus. The heat-seal strength of a seal portion bonded in a peelable manner measured in accordance with JAS Z 0238 may be 3 N/15 mm or more and 15 N/15 mm or less or 3 N/15 mm or more and 6 N/15 mm or less. The heat-seal strength is an arithmetic mean of five measured values.

The seal portion 49 includes a curved first seal portion 49a. The first seal portion 49a may be linear. The first container 30 stored in the second container 40 faces the first seal portion 49a. The first container 30 faces a linear first seal portion 49a in the first direction D1. The first seal portion 49a is bent so as to protrude toward the side away from the first container 30 in the first direction D1. The first seal portion 49a is bent so as to protrude toward the outside of the storage space S of the second container 40. The first seal portion 49a is bent so as to protrude toward the side where the storage space S of the second container 40 is widened.

In the illustrated example, the seal portion 49 includes a first side seal portion 49b connected to one end of the first seal portion 49a, and a second side seal portion 49c connected to the other end of the first seal portion 49a. The storage space S of the second container 40 for storing the first container 30 is formed between the first side seal portion 49b and the second side seal portion 49c. The minimum distance DXa along the first film 41a between the first side seal portion 49b and the second side seal portion 49c may be less than the length L30 of the first container 30 in the direction of the insertion of the stopper 34 into the opening portion 33. The minimum distance DXb along the second film 41b between the first side seal portion 49b and the second side seal portion 49c may also be less than the length L30 of the first container 30 in the direction of the insertion of the stopper 34 into the opening portion 33. In the illustrated example, the direction in which the stopper 34 is inserted into the opening portion 33 is the same as the first direction D1 in which the first container 30 and the first seal portion 49a face each other.

The minimum distance DXa along the first film 41a between the first side seal portion 49b and the second side seal portion 49c is the minimum length of the first film 41a between the first side seal portion 49b and the second side seal portion 49c. The minimum distance DXb along the second film 41b between the first side seal portion 49b and the second side seal portion 49c is the minimum length of the second film 41b between the first side seal portion 49b and the second side seal portion 49c. The length L30 of the first container 30 is the length of the first container 30 in the axial direction and is typically the length of the first container 30 in the longitudinal direction.

The minimum distances DXa and DXb along the films 41a and 41b between the side seal portions 49b and 49c can be set to be shorter than the length L30 of the first container 30 to suppress a large change in the orientation of the first container 30 in the second container 40. This stabilizes the orientation of the first container 30 in the second container 40. As described later, this can stably maintain the state in which the stopper 34 of the first container 30 and the oxygen-absorbing member 20 containing the oxygen absorber 22 face each other and promote the discharge of oxygen from the first container 30.

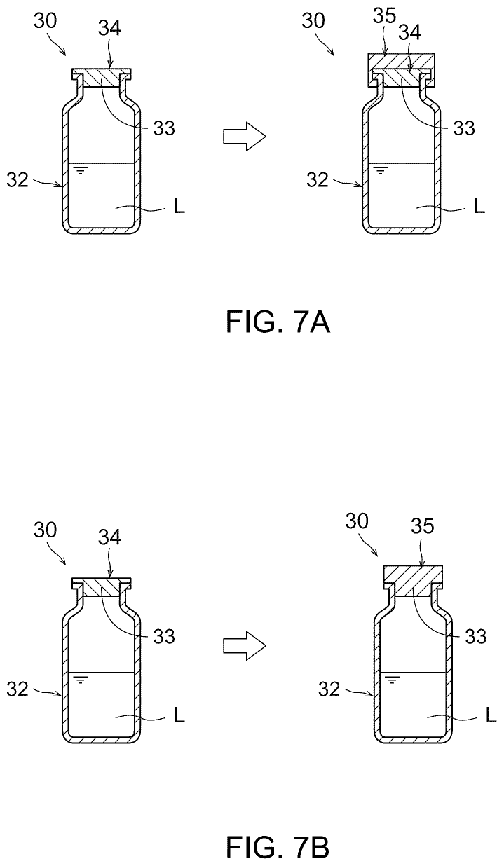

The seal portion 49 further includes a second seal portion 49d facing the first seal portion 49a in the first direction D1. In the illustrated example, the seal portion 49 includes the first seal portion 49a and the second seal portion 49d facing each other in the first direction D1 and the first side seal portion 49b and the second side seal portion 49c facing each other in the second direction D2. The first seal portion 49a, the second seal portion 49d, the first side seal portion 49b, and the second side seal portion 49c form the seal portion 49 along the periphery. The peripheral seal portion 49 defines the storage space S of the second container 40. In place of the second seal portion 49d, a folded-back portion 41x formed by folding back a film illustrated in FIG. 7C described later may be provided.

As illustrated in FIGS. 1A and 1B, each of the first film 41a and the second film 41b includes a main portion 50a forming the storage space S and an extension portion 50b connected to the main portion 50a. The main portion 50a includes the first seal portion 49a, the second seal portion 49d, the first side seal portion 49b, the second side seal portion 49c, and a portion surrounded by these seal portions 49a, 49d, 49b, and 49c. The extension portion 50b is connected to the main portion 50a at the first seal portion 49a. The extension portion 50b may be connected to at least the bent top portion (bent apex portion) of the first seal portion 49a. The extension portion 50b may be connected to at least a portion of the first seal portion 49a most protruding from the first container 30 in the first direction D1 in which the first container 30 and the first seal portion 49a face each other. In the extension portion 50b, the space between the first film 41a and the second film 41b is open to the outside. In the extension portion 50b, the space between the first film 41a and the second film 41b is not sealed by the seal portion.

The user can easily apply a peeling force to the first film 41a and the second film 41b by gripping the extension portion 50b. At this time, the peeling force is concentrated on the bent top portion of the first seal portion 49a. In the illustrated example, the peeling force is concentrated on the bent portion of the bent first seal portion 49a. Thus, it is possible to easily and smoothly peel off the first film 41a and the second film 41b with the bent first seal portion 49a as a starting point. In the second container 40, the first seal portion 49a serves as a to-be-opened portion. The to-be-opened portion is a portion intended to be opened when the second container 40 is opened.

In the illustrated example, the second direction D2 is orthogonal to the first direction D1. The third direction D3 is orthogonal to both the first direction D1 and the second direction D2. The first film 41a and the second film 41b face each other in the third direction side D3. The first film 41a and the second film 41b have a quadrangular shape in a state of being flatly unfolded. The first film 41a and the second film 41b include a pair of edge portions extending in the first direction D1. The first film 41a and the second film 41b include a pair of edge portions extending in the second direction D2. An edge portion extending in the first direction D1 is a long side of the rectangular shape. An edge portion extending in the second direction D2 is a short side of the rectangular shape.

To clarify directional relationships between the drawings, some of the drawings illustrate common directions using arrows with common reference numerals and letters. The tip side of each arrow corresponds to the first side in each direction. The side opposite the tip of each arrow corresponds to the second side in each direction. An arrow directed toward the back of the drawing in a direction perpendicular to the drawing is indicated by a symbol with a “x” mark in a circle, for example, as illustrated in FIG. 1A. An arrow directed from the drawing toward the front in a direction perpendicular to the drawing is indicated by a symbol with a dot in a circle, for example, as illustrated in FIG. 1B.

The second container 40 is not limited to the example illustrated in FIGS. 1A and 1B. As illustrated in FIG. 4A, the seal portion 49 may be bonded at the periphery of the films 41a and 41b.

Instead of bonding separate films, the films 41a and 41b may be formed by a single folded film. The two films 41a and 41b may be formed of a single seamless film.

The second container 40 illustrated in FIG. 4B includes a film 41 folded at the folded-back portion 41x. The second container 40 can be produced by bonding the facing portions of the folded film 41 at the seal portion 49. In the second container 40 illustrated in FIG. 4B, the storage space S is formed in a portion surrounded by the folded-back portion 41x and a three-sided seal portion 49. In the example illustrated in FIG. 4B, the first film 41a and the second film 41b forming the storage space S between the first film 41a and the second film 41b are formed by one film. There is no seam between the first film 41a and the second film 41b.

The second container 40 illustrated in FIG. 4C is also referred to as a pillow type. The second container 40 is produced by bonding both ends of the single film 41 together as the seal portion 49 to form the film into a tubular shape and further bonding both tubular end portions as the seal portion 49. In the example illustrated in FIG. 4C, the first film 41a and the second film 41b forming the storage space S between the first film 41a and the second film 41b are formed by one film. There is no seam between the first film 41a and the second film 41b.

As illustrated in FIG. 4D, the second container 40 may be a gusset bag. In the example illustrated in FIG. 4D, the second container 40 includes a first film (first main film) 41a, a second film (second main film) 41b, a first gusset film 41c, and a second gusset film 41d. The gusset bag can form a rectangular bottom surface. This stabilizes the posture of the first container 30 in the second container 40.

As illustrated in FIG. 4E, the second container 40 may be a standing pouch. The second container 40 illustrated in FIG. 4D includes the first film 41a, the second film 41b, and a bottom film 41e. The standing pouch has a bottom surface formed by the bottom film 41e. This stabilizes the posture of the first container 30 in the second container 40.

The film constituting the second container 40 may be transparent. The first container 30 in the storage space S can be observed through the transparent second container 40.

The second container 40 may not be a film container made of a film. As illustrated in FIGS. 3A to 3C and FIG. 4F, the second container 40 may include a container body 42 and a lid 44. The container body 42 includes a storage portion 42a and a flange portion 42b. The storage portion 42a may form a rectangular parallelepiped storage space S. The first container 30 is stored in the storage space S. The storage portion 42a may have a rectangular parallelepiped external shape in which one surface is open. The flange portion 42b is provided on the periphery of the opening of the storage portion 42a. The lid 44 is flat. The periphery of the lid 44 can be hermetically bonded to the flange portion 42b of the container body 42. The container body 42 and the lid 44 may be formed of a resin sheet with an oxygen barrier property. The lid 44 and the container body 42 may be transparent. The resin sheet with an oxygen barrier property may have a thickness of 0.05 mm or more and 2 mm or less or 0.1 mm or more and 1.5 mm or less.

The second container 40 illustrated in FIG. 4F can maintain a negative internal pressure at atmospheric pressure. The second container 40 can contain a gas at a negative pressure while being subjected to atmospheric pressure. The second container 40 may contain a gas at a positive pressure while being subjected to atmospheric pressure. In these examples, the second container 40 may have sufficient rigidity to maintain its shape. However, the second container 40 may be deformed to some extent at atmospheric pressure when the internal pressure is maintained at a negative pressure or a positive pressure. The second container 40 that can maintain the internal pressure at a negative pressure or a positive pressure is, for example, a can made of metal.

The oxygen-permeable portion of the first container 30 may be at least partially separated from the second container 40 with an oxygen barrier property. In this example, the movement of oxygen from the inside of the first container 30 to the inside of the second container 40 can be promoted. In the illustrated example, a gap G (see FIG. 4D) is formed between the stopper 34 of the first container 30 stored in the second container 40 and the second container 40.

The oxygen absorber 22 absorbs oxygen in the second container 40. When the oxygen absorber 22 absorbs oxygen, the concentration of oxygen in the second container 40 decreases, and the oxygen in the first container 30 moves to the second container 40. The amount of the oxygen absorber 22 is set to an amount capable of absorbing the total amount of oxygen present in the first container 30 and the second container 40. The oxygen absorber 22 may be any composition that can absorb oxygen. The oxygen absorber 22 may be an iron-based oxygen absorber or a nonferrous oxygen absorber. The oxygen absorber 22 may be a deoxidizer composition containing a metal powder, such as an iron powder, a reducing inorganic substance, such as an iron compound, a polyhydric phenol, a polyhydric alcohol, a reducing organic substance, such as ascorbic acid or a salt thereof, a metal complex, or the like as a main agent of an oxygen absorption reaction.

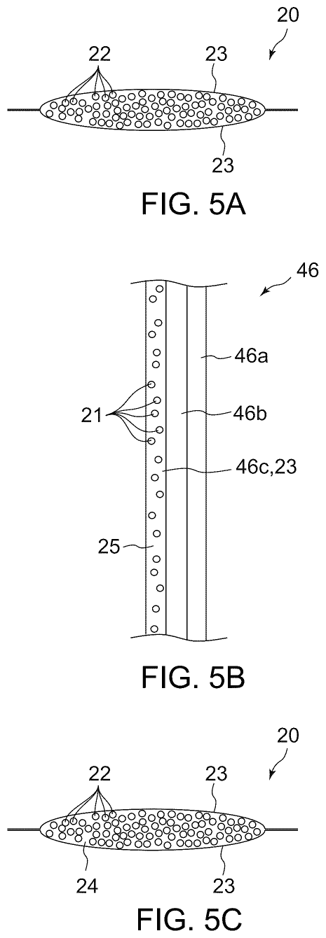

As illustrated in FIGS. 1A and 1B, the combined medical container 10L containing a liquid medicine may include the oxygen-absorbing member 20 stored in the second container 40 together with the first container 30L containing a liquid medicine. As illustrated in FIG. 5A, the oxygen-absorbing member 20 may include a package 23 with oxygen permeability and the oxygen absorber 22 contained in the package 23. The oxygen-absorbing member 20 containing the oxygen absorber 22 may be an iron-based water-dependent FX type, an iron-based self-reacting S type, an SPE type, a ZP type, a ZI-PT type, a ZJ-PK type, or an E type among deoxidizers available from Mitsubishi Gas Chemical Co., Inc. The oxygen-absorbing member 20 containing the oxygen absorber 22 may be an organic self-reacting GLS type, GL-M type, GE type, or the like among deoxidizers available from Mitsubishi Gas Chemical Co., Inc. The oxygen-absorbing member 20 containing the oxygen absorber 22 may be a ZH type, a Z-PK type, a Z-PR type, a Z-PKR type, a ZM type, or the like for pharmaceutical agents among deoxidizers available from Mitsubishi Gas Chemical Co., Inc.

To promote oxygen absorption by the oxygen absorber 22, as illustrated FIG. 5C, the oxygen-absorbing member 20 may contain a humectant 24 that retains water. The humectant 24 is, for example, one or more selected from the group consisting of diatomaceous earth, silica, and activated carbon. The humectant 24 may be used as a carrier for carrying the oxygen absorber 22. In an example in which the liquid medicine L contains a non-aqueous solvent, such as an alcohol or oil, the humectant 24 retaining water is effective in ensuring the oxygen absorption function of the oxygen absorber 22.

The oxygen absorber 22 may be contained in the oxygen-absorbing film 21. FIG. 5B illustrates an example of a laminate 46 including the oxygen-absorbing film 21. The laminate 46 including the oxygen-absorbing film 21 may constitute the films 41a to 41e of the second container 40 illustrated in FIGS. 1A, 1B, and 4A to 4E. The laminate 46 including the oxygen-absorbing film 21 may constitute the container body 42 and the lid 44 of the second container 40 illustrated in FIG. 4F. The laminate 46 illustrated in FIG. 5B includes a first layer 46a, a second layer 46b, and a third layer 46c. The first layer 46a may be an outermost layer made of poly(ethylene terephthalate), a polyamide, or the like. The second layer 46b may be an oxygen barrier layer formed of an aluminum foil, a metal-oxide-deposited film, a metallized film, or the like. The third layer 46c may be an innermost layer of a heat seal layer. The illustrated third layer 46c includes a base material 25 composed of a thermoplastic resin and an oxygen absorber 22 dispersed in the base material 25. The oxygen absorber 22 may be contained not only in the heat seal layer or the innermost layer 46c but also in an intermediate layer of a laminate, such as an adhesive layer.

As another example, the first container 30 may include the oxygen-absorbing film 21 containing the oxygen absorber 22.

A medical container set 15 and a combined medical container 10 may include an oxygen detection member 28 that detects the oxygen state of the second container 40. The oxygen detection member 28 may display information on the detected oxygen state. The oxygen detection member 28 may include a display portion 28a that displays information on the oxygen state. The oxygen detection member 28 may detect the oxygen concentration. The oxygen detection member 28 may display the detected oxygen concentration. The oxygen detection member 28 may display the detected oxygen concentration by color. The oxygen detection member 28 may display the oxygen concentration range to which the detected oxygen concentration belongs by color.

The oxygen detection member 28 may contain a variable organic dye whose color is reversibly changed by oxidation-reduction. For example, the oxygen reducing agent includes an organic dye, such as a thiazine dye, an azine dye, or an oxazine dye, and a reducing agent, and may be in a solid form. The oxygen reducing agent may contain an oxygen indicator ink composition. The oxygen indicator ink composition may contain a resin solution, a thiazine dye or the like, a reducing saccharide, and an alkaline substance. The thiazine dye or the like, the reducing saccharide, and the alkaline substance may be dissolved or dispersed in the resin solution. A substance contained in the oxygen detection member 28 may be reversibly changed by oxidation and reduction. By using the oxygen detection member 28 containing a reversible substance, the oxygen detection member 28 stored in the container changes the display color with the deoxygenation in the container before the deoxygenation is completed. The display of the oxygen detection member 28 can be observed to understand the state related to oxygen in the container. Furthermore, the oxygen detection member 28 stored in the container can notify an increase in the oxygen concentration after the completion of deoxygenation, for example, a state in which a pinhole or the like is formed in the container during a distribution process or the like and oxygen flows into the container, by changing the display color.

The oxygen detection member 28 may be a commercially available tablet-type oxygen detection member. The oxygen detection member 28 may be an oxygen detection member available from Mitsubishi Gas Chemical Co., Inc. under the trade name “Ageless Eye”. The oxygen detection member 28 may be an oxygen detector coated with an ink composition with an oxygen detection function and may be, for example, an oxygen detection member available from Mitsubishi Gas Chemical Co., Inc. under the trade name of “Paper Eye”. “Ageless Eye” and “Paper Eye” are functional products that can easily indicate, by a color change, an anaerobic condition in which the concentration of oxygen in a transparent container is less than 0.1% by volume. As the oxygen detection member 28, together with a deoxidizer, for example, a deoxidizer available from Mitsubishi Gas Chemical Co., Inc. under the trade name of “Ageless”, a material that can be used for maintaining the freshness of food, maintaining the quality of a pharmaceutical agent, and the like may be used.

As illustrated in FIG. 1A, the oxygen detection member 28 may be disposed so that the display portion 28a can be observed from the outside of the transparent second container 40. In the example illustrated in FIG. 1A, the oxygen detection member 28 is stored in the second container 40, similarly to the oxygen absorber 22 and the oxygen-absorbing member 20. The oxygen detection member 28 may be welded to the inner surface of the second container 40 or the outer surface of the first container 30 or may be bonded thereto via a bonding material. The oxygen detection member 28 may be disposed so that the display portion 28a thereof is not made unobservable by the oxygen-absorbing member 20 or the humectant 24. Furthermore, when a label is attached to the first container 30, the oxygen-absorbing member 20 and the oxygen detection member 28 may be disposed so as not to cover the label.

Furthermore, the oxygen detection member 28 may detect an oxygen state of the first container 30. More specifically, the medical container set 15 and the combined medical container 10 may include an oxygen detection member 28 that detects the oxygen state of the first container 30. The oxygen detection member 28 may be stored in the first container 30. The oxygen detection member 28 may display information on the detected oxygen state of the first container 30. The oxygen detection member 28 may include a display portion 28a that displays information on the oxygen state of the first container 30. The oxygen detection member 28 may detect the concentration of oxygen in the first container 30. The oxygen detection member 28 may display the detected concentration of oxygen in the first container 30. The oxygen detection member 28 may display the detected concentration of oxygen in the first container 30 by color. The oxygen detection member 28 may display, by color, the oxygen concentration range to which the detected concentration of oxygen in the first container 30 belongs.

A method for producing the combined medical container 10L containing a liquid medicine is described below. The combined medical container 10L containing a liquid medicine can be produced to produce the first container 30L containing a liquid medicine in which the oxygen concentration is adjusted.

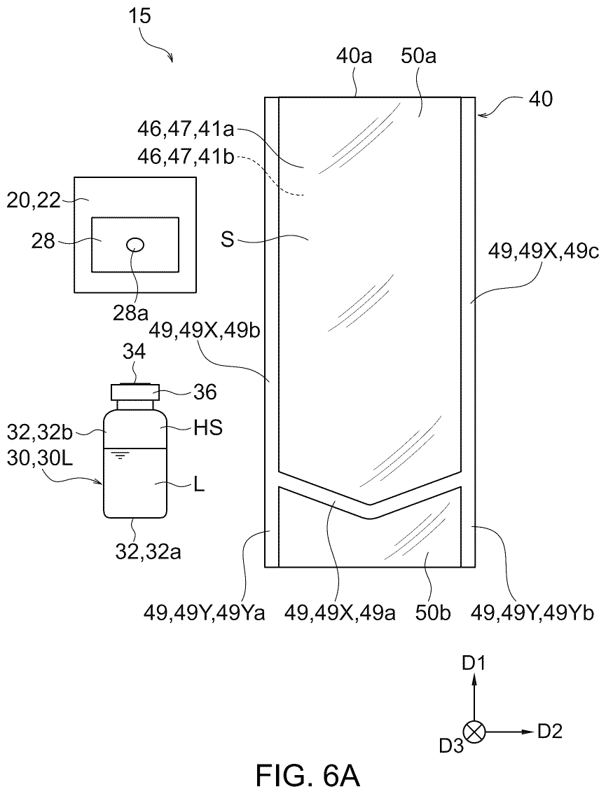

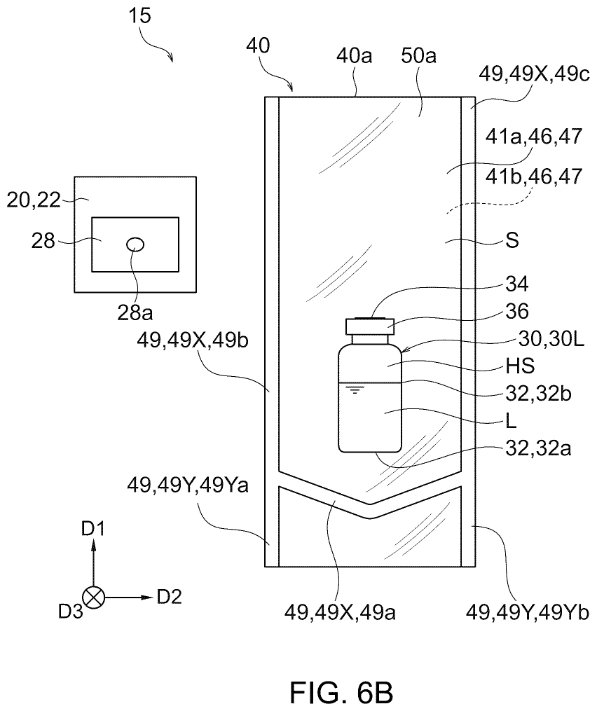

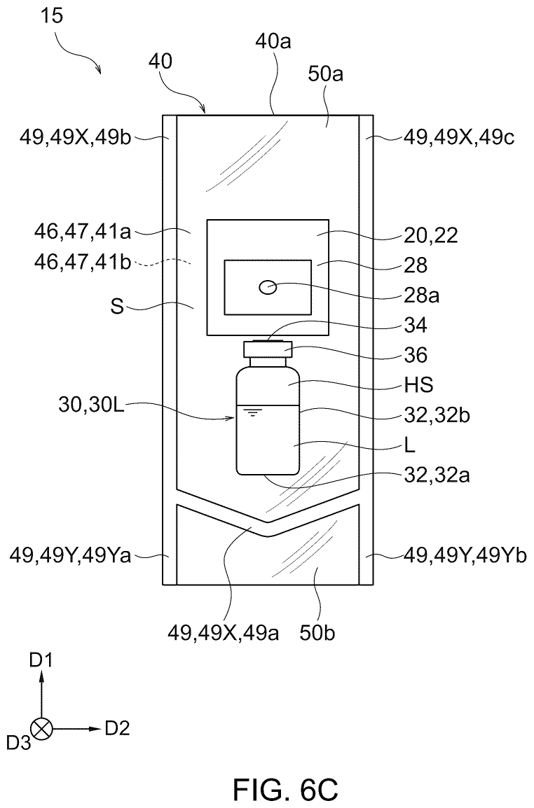

Next, with reference to FIGS. 6A to 6C, a method for producing the combined medical container 10L containing a liquid medicine illustrated in FIGS. 1A to 1C is described.

First, as illustrated in FIG. 6A, the first container 30L containing a liquid medicine, the oxygen-absorbing member 20, the oxygen detection member 28, and the second container 40 are prepared. The second container 40 is not yet closed. In the example illustrated in FIG. 6A, the first film 41a and the second film 41b are bonded at the first seal portion 49a, the first side seal portion 49b, and the second side seal portion 49c. This three-sided sealing substantially forms the space S for storing the first container 30, the oxygen-absorbing member 20, and the oxygen detection member 28. On the other hand, the first film 41a and the second film 41b are not bonded to each other at the second seal portion 49d. Thus, the second container 40 has an opening portion 40a communicating with the storage space S. In the second container 40 illustrated in FIGS. 6A to 6C, the lid 44 may not be bonded to the container body 42, and the opening portion 40a may be formed.

The first container 30L containing a liquid medicine is produced by filling the first container 30 with the liquid medicine L. For example, the liquid medicine L is produced using a production line installed in a sterile environment maintained at a positive pressure. The sterile environment is maintained at a positive pressure from the perspective of suppressing the entry of foreign materials, such as bacteria. As a result, the internal pressure of the first container 30L containing a liquid medicine becomes a positive pressure as in the production environment.

As illustrated in FIG. 6B, the first container 30 is stored in the storage space S of the second container 40. In the illustrated example, the first container 30 is stored in the storage space S of the second container 40 such that the container body 32 of the first container 30 faces the first seal portion 49a. The bottom portion 32a of the container body 32 faces the first seal portion 49a in the first direction D1.

Next, as illustrated in FIG. 6C, the oxygen-absorbing member 20 and the oxygen detection member 28 are stored in the storage space S of the second container 40. The oxygen-absorbing member 20 has a sheet shape. The oxygen-absorbing member 20 is stored in the storage space S of the second container 40 such that one side edge of the sheet-like oxygen-absorbing member 20 faces the stopper 34 of the first container 30. The oxygen detection member 28 has a sheet shape. The sheet-like oxygen detection member 28 overlaps the oxygen-absorbing member 20 in the third direction D3. The amount of the oxygen absorber 22 is set to an amount capable of absorbing the total amount of oxygen present in the first container 30 and the second container 40.

The first film 41a and the second film 41b are then bonded at the second seal portion 49d to close the second container 40. The bonding of the first film 41a and the second film 41b may be performed using a bonding material, such as a tackifier or an adhesive material, or may be welding by heat sealing, ultrasonic bonding, or the like. The second container 40 is in an air-tight state. As a result, the combined medical container 10L containing a liquid medicine is produced. Before closing the second container 40, the storage space S of the second container 40 may be replaced with an inert gas. The second container 40 may be closed in an inert gas atmosphere. Unlike the first seal portion 49a, the second seal portion 49d may be formed in a linear shape. Unlike the first seal portion 49a, the second seal portion 49d may be bonded so as not to be peeled off. Thus, even in a state in which the first container 30, the oxygen-absorbing member 20, and the oxygen detection member 28 are stored, the first film 41a and the second film 41b can be easily and stably bonded at the second seal portion 49d.

The steps up to closing the second container 40 may be performed in a sterile environment. That is, the first container 30L containing a liquid medicine produced in a sterile state and the second container 40 and the oxygen-absorbing member 20 sterilized or produced in a sterile state are brought into a sterile condition, such as a sterile chamber. In a sterile environment, the second container 40 storing the first container 30L containing a liquid medicine is closed. The inside of the second container 40 storing the first container 30L containing a liquid medicine is also brought into a sterile state. That is, the first container 30L containing a liquid medicine can be stored in the second container 40 in a sterile state.

As described above, the combined medical container 10L containing a liquid medicine illustrated in FIGS. 1A and 1B is produced. In the combined medical container 10L containing a liquid medicine, the first container 30L containing a liquid medicine is stored in the second container 40. The oxygen absorber 22 of the oxygen-absorbing member 20 absorbs oxygen in the second container 40. The second container 40 has an oxygen barrier property. This decreases the concentration of oxygen (%) in the second container 40. As the concentration of oxygen in the second container 40 decreases, oxygen permeates the stopper 34 with oxygen permeability and moves from the first container 30 to the second container 40. This decreases the concentration of oxygen (%) in the headspace HS of the first container 30 and decreases the amount of dissolved oxygen (mg/L) in the liquid medicine L contained in the first container 30. A material constituting the stopper 34 has a first oxygen permeability of 0.00010 (cc×mm/(mm²×day)) or more. A material constituting the stopper 34 may have a first oxygen permeability of 0.00050 (cc×mm/(mm²×day)) or more, 0.00075 (cc×mm/(mm²×day)) or more, 0.0010 (cc×mm/(mm²×day)) or more, or 0.0020 (cc×mm/(mm²×day)) or more. This promotes the oxygen permeation through the first container 30 and accelerates the movement of oxygen from the first container 30 to the second container 40. This can effectively suppress the oxygen degradation of the liquid medicine L.

The concentration of oxygen (%) in the headspace HS of the first container 30 is also simply referred to as the concentration of oxygen (%) in the first container 30.

Also in the combined medical container 10L containing a liquid medicine illustrated in FIGS. 3A to 3D, oxygen permeation through the stopper 34 and the gasket 68 of the syringe 60 constituting the first container 30 can be promoted to suppress the oxygen degradation of the liquid medicine L. The water vapor permeation through the stopper 34 or the gasket 68 of the syringe 60 can be reduced to suppress the quality deterioration of the liquid medicine L.

A sufficient amount of the oxygen absorber 22 can be used to keep the concentration of oxygen in the second container 40 and the concentration of oxygen in the first container 30 sufficiently low, for example, less than 0.3%, 0.1% or less, 0.05% or less, less than 0.03%, or even 0%. A sufficient amount of the oxygen absorber 22 can be used to significantly reduce the amount of dissolved oxygen in the liquid medicine L, for example, less than 0.15 mg/L, 0.04 mg/L or less, 0.03 mg/L or less, 0.02 mg/L or less, or less than 0.015 mg/L, more preferably 0 mg/L.

In the example illustrated in FIGS. 1A and 1B, the stopper 34 faces the oxygen-absorbing member 20. This can effectively suppress unintentional blockage of the movement path of oxygen passing through the stopper 34 from the first container 30 to the oxygen-absorbing member 20, for example, the adhesion of a pair of the films 41a and 41b, or the like. This can stably and quickly reduce the amount of oxygen in the first container 30.

On the other hand, water vapor can also permeate the stopper 34 with oxygen permeability. However, a material constituting the stopper 34 may have a first water vapor permeability of 1.0 (mg×mm/(mm²×day)) or less at a temperature of 40° C. and a relative humidity of 90%. The material constituting the stopper 34 may have a first water vapor permeability of 0.80 (mg×mm/(mm²×day)) or less, 0.50 (mg×mm/(mm²×day)) or less, 0.25 (mg×mm/(mm²×day)) or less, or 0.15 (mg×mm/(mm²×day)) or less. The water vapor permeation through the first container 30 can be suppressed in this manner to suppress the quality deterioration of the liquid medicine L. For example, when the liquid medicine L contains a non-aqueous liquid medium, it is possible to suppress the movement of a large amount of water vapor from the second container 40 to the first container 30 through the stopper 34. This can suppress the hydrolysis of a pharmaceutical ingredient of the liquid medicine L. When the liquid medicine L contains an aqueous liquid medium, the evaporation of the aqueous liquid medium and the water vapor permeation through the first container 30 are suppressed. This can suppress the change in the concentration of a pharmaceutical ingredient in the liquid medicine L and the change in the hydrogen ion concentration of the liquid medicine L.

In contrast, in the related art, the amount of oxygen in a container containing a liquid medicine cannot be sufficiently reduced. For this reason, a liquid medicine is sometimes lyophilized and stored in the form of a powder. Powdering can suppress oxygen degradation. However, it is a great disadvantage in terms of labor, time, and cost to make a chemical used as a liquid medicine into a powder form and to return the powdered chemical to the liquid medicine L at the time of use. The first container 30L containing a liquid medicine used for the combined medical container 10L containing a liquid medicine can be produced in a conventional manner using existing equipment or the like. It is possible to suppress the quality deterioration of the liquid medicine L in the first container 30 while eliminating the need for equipment modification and capital investment. Furthermore, it is possible to save time and effort for lyophilizing the liquid medicine L or returning powder to liquid.

In addition to sufficiently reducing the concentration of oxygen in the first container 30, rapidly reducing the concentration of oxygen in the first container 30 can also suppress the decomposition of the liquid medicine L due to oxygen. Thus, oxygen in a space not occupied by the liquid medicine L in the first container 30, that is, oxygen in a so-called headspace HS, may be replaced with an inert gas before the first container 30 is closed. An inert gas may be bubbled in the liquid medicine L to remove dissolved oxygen from the liquid. The inert gas replacement or bubbling can reduce the concentration of oxygen in the first container 30 in the equilibrium state to approximately 1.0%, for example, approximately 0.50% or more and 1.0% or less. This can rapidly reduce the amount of oxygen in the first container 30. The inert gas is a stable gas with low reactivity. The inert gas is, for example, a noble gas, such as nitrogen, helium, neon, or argon.

The adjustment of the amount of oxygen in the first container 30 in the second container 40 may be performed until the oxygen permeation through the first container 30 is balanced. The adjustment of the amount of oxygen in the first container 30 in the second container 40 may be performed until the concentration of oxygen in the second container 40 decreases to a predetermined value. The adjustment of the amount of oxygen in the first container 30 in the second container 40 may be performed until the concentration of oxygen in the first container 30 decreases to a predetermined value. The adjustment of the amount of oxygen in the first container 30 in the second container 40 may be performed until the amount of dissolved oxygen in the liquid medicine L in the first container 30 decreases to a predetermined value. The adjustment of the amount of oxygen in the first container 30 in the second container 40 may be performed until the liquid medicine L in the combined medical container 10L containing a liquid medicine is used. Furthermore, while the first container 30 is stored in the second container 40 and the amount of oxygen is adjusted, the combined medical container 10L containing a liquid medicine may be circulated.

Furthermore, as already described, the use of a combined container including a first container, a second container, and an oxygen absorber for the liquid medicine L has not been sufficiently studied. On the other hand, the present inventors have studied the application of a combined container to the liquid medicine L and have found that there is a problem specific to the liquid medicine, which is not a problem in food or the like. In particular, when an attempt is made to impart high oxygen permeability to a first container for containing a liquid medicine that is susceptible to oxygen degradation, to promote oxygen permeation, and to more effectively suppress oxygen degradation of the liquid medicine, quality deterioration of the liquid medicine due to water vapor permeation becomes more significant. Thus, to apply a combined container to a liquid medicine and handle the liquid medicine as a combined medical container containing the liquid medicine, it is necessary to address two problems, that is, suppression of degradation due to oxygen and suppression of degradation due to water vapor, which are contradictory to each other in terms of solution means. That is, in a combined medical container applied to a liquid medicine, it is necessary to impart, to a first container for containing the liquid medicine, characteristics that are usually contradictory to each other, such as a characteristic of promoting oxygen permeation and a characteristic of suppressing water vapor permeation. As a result of intensive studies for the purpose of solving such a problem, it has been found that permeation characteristics capable of sufficiently promoting the permeation of oxygen and sufficiently suppressing the permeation of water vapor can be imparted to a stopper included in a first container, and the quality deterioration of a liquid medicine can be suppressed by using the stopper to which such permeability is imparted. That is, the first container 30 with the first oxygen permeability in the predetermined range and the first water vapor permeability in the predetermined range can suppress the degradation of the liquid medicine L due to water vapor, which does not exist in the related art, while suppressing the degradation of the liquid medicine L due to oxygen. In this regard, the operation and effect of the present embodiment are remarkable and far beyond the range predicted from the technical level at the time of filing of the present application.

As illustrated in FIG. 7A, the method for producing the combined medical container 10L containing a liquid medicine may include a step of attaching a second stopper 35 to the stopper 34 or the container body 32 to cover the stopper 34 with the second stopper 35. This step may be performed after the adjustment of the amount of oxygen in the first container 30 in the second container 40 is completed. This step may be performed after the oxygen concentration has sufficiently decreased or after a certain period of time has elapsed. This step can close the opening portion 33 by using both the stopper 34 and the second stopper 35. The second stopper 35 can be attached to suppress the oxygen permeation through the first container 30. That is, the second stopper 35 can be used to stably maintain a state where the amount of oxygen in the first container 30 is reduced. Furthermore, the second stopper 35 can be attached to suppress the water vapor permeation through the first container 30. Thus, the second stopper 35 can be used to sufficiently suppress the quality deterioration of the liquid medicine L due to water vapor.

A material constituting the second stopper 35 may have the first oxygen permeability in the above predetermined range and the first water vapor permeability in the above predetermined range. The material constituting the second stopper 35 may have a lower first oxygen permeability and a lower first water vapor permeability than a material constituting the stopper 34. The second stopper 35 may have a lower second oxygen permeability and a lower second water vapor permeability than the stopper 34. The second stopper 35 may have an oxygen barrier property. The second stopper 35 may have a water vapor barrier property.

As illustrated in FIG. 7B, a method for producing the combined medical container 10L containing a liquid medicine may include a step of closing the opening portion 33 with the second stopper 35 instead of the stopper 34. In this step, the stopper 34 is removed from the container body 32, and the opening portion 33 of the container body is closed by the second stopper 35. This step may be performed after the adjustment of the amount of oxygen in the first container 30 in the second container 40 is completed. This step may be performed after the oxygen concentration has sufficiently decreased or after a certain period of time has elapsed. The second stopper 35 with the first oxygen permeability lower than the first oxygen permeability of the stopper 34 can be used to suppress the oxygen permeation through the first container 30. The second stopper 35 with the second oxygen permeability lower than the second oxygen permeability of the stopper 34 can be used to suppress the oxygen permeation through the first container 30. Thus, the second stopper 35 can be used to stably maintain a state where the amount of oxygen in the first container 30 is reduced. The second stopper 35 with the first water vapor permeability lower than the first water vapor permeability of the stopper 34 can be used to suppress the water vapor permeation through the first container 30. The second stopper 35 with the second water vapor permeability lower than the second water vapor permeability of the stopper 34 can be used to suppress the water vapor permeation through the first container 30. Thus, the second stopper 35 can be used to sufficiently suppress the quality deterioration of the liquid medicine L due to water vapor.

Such a second stopper 35 may be attached to the stopper 34 or the container body 32 by screw fastening, fitting, or the like. Such a second stopper 35 may be attached to the stopper 34 or the container body 32 using a bonding material, such as an adhesive agent or a sticky agent. These additional steps may be performed by opening the second container 40 in an inert gas atmosphere. These additional steps may be performed without opening the second container 40, for example, by operating the second stopper 35 through a film constituting the second container 40.

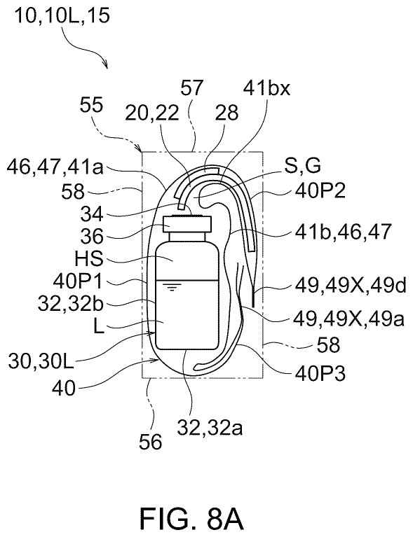

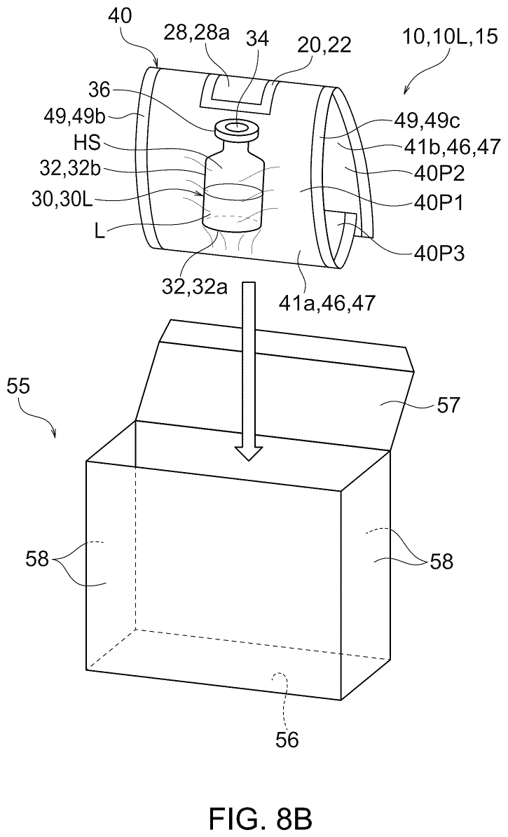

As illustrated in FIG. 8A, at the time of storage, shipment, and distribution of the combined medical container 10L containing a liquid medicine, the combined medical container 10L containing a liquid medicine may be further folded. In the example illustrated in FIG. 8A, the second container 40 is bent with the second film 41b inside. In FIG. 1A, a first bending axial line BA1 along which the second container 40 is bent is shown. The second container 40 is bent such that a second portion 40P2 of the second container 40 located on one side (first side) in the first direction D1 from a first portion 40P1 in a state where the second container 40 is unfolded faces the first portion 40P1 of the second container 40 storing the first container 30 in the third direction D3. That is, the first portion 40P1 and the second portion 40P2 overlap in the third direction D3. The first portion 40P1 and the second portion 40P2 may be in contact with each other or may be separated from each other. The first portion 40P1 and the second portion 40P2 may be bonded together.

The oxygen-absorbing member 20 containing the oxygen absorber 22 has a sheet shape. The sheet-like oxygen-absorbing member 20 is bent together with the second container 40. An intermediate portion of the bent oxygen-absorbing member 20 is located on the bent top portion (folded-back top portion) 41bx of the second film 41b. As illustrated in FIG. 8A, the bent top portion 41bx is a position of the bent second film 41b that protrudes most to the first side in the first direction D1. The bent top portion 41bx is the position farthest from the first container in the direction of inserting the stopper 34 into the container body 32.

As in the example illustrated in FIG. 8A, bending the sheet-like oxygen-absorbing member 20 together with the second film 41b makes it easy to secure an oxygen movement path connecting the first container 30 and the oxygen-absorbing member 20. More specifically, a gap is easily formed between the oxygen-absorbing member 20, the stopper 34 of the first container 30, and the second film 41b. Since oxygen can stably move from the stopper 34 to the oxygen-absorbing member 20 through this gap, the concentration of oxygen in the first container 30 and the amount of dissolved oxygen in the liquid medicine L contained in the first container 30 can be stably reduced.

In the example illustrated in FIG. 8A, an oxygen detection member 28 is positioned between the oxygen-absorbing member 20 and the first film 41a. The display portion 28a of the oxygen detection member 28 disposed in this manner is easily observed through a transparent first film 41a. Thus, the display portion 28a of the oxygen detection member 28 can be observed to stably obtain information on the concentration of oxygen in the second container 40.

In the example illustrated in FIG. 8A, the second container 40 is bent twice with the second film 41b inside. In the FIG. 1A, in addition to the first bending axial line BA1, a second bending axial line BA2 for bending the second container 40 is shown. Due to the bending along the second bending axial line BA2, the first portion 40P1 of the second container 40 storing the first container 30 faces, in the third direction D3, a third portion 40P3 located on the other side (second side) in the first direction D1 from the first portion 40P1 in the state where the second container is unfolded. That is, the first portion 40P1 and the third portion 40P3 overlap in the third direction D3. The first portion 40P1 and the third portion 40P3 may be in contact with each other or may be separated from each other. The first portion 40P1 and the third portion 40P3 may be bonded together. The second container 40 is folded along the second bending axial line BA2 with the second film 41b located inside. The second container 40 can be bent twice to miniaturize the combined medical container 10L containing a liquid medicine.

Due to the double bending, the second portion 40P2 and the third portion 40P3 are located on the same side with respect to the first portion 40P1. The first film 41a in the first portion 40P1 is not covered with the second portion 40P2 or the third portion 40P3. Thus, the first container 30 can be clearly observed through the first film 41a of the second container 40. Thus, the state of the first container 30 and the state of the liquid medicine L contained in the first container 30 can be easily observed. Furthermore, a label attached to the first container 30 is also easily observed. Information relating to the liquid medicine L may be written on the label.

In the illustrated example, the first portion 40P1, the third portion 40P3, and the second portion 40P2 overlap in this order. The second portion 40P2 and the third portion 40P3 may be in contact with each other or may be separated from each other. The second portion 40P2 and the third portion 40P3 may be bonded. In this example, the radius of curvature of the bending of the second portion 40P2 with respect to the first portion 40P1 can be increased. Thus, the oxygen movement path connecting the first container 30 and the oxygen-absorbing member 20 can be more stably secured. This enables oxygen to stably move from the stopper 34 to the oxygen-absorbing member 20 and stably reduce the concentration of oxygen in the first container 30 and the amount of dissolved oxygen in the liquid medicine L contained in the first container 30.

As illustrated in FIG. 8B, the combined medical container 10L containing a liquid medicine may further include an outer case 55 for storing the second container 40. The outer case 55 includes a bottom portion 56, a top portion 57 facing the bottom portion 56, and a side wall portion 58 located between the bottom portion 56 and the top portion 57. As illustrated in FIG. 8A, the second container 40 is folded such that the first portion 40P1, the second portion 40P2, and the third portion 40P3 overlap. As shown by the dash-dot-dot line in FIG. 8A, the second container storing the first container 30 may be stored in the outer case 55 such that the bottom portion 32a of the container body 32 of the first container 30 faces the bottom portion 56 of the outer case 55 and the stopper 34 of the first container 30 faces the top portion 57 of the outer case 55. In this example, the combined medical container 10L containing a liquid medicine can be stored with the bottom portion 56 positioned on a placement surface, such as a desk or a shelf. At this time, the stopper 34 with oxygen permeability is away from the liquid medicine L and comes into contact with the gas in the headspace HS in the first container 30. Storing the combined medical container 10L containing a liquid medicine in this state can promote the oxygen permeation through the stopper 34 and can rapidly reduce the concentration of oxygen in the first container 30 and the amount of dissolved oxygen in the liquid medicine L after the first container 30 is stored in the second container 40.

Next, a method of using the combined medical container 10L containing a liquid medicine is described.

To use the liquid medicine L contained in the combined medical container 10, first, the second container 40 is opened. Next, the first container 30L containing a liquid medicine is taken out from the opened second container 40. The liquid medicine L is then taken out from the first container 30L containing a liquid medicine and can be used. With respect to the first container 30L containing a liquid medicine illustrated in FIG. 1C, the first container 30 can be opened by removing the fixture 36 from the container body 32 and further removing the stopper 34 from the container body 32. Thus, the liquid medicine L in the first container 30 can be used.

In the combined medical container 10L containing a liquid medicine illustrated in FIGS. 1A and 1B, the second container 40 includes the first film 41a and the second film 41b storing the first container 30 between the first film 41a and the second film 41b. The first film 41a and the second film 41b are peelably bonded to each other at the seal portion 49. The seal portion 49 includes the first seal portion 49a positioned to face the first container 30. The first seal portion 49a has a linear shape. The first seal portion 49a is bent. The first seal portion 49a is bent so as to protrude to the side away from the first container 30 in the first direction D1 where the first seal portion 49a and the first container 30 face each other. Thus, the second container 40 can be easily opened by peeling off the first film 41a and the second film 41b at the first seal portion 49a with the bent first seal portion 49a as a starting point.

Furthermore, when the second container 40 is opened, the first container 30 is located in the opening portion of the second container 40. In particular, the first container 30 may be positioned within the second container 40 by the first seal portion 49a protruding away from the first container 30. Thus, when the second container 40 is opened, the first container 30 can be stably grasped. Thus, the first container 30 can be taken out from the second container 40. That is, when the liquid medicine L contained in the first container 30 is used, the first container 30 can be easily taken out from the second container 40.

In the example illustrated in FIGS. 1A and 1B, the first container 30 is disposed in the second container 40 so that the container body 32 faces the first seal portion 49a and the stopper 34 faces the oxygen-absorbing member 20. As illustrated in FIG. 1D, the first container 30 may be disposed in the second container 40 such that the stopper 34 faces the first seal portion 49a and the bottom portion 32a of the container body 32 faces the oxygen-absorbing member 20. The combined medical container 10L containing a liquid medicine illustrated in FIG. 1D can also be expected to have the following operation and effect similar to the combined medical container 10L containing a liquid medicine illustrated in FIGS. 1A and 1B. Thus, the second container 40 can be easily opened by easily peeling off the first film 41a and the second film 41b at the first seal portion 49a with the bent first seal portion 49a as a starting point. Furthermore, when the second container 40 is opened, the first container 30 is located in the opening portion of the second container 40. In particular, the first container 30 is positioned within the second container 40 by the first seal portion 49a protruding away from the first container 30. Thus, when the second container 40 is opened, the first container 30 can be stably grasped. Thus, when the liquid medicine L contained in the first container 30 is used, the first container 30 can be easily taken out from the second container 40. In particular, in the example illustrated in FIG. 1D, when the second container 40 is opened, the fixture 36 of the first container 30 and the head portion 32d and the neck portion 32c of the container body 32 can be grasped, and the first container 30 can be more stably taken out from the second container 40.

In the examples illustrated in FIGS. 1A and 1D, when the second container 40 is opened, wastes, such as scraps, are not generated. The oxygen-absorbing member 20 and the oxygen detection member 28 are stored in the second container 40 even after the first container 30 is taken out from the second container 40. Thus, it is easy to handle the second container 40, the oxygen-absorbing member 20, and the oxygen detection member 28 that are discarded after the second container 40 is opened.

As illustrated in FIG. 1A, the seal portion 49 may include a main seal portion 49X that defines the space S for storing the first container 30, and an auxiliary seal portion 49Y that binds the first film 41a and the second film 41b at the extension portion 50b. In the illustrated example, the main seal portion 49X includes the first seal portion 49a, the first side seal portion 49b, the second side seal portion 49c, and the second seal portion 49d. The auxiliary seal portion 49Y can be provided to suppress curling of the first film 41a and the second film 41b at the extension portion 50b. Thus, the auxiliary seal portion 49Y can be provided to easily grasp the extension portion 50b of the first film 41a and the second film 41b. Thus, the combined medical container 10L containing a liquid medicine can be more easily handled. Furthermore, the second container 40 can have improved rigidity in the extension portion 50b and can protect the first container 30.

In the example illustrated in FIG. 1A, the auxiliary seal portion 49Y includes a first auxiliary seal portion 49Ya connected to the first side seal portion 49b and a second auxiliary seal portion 49Yb connected to the second side seal portion 49c. The first auxiliary seal portion 49Ya may linearly extend on an extension line of the first side seal portion 49b. The second auxiliary seal portion 49Yb may linearly extend on an extension line of the second side seal portion 49c. These examples can more effectively suppress curling of the first film 41a and the second film 41b at the extension portion 50b. These examples more effectively improve the rigidity of the second container 40 at the extension portion 50b.

The configuration of the auxiliary seal portion 49Y is not limited to the configuration illustrated in FIG. 1A or the like. As illustrated in FIG. 1E, the auxiliary seal portion 49Y may be separated from the main seal portion 49X. In the example illustrated in FIG. 1E, the auxiliary seal portion 49Y includes the first auxiliary seal portion 49Ya located on an extension line of the first side seal portion 49b and the second auxiliary seal portion 49Yb located on an extension line of the second side seal portion 49c. The first auxiliary seal portion 49Ya and the second auxiliary seal portion 49Yb may have a line shape, a polygonal line shape, or a dot shape as illustrated in FIG. 1E. These examples can also suppress the curling of the first film 41a and the second film 41b at the extension portion 50b. These examples also improve the rigidity of the second container 40 at the extension portion 50b.

As illustrated in FIG. 9, the liquid medicine L may be an injection. The injection is, for example, an anticancer agent, an antiviral agent, a vaccine, or an antipsychotic agent. The liquid medicine L may be taken out from the first container 30 using the syringe 60. Like the syringe constituting the first container 30, the syringe 60 may include a cylinder 62 and a piston 66. The cylinder 62 may include a cylinder body 63 and a needle 64 protruding from the cylinder body 63. The tubular needle 64 enables access to the space for storing the liquid medicine L of the cylinder body 63. The piston 66 may include a piston body 67 and a gasket 68 retained in the piston body 67. The gasket 68 may be composed of rubber or the like. The gasket 68 is inserted into the cylinder body 63 and defines the storage space of the liquid medicine L in the cylinder body 63. The liquid medicine L injected into the syringe 60 may be transferred from the syringe 60 to another syringe, a container, or the like before being administered to a patient or the like. In this example, it may be administered to a patient from another syringe, a container, or the like.

In the example illustrated in FIGS. 3A to 3D in which the syringe 60 constitutes the first container 30, the syringe 60 taken out from the second container 40 by opening portion the second container 40 can be used for a patient as it is.

The pressure in the first container 30L containing a liquid medicine may be adjusted. As an example, the pressure in the first container 30L containing a liquid medicine may be kept low or may be kept negative. This example can suppress unintended leakage of the liquid medicine L during storage of the first container 30L containing a liquid medicine, scattering of the liquid medicine L when the first container 30 is opened, or the like. The leakage or scattering problem is more severe with a toxic liquid, for example, a highly pharmacologically active chemical. Furthermore, in the example illustrated in FIG. 9, when the pressure in the first container 30L containing a liquid medicine is positive, the liquid medicine L automatically enters the syringe 60. In this case, it is difficult to inject a desired amount of the liquid medicine L into the syringe 60 with high accuracy.

On the other hand, the liquid medicine L, for example, an anticancer agent, an antiviral agent, a vaccine, an antipsychotic agent, or the like, which is deteriorated by a post-sterilization treatment performed after production using, for example, gas, heat, gamma rays, or the like, is produced in a sterile environment and is stored in a container. That is, the liquid medicine L to which the terminal sterilization method cannot be applied is produced by an aseptic manipulation method. This sterile environment is typically maintained at a predetermined positive pressure to suppress the entry of bacteria. Thus, the pressure in the container becomes a predetermined positive pressure corresponding to the sterile environment, and it is difficult to adjust the internal pressure of the container after the container is closed.

The combined medical container 10L containing a liquid medicine can address such a trouble. As described above, the first container 30L containing a liquid medicine is stored in the second container 40. During this storage, oxygen in the first container 30 permeates the first container 30 and moves into the second container 40. This decreases the pressure in the first container 30. That is, the pressure of the first container 30 containing the liquid medicine L can be adjusted after the first container 30 is closed to enclose the liquid medicine L.

As illustrated in FIGS. 3A to 3C, the syringe 60 may further include a fixing component 61 that regulates the relative movement of the piston 66 with respect to the cylinder 62. The fixing component 61 is removably attached to one or more of the cylinder 62 and the piston 66. The fixing component 61 can maintain the storage space S defined by the cylinder 62 and the piston 66 at a negative pressure or a positive pressure. That is, the pressure in the storage space S of the syringe 60 can be maintained to be lower or higher than the pressure of the environment in which the syringe 60 is disposed or the pressure in the second container 40.

In the example illustrated in FIGS. 3A to 3C, the pressure in the syringe 60 can be adjusted by permeation of gas through the stopper 34 and the gasket 68. More specifically, the pressure in the storage space S of the first container 30 defined by the cylinder body 63 and the gasket 68 can be reduced, particularly reduced to a negative pressure. The internal pressure of the syringe 60 can be reduced to suppress the scattering of the liquid medicine L when the fixing component 61 is removed.

From the perspective of adjusting the internal pressure of the first container 30, a second container 40 that can contain a gas at atmospheric pressure while maintaining the gas at a negative pressure may be used. For example, the second container 40 illustrated in FIGS. 3A to 3C and 4F may be used, and the second container 40 storing the first container 30 may be closed in an inert gas atmosphere maintained at negative pressures. The pressure in the closed second container 40 is lower than the atmospheric pressure. This promotes oxygen permeation from the first container 30 to the second container 40. In particular, the pressure in the first container 30 can be adjusted to a large extent by securing a large volume of the second container 40 or greatly reducing the initial pressure of the second container 40. As a result, the pressure in the first container 30, which is initially positive, can be adjusted to be the atmospheric pressure (1 atm) or less and further adjusted to be negative by storing the first container 30 in the second container 40. Thus, a pressure-adjusted first container 30L containing a liquid medicine can be produced without depending on the method for producing the liquid medicine L, the method for enclosing the liquid medicine L in the first container 30, or the like.

Closing the second container 40 by applying a negative pressure thereto promotes the oxygen permeation through the first container 30. Thus, it is possible to shorten the time from the closing of the second container 40 storing the first container 30L containing a liquid medicine to the equilibrium of the oxygen permeation through the first container 30.

It should be noted that the negative pressure refers to a pressure lower than the atmospheric pressure, that is, a pressure lower than 1 atm. The positive pressure refers to a pressure higher than the atmospheric pressure of 1 atm. When the container is provided with a pressure gauge, whether or not the inside of the container is a negative pressure is determined with the pressure gauge. When the container is not provided with a pressure gauge, it is determined using a syringe. More specifically, when a needle of a syringe is stuck into a target container, it is determined whether or not the liquid or gas contained in the syringe flows into the container in a state where only the atmospheric pressure is applied to the piston of the syringe. When the liquid or gas in the syringe flows into the container, it is determined that the pressure in the container is negative. Likewise, whether or not the pressure in the container is positive is determined using a pressure gauge. When the container is not provided with a pressure gauge, it is determined using a syringe. More specifically, when a needle of a syringe is stuck into a target container, it is determined whether or not the liquid or gas contained in the container flows into the syringe in a state where only the atmospheric pressure is applied to the piston of the syringe. When the liquid or gas in the container flows into the syringe, it is determined that the pressure in the container is positive.

In the first embodiment described above, the first container 30L containing a liquid medicine includes the first container 30 and the liquid medicine L contained in the first container 30. The combined medical container 10L containing a liquid medicine includes the first container 30L containing a liquid medicine, the second container 40, and the oxygen absorber 22. The second container 40 stores the first container 30L containing a liquid medicine. The second container 40 has an oxygen barrier property. The oxygen absorber 22 absorbs oxygen in the second container 40.

In the first embodiment, the first container 30 includes a container body 32 with an opening portion 33, and a stopper 34 that closes the opening portion 33. A material constituting the stopper 34 has a first oxygen permeability of 0.00010 (cc×mm/(mm²×day)) or more at a temperature of 23° C. and a relative humidity of 50%. This promotes oxygen permeation through the stopper 34 of the first container 30 and accelerates the movement of oxygen from the first container 30 to the second container 40. This can effectively suppress the oxygen degradation of the liquid medicine L.

In the first embodiment, a material constituting the stopper 34 has a first water vapor permeability of 1 (mg×mm/(mm²×day)) or less at a temperature of 40° C. and a relative humidity of 90%. The water vapor permeation through the stopper 34 of the first container 30 can be suppressed in this manner to suppress the quality deterioration of the liquid medicine L. For example, when the liquid medicine L contains a non-aqueous liquid medium, it is possible to suppress the movement of a large amount of water vapor from the second container 40 to the first container 30 through the stopper 34. This can suppress the hydrolysis of a pharmaceutical ingredient of the liquid medicine L. When the liquid medicine L contains an aqueous liquid medium, the evaporation of the aqueous liquid medium and the water vapor permeation through the first container 30 are suppressed. This can suppress the change in the concentration of a pharmaceutical ingredient in the liquid medicine L and the change in the hydrogen ion concentration of the liquid medicine L. That is, the first embodiment can address the newly arising issue of quality deterioration of the liquid medicine L by applying the combined container to the liquid medicine L. Since this issue is unique to the combination of the combined container and the liquid medicine L and has not been known in the related art, it can be said that the operation and effect achieved by the first embodiment greatly exceed the range predicted from the state of the art.

In the first embodiment described above, the quality deterioration of the liquid medicine L is suppressed by promoting the oxygen permeation through the stopper 34 and suppressing the water vapor permeation through the stopper 34. As a second embodiment, the quality deterioration of the liquid medicine L may be suppressed by adjusting the permeability of the entire first container. That is, the oxygen permeation through the first container 30 may be promoted and the water vapor permeation through the first container 30 may be suppressed. The second embodiment can also sufficiently suppress both the oxygen degradation of the liquid medicine L and the quality deterioration of the liquid medicine L due to water vapor. The second oxygen permeability in the predetermined range and the second water vapor permeability in the predetermined range that are imparted to the first container are described below. The first container 30 used in the first embodiment may have, in addition to the first oxygen permeability in the predetermined range and the first water vapor permeability in the predetermined range described above, the second oxygen permeability in the predetermined range and the second water vapor permeability in the predetermined range described below.

In the second embodiment, the first container 30 has the second oxygen permeability in the predetermined range and the second water vapor permeability in the predetermined range. In other respects, the second embodiment may include the same configuration as that of the first embodiment described above. For example, the second embodiment may include the first container 30L containing a liquid medicine, the medical container set 15, and the combined medical container 10L containing a liquid medicine illustrated in FIGS. 1A to 9. In the following description of the second embodiment and the drawings used in the following description of the second embodiment, the same reference numerals and letters are used for portions that can be configured in the same manner as the portions described in the first embodiment, and redundant description is omitted.

The first container 30 may have a second oxygen permeability of 0.010 (cc/day) or more, 0.050 (cc/day) or more, 0.10 (cc/day) or more, 0.20 (cc/day) or more, 0.48 (cc/day) or more, 0.50 (cc/day) or more, 0.72 (cc/day) or more, 1.0 (cc/day) or more, or 1.5 (cc/day) or more, 1.68 (cc/day) or more. The second oxygen permeability is a characteristic at a temperature of 23° C. and a relative humidity of 50%. The lower limit of the second oxygen permeability of the first container 30 can be set in this manner to sufficiently promote the oxygen permeation through the first container 30 and suppress the oxygen degradation of the liquid medicine L. The second oxygen permeability may be 10 (cc/day) or less, 5.0 (cc/day) or less, or 1.0 (cc/day) or less.

The first container 30 may have a second oxygen permeability of 0.010 (cc/day) or more and 10 (cc/day) or less, 0.050 (cc/day) or more and 10 (cc/day) or less, 0.10 (cc/day) or more and 10 (cc/day) or less, 0.20 (cc/day) or more and 10 (cc/day) or less, 0.48 (cc/day) or more and 10 (cc/day) or less, 0.50 (cc/day) or more and 10 (cc/day) or less, 0.72 (cc/day) or more and 10 (cc/day) or less, 1.0 (cc/day) or more and 10 (cc/day) or less, 1.5 (cc/day) or more and 10 (cc/day) or less, or 1.68 (cc/day) or more and 10 (cc/day) or less. The first container 30 may have a second oxygen permeability of 0.010 (cc/day) or more and 5.0 (cc/day) or less, 0.050 (cc/day) or more and 5.0 (cc/day) or less, 0.10 (cc/day) or more and 5.0 (cc/day) or less, 0.20 (cc/day) or more and 5.0 (cc/day) or less, 0.48 (cc/day) or more and 5.0 (cc/day) or less, 0.50 (cc/day) or more and 5.0 (cc/day) or less, 0.72 (cc/day) or more and 5.0 (cc/day) or less, 1.0 (cc/day) or more and 5.0 (cc/day) or less, 1.5 (cc/day) or more and 5.0 (cc/day) or less, or 1.68 (cc/day) or more and 5.0 (cc/day) or less. The first container 30 may have a second oxygen permeability of 0.010 (cc/day) or more and 1.0 (cc/day) or less, 0.050 (cc/day) or more and 1.0 (cc/day) or less, 0.10 (cc/day) or more and 1.0 (cc/day) or less, 0.20 (cc/day) or more and 1.0 (cc/day) or less, 0.48 (cc/day) or more and 1.0 (cc/day) or less, 0.50 (cc/day) or more and 1.0 (cc/day) or less, 0.72 (cc/day) or more and 1.0 (cc/day) or less, 1.0 (cc/day) or more and 1.0 (cc/day) or less, 1.5 (cc/day) or more and 1.0 (cc/day) or less, or 1.68 (cc/day) or more and 1.0 (cc/day) or less.

The second oxygen permeability is a characteristic related to oxygen permeation through a constituent element, such as a component constituting the container, or the entire container. The second oxygen permeability refers to the volume of oxygen permeating a container to be measured per unit time in a state where the container is placed in an air atmosphere and the inside of the container is maintained in a substantially oxygen-free state. The unit time is one day or 24 hours. The unit of the volume of oxygen is “cc”.

The second oxygen permeability of a component constituting the first container 30 is set in the same numerical range as the numerical range of the second oxygen permeability of the first container 30. Although the second oxygen permeability of the first container 30 in a first state (disassembled state) is described later, the second oxygen permeability of the first container 30 in the first state (disassembled state) is set in the same numerical range as the numerical range of the second oxygen permeability of the first container 30.

As illustrated in FIGS. 10A and 10B, the second oxygen permeability of a constituent element, such as a component constituting a container, is measured using a test container 70 including a constituent element to be measured. As illustrated in FIG. 2A, the test container 70 for measuring the first oxygen permeability includes a test sheet 30X. In the test container 70 for measuring the second oxygen permeability, each component capable of serving as an oxygen permeation path of the first container 30 is used instead of the test sheet 30X. Except for this point, an apparatus for measuring the second oxygen permeability illustrated in FIGS. 10A and 10B has the same configuration as that described above for the apparatus for measuring the first oxygen permeability illustrated in FIG. 2A.

In the test container 70 illustrated in FIG. 10A, a partition wall portion 71 of the test container 70 includes a main wall portion 72 and a stopper 34. The stopper 34 faces a through-hole 72A. The through-hole 72A is closed by the stopper 34. The stopper 34 is hermetically bonded to the peripheral portion of the through-hole 72A of the main wall portion 72 by using a barrier bonding material 73 with an oxygen barrier property. The portion of the stopper 34 in contact with the barrier bonding material 73 is a portion in contact with the container body 32 in normal use of the first container 30.

In a test container 70 illustrated in FIG. 10B, a partition wall portion 71 of the test container 70 includes a main wall portion 72 and a container body 32. The container body 32 faces a through-hole 72A. The through-hole 72A is closed by the container body 32. The container body 32 is hermetically bonded to the peripheral portion of the through-hole 72A of the main wall portion 72 by using a barrier bonding material 73 with an oxygen barrier property. The portion of the container body 32 in contact with the barrier bonding material 73 is a portion in air-tight contact with the stopper 34 in normal use of the first container 30.

The concentration of oxygen in the test container 70 is maintained at 0.05% or less. That is, the test container 70 is substantially free of oxygen. The test container 70 is connected to a first flow path 71A and a second flow path 71B. The second flow path 71B is connected to an oxygen meter 74 that measures the amount of oxygen. The oxygen meter 74 can measure the amount (cc) of oxygen flowing through the second flow path 71B. The oxygen meter 74 is an oxygen content meter incorporated in OXTRAN (2/61) manufactured by MOCON, Inc., U.S.A. An oxygen-free gas is supplied through the first flow path 71A to the test container 70. Nitrogen is supplied through the first flow path 71A. The gas in the test container 70 is discharged through the second flow path 71B. The first flow path 71A and the second flow path 71B have an oxygen barrier property. The inside of the test container 70 is maintained in a substantially oxygen-free state by the first flow path 71A and the second flow path 71B.

The test container 70 is placed in a test atmosphere with a temperature of 23° C. and a relative humidity of 50%. The test atmosphere is an air atmosphere at atmospheric pressure. The test atmosphere has an oxygen concentration of 20.95%. When the test container 70 is placed in the test atmosphere, oxygen moves from the test atmosphere into the test container 70 through components 32 and 34 to be measured. The gas in the test container 70 is discharged from the second flow path 71B. The amount of oxygen flowing through the second flow path 71B can be measured with the oxygen meter 74 to measure the oxygen permeation amount per day (cc/day) through the components 32 and 34 to be measured in an atmosphere with a temperature of 23° C. and a relative humidity of 50%. The oxygen permeation rate (cc/day) measured for the container body 32 is the second oxygen permeability of the container body 32. The oxygen permeation rate (cc/day) measured for the stopper 34 is the second oxygen permeability of the stopper 34.

The second oxygen permeability (cc/day) of the first container 30 is evaluated in a state of being stored in the second container 40. The second oxygen permeability (cc/day) of the first container 30 is an indicator of the permeability of the first container in an assembled state. For example, for the first container 30 attached to the container body 32 in a state where the stopper is compressed, this state is reproduced to measure the second oxygen permeability (cc/day). Also in this case, the second oxygen permeability (cc/day) of the first container 30 is determined by dividing the first container 30 into a plurality of portions, evaluating the second oxygen permeability (cc/day) of the plurality of divided portions, and adding the second oxygen permeability (cc/day) of the plurality of portions. The position at which the first container 30 is divided is a position at which one component does not receive an action, such as a pressure, from another component.

For example, the first container 30 illustrated in FIG. 1C includes a fixture 36 for fastening the stopper 34 to the container body 32. The fixture 36 presses the stopper 34 toward the container body 32. For the first container 30, the second oxygen permeability (cc/day) of the first container 30 is determined by measuring the second oxygen permeability (cc/day) of a portion 30Z of the first container 30 including the stopper 34 and the fixture 36 and the second oxygen permeability (cc/day) of the remaining portion of the first container 30 in the test container 70 illustrated in FIG. 10E and adding the measured values.

In the example illustrated in FIG. 10E, the portion 30Z includes the stopper 34 and the fixture 36, and a portion of the container body 32 to which the stopper 34 and the fixture 36 are attached. A portion of the container body 32 is hermetically bonded to the peripheral portion of the through-hole 72A of the main wall portion 72 via the barrier bonding material 73 with an oxygen barrier property. In the example illustrated in FIG. 10E, the portion 30Z is obtained by cutting the container body 32 of the first container 30 illustrated in FIG. 1C in the vicinity of the stopper 34.

The test container 70 illustrated in FIG. 10E is used to determine the second oxygen permeability (cc/day) of the portion 30Z. Another portion of the first container other than the portion 30Z is used to form the test container 70, and the test container is used to determine the second oxygen permeability (cc/day) for the other portion. The total value of the oxygen permeation amount per day (cc/day) measured for the portion 30Z and the other portion corresponds to the second oxygen permeability (cc/day) of the first container 30 composed of the portion 30Z and the other portion. The second oxygen permeability (cc/day) of the first container 30 composed of the portion 30Z and the other portion is determined by adding the second oxygen permeability (cc/day) of the portion 30Z, and the second oxygen permeability (cc/day) of the other portion

As an indicator different from the second oxygen permeability (cc/day) in the assembled state (or the usage state) of the first container measured by the method described with reference to FIG. 10E, a value obtained by adding the oxygen permeation amount per day (cc/day) measured for each of the components 32 and 34 of the container also serves as an indicator of the oxygen permeability of the first container 30. The total oxygen permeation rate (cc/day) obtained by adding up the second oxygen permeability (cc/day) of each component (constituent element) measured by the method described with reference to FIGS. 10A and 10B is defined as the second oxygen permeability (cc/day) of the first container 30 in the first state (or the disassembled state).

When the first container 30 is obtained in a disassembled state for each component, the second oxygen permeability (cc/day) of the first container 30 in the first state is calculated by adding up the second oxygen permeability (cc/day) measured for each component. When the first container 30 is obtained in an assembled state (usage state), the first container 30 is disassembled into components (constituent elements), and the second oxygen permeability (cc/day) of the first container 30 in the first state is calculated by adding up the second oxygen permeability (cc/day) measured for each component.

The second oxygen permeability of the first container 30 in the first state (disassembled state) is set in the same numerical range as the numerical range of the second oxygen permeability of the first container 30.

In the examples illustrated in FIGS. 10A, 10B, and 10E, the test container 70 is disposed within a test chamber 75. The atmosphere in the test chamber 75 is maintained at a temperature of 23° C. and a relative humidity of 50%. The test chamber 75 is supplied with air through a supply path 75A. The gas in the test chamber 75 is discharged through a discharge path 75B. Air is circulated through the supply path 75A and the discharge path 75B to maintain the concentration of oxygen in the test chamber 75 at 20.95%.

In the examples illustrated in FIGS. 10A, 10B, and 10E, a pump for circulating air may be provided in one of the supply path 75A and the discharge path 75B. As long as the concentration of oxygen in the test chamber 75 can be kept equal to that in an air atmosphere, the supply path 75A and the discharge path 75B illustrated in FIGS. 10A, 10B, and 10E may be opened to the air atmosphere at atmospheric pressure.

The first container 30 may have a second water vapor permeability of 20 (mg/day) or less, 18 (mg/day) or less, 15 (mg/day) or less, 10 (mg/day) or less, 6.0 (mg/day) or less, 4.6 (mg/day) or less, or 3.9 (mg/day) or less. The first water vapor permeability is a characteristic at a temperature of 40° C. and a relative humidity of 90%. Setting the upper limit of the second water vapor permeability of the first container 30 in this manner can sufficiently suppress the water vapor permeation through the first container 30 and suppress the quality deterioration of the liquid medicine L due to the water vapor permeation. The second water vapor permeability may be 0.050 (mg/day) or more, 0.10 (mg/day) or more, or 0.50 (mg/day) or more.

The first container 30 may have a second water vapor permeability of 0.050 (mg/day) or more and 20 (mg/day) or less, 0.050 (mg/day) or more and 18 (mg/day) or less, 0.050 (mg/day) or more and 15 (mg/day) or less, 0.050 (mg/day) or more and 10 (mg/day) or less, 0.050 (mg/day) or more and 6.0 (mg/day) or less, 0.050 (mg/day) or more and 4.6 (mg/day) or less, or 0.050 (mg/day) or more and 3.9 (mg/day) or less. The first container 30 may have a second water vapor permeability of 0.10 (mg/day) or more and 20 (mg/day) or less, 0.10 (mg/day) or more and 18 (mg/day) or less, 0.10 (mg/day) or more and 15 (mg/day) or less, 0.10 (mg/day) or more and 10 (mg/day) or less, 0.10 (mg/day) or more and 6.0 (mg/day) or less, 0.10 (mg/day) or more and 4.6 (mg/day) or less, or 0.10 (mg/day) or more and 3.9 (mg/day) or less. The first container 30 may have a second water vapor permeability of 0.50 (mg/day) or more and 20 (mg/day) or less, 0.50 (mg/day) or more and 18 (mg/day) or less, 0.50 (mg/day) or more and 15 (mg/day) or less, 0.50 (mg/day) or more and 10 (mg/day) or less, 0.50 (mg/day) or more and 6.0 (mg/day) or less, 0.50 (mg/day) or more and 4.6 (mg/day) or less, or 0.50 (mg/day) or more and 3.9 (mg/day) or less.

The second water vapor permeability is a characteristic related to the water vapor permeation through a constituent element, such as a component constituting the container, or the entire container. The second water vapor permeability refers to the volume of water vapor permeating a container to be measured per unit time in a state where the container is placed in an air atmosphere and the inside of the container is maintained in a substantially water-vapor-free state. The unit time is one day or 24 hours. The unit of the volume of water vapor is “mg”.

The second water vapor permeability of a component constituting the first container 30 is set in the same numerical range as the numerical range of the second water vapor permeability of the first container 30. Although the second water vapor permeability of the first container 30 in a first state (disassembled state) is described later, the second water vapor permeability of the first container 30 in the first state (disassembled state) is set in the same numerical range as the numerical range of the second water vapor permeability of the first container 30.

As illustrated in FIGS. 10C and 10D, the second water vapor permeability of a constituent element, such as a component constituting a container, is measured using a test container 77 including a constituent element to be measured. As illustrated in FIG. 2B, the test container 77 for measuring the first water vapor permeability includes a test sheet 30Y. In the test container 77 for measuring the second water vapor permeability, each component capable of serving as a water vapor permeation path of the first container 30 is used instead of the test sheet 30Y. Except for this point, the apparatus for measuring the second water vapor permeability illustrated in FIGS. 10C and 10D has the same configuration as that described above for the apparatus for measuring the first water vapor permeability illustrated in FIG. 2B.

In the test container 77 illustrated in FIG. 10C, a test storage portion 78 of the test container 77 is a container with an opening portion 78A. The test storage portion 78 has a water vapor barrier property. The stopper 34 faces the opening portion 78A. The opening portion 78A is closed by the stopper 34. The stopper 34 is hermetically bonded to the peripheral portion of the opening portion 78A of the test storage portion 78 by using a barrier bonding material 73 with a water vapor barrier property. In the test container 77, a portion facing the opening portion 78A of the stopper 34 is a portion of the stopper 34 facing the opening portion 33 in normal use of the first container 30. A portion of the stopper 34 in contact with the barrier bonding material 73 is a portion of the stopper 34 in contact with the container body 32 in normal use of the first container 30.

In the test container 77 illustrated in FIG. 10D, the container body 32 faces the opening portion 78A. The opening portion 78A is closed by the container body 32. The container body 32 is hermetically bonded to the peripheral portion of the opening portion 78A of the test storage portion 78 with a water vapor barrier property by using the barrier bonding material 73 with a water vapor barrier property. The portion of the container body 32 in contact with the barrier bonding material 73 is a portion in contact with the stopper 34 in normal use of the first container 30.

With reference to the provisions of JIS Z 0208-1976, the mass of calcium chloride 79 is determined so that the test is completed before the calcium chloride 79 absorbs 10% by mass of water based on the mass of the calcium chloride 79. The test container 77 with a volume of 1 mL or more and 50 mL or less typically stores approximately 10 g of calcium chloride. When the mass of calcium chloride is determined in this manner, the inside of the test container 77 can be maintained in a substantially water-vapor-free state.

The test container 70 is placed in a test atmosphere maintained at a temperature of 40° C. and a relative humidity of 90%. The test atmosphere is an air atmosphere at atmospheric pressure. When the test container 77 is placed in the test atmosphere, water vapor moves from the test atmosphere into the test container 77 through the components 32 and 34 of the container to be measured. In the test container 77, water vapor is absorbed as water by the calcium chloride 79. The weight increase of the test container 77 can be measured to determine the water vapor permeation amount (mg) through the components 32 and 34 of the container to be measured in an atmosphere with a temperature of 40° C. and a relative humidity of 90%. Immediately after closing the test container 77 by closing the opening portion 78A of the test storage portion 78 with the components 32 and 34 of the container to be measured, water vapor may be present in the test container 77. To remove the influence of the water vapor, the water vapor permeation amount per day (mg/day) through the components 32 and 34 of the container to be measured can be determined by dividing the change in weight between the weight of the test container 77 after one day from the closing of the test container 77 and the weight of the test container 77 after 11 days from the closing of the test container 77 by 10 (days).

Similarly to the second oxygen permeability of the first container 30, the second water vapor permeability (mg/day) of the first container 30 is evaluated in a state where the first container 30 is stored in the second container 40. The second water vapor permeability (mg/day) of the first container 30 is an indicator of the permeability of the first container in an assembled state. The second water vapor permeability (mg/day) of the first container 30 is determined by the same measurement method as the measurement method described with reference to FIGS. 10C and 10D except that the first container 30 in the assembled state (usage state) containing calcium chloride is used as the test container 77.

As illustrated in FIGS. 10C and 10D, the test container 77 is disposed in the test chamber 75. The atmosphere in the test chamber 75 is maintained at a temperature of 40° C. and a relative humidity of 90%. The atmosphere in the test chamber 75 is an air atmosphere at atmospheric pressure. The test chamber 75 is supplied with air through a supply path 75A. The gas in the test chamber 75 is discharged through a discharge path 75B. The supply path 75A and the discharge path 75B maintain the test chamber 75 in the test atmosphere.

The total water vapor permeation amount (mg/day) obtained by adding up the second water vapor permeability (mg/day) of each component (constituent element) measured by the method described above with reference to FIGS. 10C and 10D is defined as the first water vapor permeability (mg/day) of the first container 30 in the first state (or the disassembled state). The first water vapor permeability in the first state (or the disassembled state) of the first container 30 is also an indicator of the water vapor permeability of the first container 30, similarly to the above second water vapor oxygen permeability (mg/day) of the first container measured using the first container 30 in the assembled state.

When the first container 30 is obtained in a disassembled state for each component, the second water vapor permeability (mg/day) of the first container 30 in the first state is calculated by adding up the second water vapor permeability (mg/day) measured for each component. When the first container 30 is obtained in an assembled state (usage state), the first container 30 is disassembled into components (constituent elements), and the second water vapor permeability (mg/day) of the first container 30 in the first state is calculated by adding up the second water vapor permeability (mg/day) measured for each component.

The second water vapor permeability of the first container 30 in the first state (disassembled state) is set in the same numerical range as the numerical range of the second water vapor permeability of the first container 30.

In the second embodiment, the first container 30L containing a liquid medicine includes the first container 30 and the liquid medicine L contained in the first container 30. The combined medical container 10L containing a liquid medicine includes the first container 30L containing a liquid medicine, the second container 40, and the oxygen absorber 22. The second container 40 stores the first container 30L containing a liquid medicine. The second container 40 has an oxygen barrier property. The oxygen absorber 22 absorbs oxygen in the second container 40.

In the second embodiment, the first container 30 may have a second oxygen permeability of 0.010 (cc/day) or more at a temperature of 23° C. and a relative humidity of 50%. This promotes oxygen permeation through the stopper 34 of the first container 30 and accelerates the movement of oxygen from the first container 30 to the second container 40. This can effectively suppress the oxygen degradation of the liquid medicine L.

In the second embodiment, the first container 30 has a second water vapor permeability of 20 (mg/day) or less at a temperature of 40° C. and a relative humidity of 90%. The water vapor permeation through the stopper 34 of the first container 30 can be suppressed in this manner to suppress the quality deterioration of the liquid medicine L. For example, when the liquid medicine L contains a non-aqueous liquid medium, it is possible to suppress the movement of a large amount of water vapor from the second container 40 to the first container 30 through the stopper 34. This can suppress the hydrolysis of a pharmaceutical ingredient of the liquid medicine L. When the liquid medicine L contains an aqueous liquid medium, the evaporation of the aqueous liquid medium and the water vapor permeation through the first container 30 are suppressed. This can suppress the change in the concentration of a pharmaceutical ingredient in the liquid medicine L and the change in the hydrogen ion concentration of the liquid medicine L. That is, the second embodiment can address the newly arising issue of quality deterioration of the liquid medicine L by applying the combined container to the liquid medicine L. Since this issue is unique to the combination of the combined container and the liquid medicine L and has not been known in the related art, it can be said that the operation and effect achieved by the second embodiment greatly exceed the range predicted from the state of the art.

In the second embodiment, the second oxygen permeability and the second water vapor permeability of the first container 30 are within the above predetermined ranges, and the quality deterioration of the liquid medicine L is suppressed. In the second embodiment, the first oxygen permeability of a material constituting the stopper 34 may be within the predetermined range described in the first embodiment or may be out of the predetermined range described in the first embodiment. Likewise, the first water vapor permeability of a material constituting the stopper 34 may be within the predetermined range described in the first embodiment or may be out of the predetermined range described in the first embodiment. In the second embodiment, the stopper 34 may have an oxygen barrier property. For example, a material of the stopper 34 may be butyl rubber.

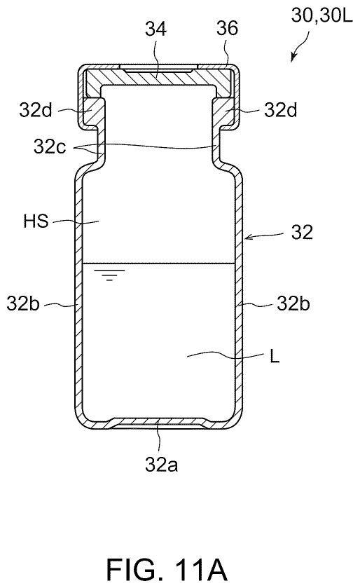

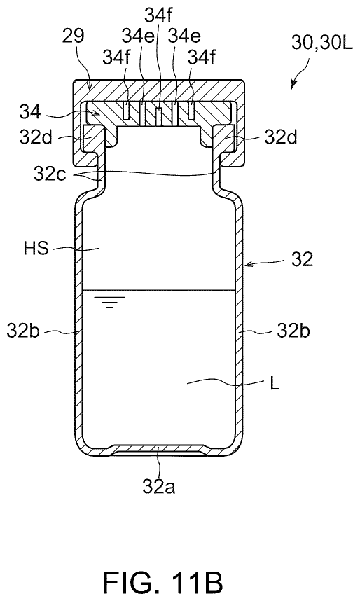

In the example illustrated in FIG. 11A, the first container 30 includes a container body 32, a stopper 34, and a fixture 36. The stopper 34 may be formed of a material that is less permeable to oxygen and water vapor. A material constituting the stopper 34 may have a first oxygen permeability of 0.00010 (cc×mm/(mm²×day)) or less at a temperature of 23° C. and a relative humidity of 50%. A material of the stopper 34 may be butyl rubber or natural rubber. This can suppress the water vapor permeation through the stopper 34. The thickness of the stopper 34 may be very thin, such as tens of micrometers to hundreds of micrometers. In the example illustrated in FIG. 11A, the stopper 34 has a small thickness, and it is possible to promote the oxygen permeation through the stopper 34. As a result, the first container 30 illustrated in FIG. 11A has the second oxygen permeability and the second water vapor permeability in the above predetermined ranges and can suppress the quality deterioration of the liquid medicine L. In the example illustrated in FIG. 11A, the container body 32 may or may not have an oxygen barrier property.

As illustrated in 11B, the first container 30 may include a container body 32, a stopper 34, and a cover 29. The stopper 34 at least partially covers the opening portion 33 of the container body 32. The cover 29 covers the stopper 34. In this example, the combination of the stopper 34 and the cover 29 promotes oxygen permeation and suppresses water vapor permeation. In another example, a combination of the stopper 34 and the fixture 36 that fixes the stopper 34 to the container body 32 may promote oxygen permeation and suppress water vapor permeation. As a result, the first container 30 has the second oxygen permeability in the predetermined range and the second water vapor permeability in the predetermined range described above and can suppress the quality deterioration of the liquid medicine L. In the example illustrated in FIG. 11B, the container body 32 may or may not have an oxygen barrier property.

The second oxygen permeability of the combination of the stopper 34 and the cover 29 is measured using the test container 70 including the combination of the stopper 34 and the cover 29. The second oxygen permeability of the combination of the stopper 34 and the fixture 36 is measured using the test container 70 including the combination of the stopper 34 and the fixture 36.

In the example illustrated in FIG. 11B, a through-hole 34e or a recessed portion 34f may be formed in the stopper 34. The oxygen permeation through the stopper 34 is promoted in the through-hole 34e or the recessed portion 34f A material constituting the stopper 34 may or may not have an oxygen barrier property. A material constituting the stopper 34 may be butyl rubber or natural rubber. A material constituting the stopper 34 may have a first oxygen permeability of less than 0.00010 (cc×mm/(mm²×day)) at a temperature of 23° C. and a relative humidity of 50%.

In the example illustrated in FIG. 11B, the cover 29 may be a cap made of resin. The cover 29 may be a resin film. Each of the first oxygen permeability and the first water vapor permeability of a material constituting the cover 29 may be within the predetermined range described in the first embodiment. That is, a material constituting the cover 29 may have a first oxygen permeability of 0.00010 (cc×mm/(mm²×day)) or more at a temperature of 23° C. and a relative humidity of 50%. A material constituting the cover 29 may have a first water vapor permeability of 1.0 (mg×mm/(mm²×day)) or less at a temperature of 40° C. and a relative humidity of 90%.

In the second embodiment, the container body 32 may have oxygen permeability. A material constituting the container body 32 may have a first oxygen permeability and a first water vapor permeability within the predetermined ranges described in the first embodiment. That is, a material constituting the container body 32 may have a first oxygen permeability of 0.00010 (cc×mm/(mm²×day)) or more at a temperature of 23° C. and a relative humidity of 50%. A material constituting the container body 32 may have a first water vapor permeability of 1.0 (mg×mm/(mm²×day)) or less at a temperature of 40° C. and a relative humidity of 90%.

In these examples related to the second embodiment, the first container 30 with a second oxygen permeability and a second water vapor permeability within the predetermined ranges can suppress the quality deterioration of the liquid medicine L.

Next, a specific example of a laminate 47 that can be used for the second container 40 is further described. In the following description and the drawings used in the following description, the same reference numerals and letters as those used for the corresponding portions in the above specific example are used for portions that can be configured similarly to the above specific example or corresponding configurations, and redundant description is omitted.

The oxygen barrier property of the second container 40 can be improved to sufficiently reduce the concentration of oxygen (%) in the second container 40, the concentration of oxygen (%) in the first container 30, and the amount of dissolved oxygen (mg/L) in the liquid medicine L in the first container 30 and stably maintain the reduced state. Furthermore, the water vapor barrier property of the second container 40 can be improved to suppress the increase in the amount of water vapor in the first container 30 when the liquid medicine L in the first container 30 contains a non-aqueous liquid medium. Furthermore, when the liquid medicine L in the first container 30 contains an aqueous liquid medium, the concentration of the liquid medicine L can be stably maintained.

A laminate of films 41a to 41d and the like in the second container 40 may include a barrier layer with an oxygen barrier function or a water vapor barrier function. The thickness of the barrier layer in the laminate can be increased to enhance the barrier function of the laminate. However, in general, an increase in the thickness of the barrier layer formed as a vapor-deposited layer results in a decrease in the adhesive strength between the barrier layer and an adjacent layer. Furthermore, when the thickness of the barrier layer formed as a vapor-deposited layer is increased, the barrier layer is easily cracked. For such a reason, the oxygen barrier property and the water vapor barrier property of a laminate used in a known container have been limited. In this regard, as a result of intensive studies, the present inventors have devised a laminate with a good barrier property. A laminate devised by the present inventors is described below.

A laminate described below can be applied to the combined medical container 10 and the second container 40 included in the medical container set 15. More specifically, a laminate 47 described below may constitute the films 41a to 41e of the second container 40 illustrated in FIGS. 1A, 1B, ID, and 1E and FIGS. 4A to 4E. The laminate 47 described below may constitute the container body 42 and the lid 44 of the second container 40 illustrated in FIGS. 3A to 3C and 4F.

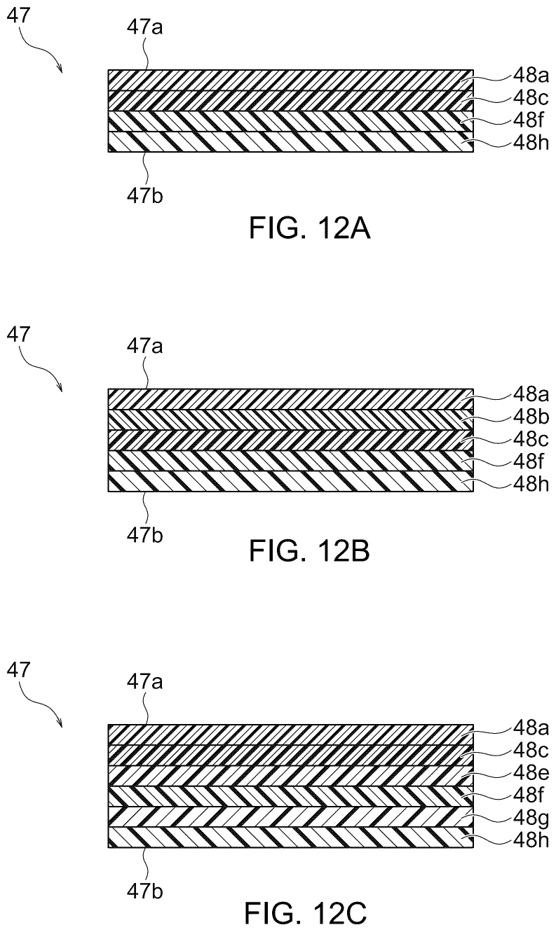

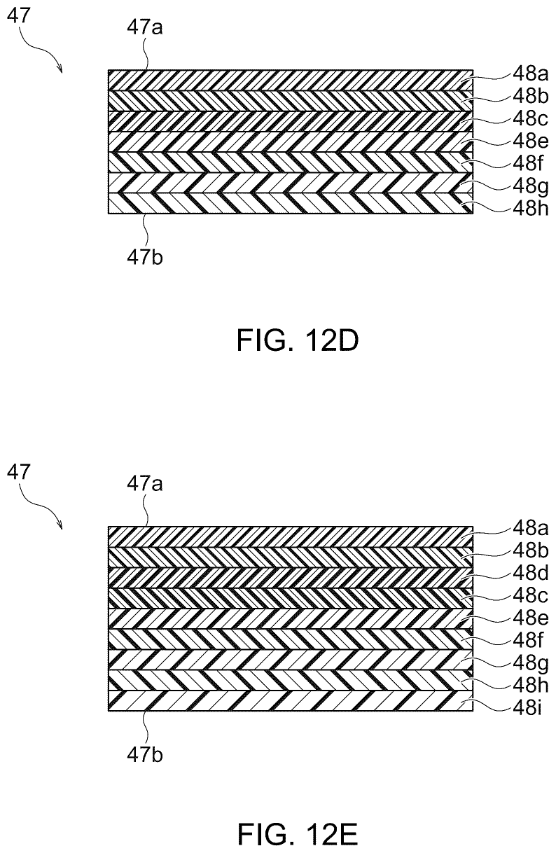

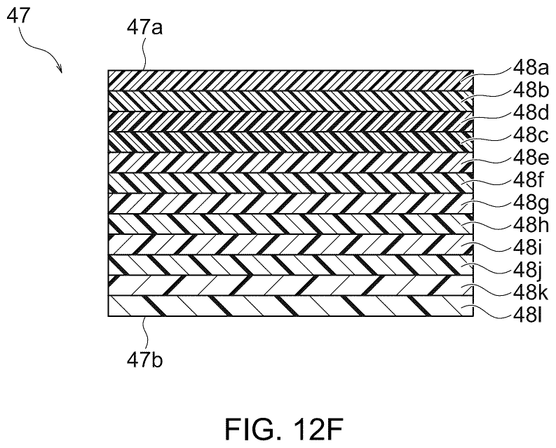

The laminate 47 includes an inner surface 47a facing the storage space S of the container and an outer surface 47b on the side opposite the inner surface 47a. As illustrated in FIG. 12A, the laminate 47 may include a sealant layer 48a, a first barrier layer 48c, a resin layer 48f, and a second barrier layer 48h in this order from the inner surface 47a to the outer surface 47b. The laminate 47 includes the two barrier layers 48c and 48h with a barrier function. Thus, the laminate 47 has a high barrier property without increasing the thickness of each of the barrier layers 48c and 48h included in the laminate 47. That is, the laminate 47 can exhibit a high barrier function while suppressing a decrease in adhesiveness and cracking of the barrier layers 48c and 48h.

Furthermore, even if a defect, such as a pinhole or a crack, occurs in one of the barrier layers 48c and 48h, the laminate 47 can maintain a certain degree of barrier property by the other of the barrier layers 48c and 48h. In particular, the resin layer 48f is arranged between the first barrier layer 48c and the second barrier layer 48h. The resin layer 48f, which functions as a substrate of the laminate 47, can suppress the occurrence of a defect, such as a pinhole or a crack, in both the first barrier layer 48c and the second barrier layer 48h.

The laminate 47 applied to the combined medical container 10 and the second container 40 of the medical container set 15 can exhibit a high oxygen barrier function and a high water vapor barrier function. The oxygen barrier property of the second container 40 can be improved to sufficiently reduce the concentration of oxygen (%) in the second container 40, the concentration of oxygen (%) in the first container 30, and the amount of dissolved oxygen (mg/L) in the liquid medicine L in the first container 30 and stably maintain the reduced state. The water vapor barrier property of the second container 40 can be improved to suppress an increase or decrease in the amount of water vapor in the first container 30 and the second container 40 when the liquid medicine L in the first container 30 contains a non-aqueous solvent. When the liquid medicine L in the first container 30 contains an aqueous solvent, the concentration of the liquid medicine L in the first container 30 can be stably maintained.

The resin layer 48f disposed between the two barrier layers 48c and 48h can suppress the formation of bubbles in the laminate 47. Thus, when the laminate 47 is applied to the medical container set 15 and the second container 40 of the combined medical container 10, the state of the first container 30 can be observed from the outside of the second container 40. Furthermore, the concentration of oxygen in the second container 40 can be measured with a non-contact oxygen content meter without opening the second container 40. Furthermore, when the container body 32 of the first container 30 is also transparent, the liquid medicine L in the first container 30 can be observed from the outside of the second container 40. In this case, the concentration of oxygen in the first container 30 can be measured with a non-contact oxygen content meter without opening the first container 30 and the second container 40. Likewise, the amount of dissolved oxygen in the liquid medicine L in the first container 30 can be measured with a non-contact oxygen content meter without opening the first container 30 and the second container 40.

The laminate 47 may be transparent. The laminate 47 may include a transparent portion. As described above, the term “transparent” means that a target portion has a transmission haze of 80.0% or less so that the inside of the target portion can be observed from the outside. To more clearly observe the target portion from the outside, at least part of the laminate 47 may have a transmission haze of 58.0% or less, 29.0% or less, 14.5% or less, 7.0% or less, 3.5% or less, or 1.0% or less.

When the laminate 47 is transparent, the state of the first container 30 can be observed from the outside of the second container 40 to which the laminate 47 is applied. Furthermore, the concentration of oxygen in the second container 40 can be measured with a non-contact oxygen content meter without opening the second container 40. Furthermore, when the container body 32 of the first container 30 is also transparent, the liquid medicine L in the first container 30 can be observed from the outside of the second container 40. In this case, the concentration of oxygen in the first container 30 can be measured with a non-contact oxygen content meter without opening the first container 30 and the second container 40. Likewise, the amount of dissolved oxygen in the liquid medicine L in the first container 30 can be measured with a non-contact oxygen content meter without opening the first container 30 and the second container 40.

The transmission haze in at least part of the laminate 47 may have any lower limit. At least part of the laminate 47 may have a transmission haze of 0% or more or more than 0%.

Part or the whole of the laminate 47 may have a total light transmittance of 50% or more, 70% or more, 80% or more, or 90% or more. By setting the lower limit to the total light transmittance of the laminate 47, the state of the first container 30 can be clearly observed from the outside of the second container 40 to which the laminate 47 is applied. The total light transmittance of the laminate 47 may have any lower limit. The total light transmittance of the laminate 47 may be 0% or more or more than 0%.

The laminate 47 may have a transmission haze in the above predetermined range and a total light transmittance in the above predetermined range.

For the measurement of the total light transmittance, a D65 standard light source is used. Before the total light transmittance is measured, the D65 standard light source is turned on for 15 minutes to stabilize the output of the D65 standard light source. The incident angle to the sample to measure the total light transmittance is 0 degrees. The test environment for measuring the total light transmittance is a temperature of 23° C.±2° C. and a relative humidity of 50%±5%. The sample is placed in the test environment for 16 hours before the start of the test. The other conditions for measuring the total light transmittance are in accordance with JIS K 7361-1: 1997. The total light transmittance is an arithmetic mean of five measured values. The five measured values are measured at five measurement positions of a measurement sample to be evaluated.

The yellow index (YI) of part or the whole of the laminate 47 may be 20 or less, 15 or less, 13 or less, or 10 or less. When the YI is 20 or less, the tint of the inside of the package is easily observed, and, for example, the degree of identification of an indicator for identification by color, such as Ageless Eye, is improved. The yellow index serves as an indicator of the degree of yellowness of the laminate 47. In the laminate 47, the two barrier layers exhibit the high barrier property. As compared with the use of one thick barrier layer, the use of the two barrier layers can reduce the yellow index of the laminate 47 to the above upper limit or less.

The above upper limit can be set for the yellow index (YI) to limit the yellowish coloring of the laminate 47. The above upper limit can be set for the yellow index (YI) to clearly observe the state of the first container 30 from the outside of the second container 40 to which the laminate 47 is applied.

The yellow index (YI) of the laminate 47 may have any lower limit. The laminate 47 may have a yellow index (YI) of 0 or more or more than 0.

The yellow index is measured using transmitted light. The tristimulus values X, Y, and Z in the XYZ color system are determined by spectrophotometric colorimetry using an auxiliary illuminant C in a 2-degree visual field on the basis of transmittances measured at 0.5 nm intervals in the range of 300 nm or more and 780 nm or less. The yellow index (YI) is determined from the values X, Y, and Z using the following formula.

YI=100(1.2769X−1.0592Z)/Y

The geometrical optics conditions for measuring the yellow index are the geometric optics conditions e according to JIS Z 8722: 2009. To eliminate the influence of scattered light from an end portion of a test specimen, the diameter of the incident light flux to the test specimen is smaller than the diameter of the opening portion. Before the yellow index is measured, the light source of the measuring apparatus is turned on for 15 minutes to stabilize the output of the D65 standard light source. The incident surface for the measurement of the yellow index is the inner surface 47a of the laminate 47. The test environment for the measurement of the yellow index is a temperature of 23° C.±2° C. and a relative humidity of 50%±5%. The sample is placed in the test environment for 16 hours before the start of the test.

The yellow index (YI) is an arithmetic mean of five measured values. The five measured values are measured at five measurement positions of an optical sheet to be evaluated. The five measurement positions are located 10 mm or more apart from each other. The other conditions for measuring the yellow index (YI) are in accordance with JIS K 7373-1: 2006.

The laminate 47 may have one or more of the transmission haze in the above predetermined range and the total light transmittance in the above predetermined range, and the yellow index in the above predetermined range.

The laminate 47 may have an oxygen permeation rate of less than 0.20 (mL/(m²×day×atm)), 0.15 (mL/(m²×day×atm)) or less, or 0.14 (mL/(m²×day×atm)) or less. When the oxygen permeation rate has such an upper limit, a very high oxygen barrier property can be imparted to the second container 40, and the concentration of oxygen (%) in the first container 30 and the amount of dissolved oxygen (mg/L) in the liquid medicine L can be sufficiently reduced and can be stably maintained in the reduced state. The oxygen permeation rate of the laminate 47 may have any lower limit. The oxygen permeation rate of the laminate 47 may be 0 (mL/(m²×day×atm)) or more or more than 0 (mL/(m²×day×atm)).

The laminate 47 may have an oxygen permeation rate of 0 (mL/(m²×day×atm)) or more and less than 0.20 (mL/(m²×day×atm)), 0 (mL/(m²×day×atm)) or more and 0.15 (mL/(m²×day×atm)) or less, or 0 (mL/(m²×day×atm)) or more and 0.14 (mL/(m²×day×atm)) or less. The laminate 47 may have an oxygen permeation rate of more than 0 (mL/(m²×day×atm)) and less than 0.20 (mL/(m²×day×atm)), more than 0 (mL/(m²×day×atm)) and less than 0.15 (mL/(m²×day×atm)) or less, or more than 0 (mL/(m²×day×atm)) and 0.14 (mL/(m²×day×atm)) or less.

The laminate 47 may have a water vapor permeation rate of 0.50 (g/(m²×day)) or less, 0.30 (g/(m²×day)) or less, or 0.20 (g/(m²×day)) or less. When the water vapor permeation rate has such an upper limit, a very high water vapor barrier property can be imparted to the second container 40. The permeation of the water vapor in the second container 40 to the outside can be suppressed to reduce the evaporation rate of the liquid medicine L and suppress the change in concentration. The water vapor permeation rate of the laminate 47 may have any lower limit. The laminate 47 may have a water vapor permeation rate of 0 (mL/(m²×day×atm)) or more or more than 0 (mL/(m²×day×atm)).

The laminate 47 may have a water vapor permeation rate of 0 (mL/(m²×day×atm)) or more and 0.50 (g/(m²×day)) or less, 0 (mL/(m²×day×atm)) or more and 0.30 (g/(m²×day)) or less, or 0 (mL/(m²×day×atm)) or more and 0.20 (g/(m²×day)) or less. The laminate 47 may have a water vapor permeation rate of more than 0 (mL/(m²×day×atm)) and 0.50 (g/(m²×day)) or less, more than 0 (mL/(m²×day×atm)) and 0.30 (g/(m²×day)) or less, or more than 0 (mL/(m²×day×atm)) and 0.20 (g/(m²×day)) or less.

The water vapor permeation rate is measured in accordance with JIS K 7129-2: 2019. The water vapor permeation rate is measured in an environment with a temperature of 40° C. and a relative humidity of 90% using the permeability measuring instrument PERMATRAN (3/33) manufactured by MOCON, Inc., U.S.A.

The resin layer 48f functions as a resin substrate of the laminate 47 as a whole. The resin layer 48f may be a stretched film. The resin layer 48f may contain a thermoplastic resin as a main component. The main component refers to a component with the highest mass ratio. The thickness of the resin layer 48f may have a lower limit. The resin layers 48f and 48j may have a thickness of 5 μm or more and 60 μm or less or 7 μm or more and 30 μm or less. The resin layer 48f can function as a resin substrate of the laminate 47 as a whole.

The resin layer 48f may be a substrate that supports at least one of the first barrier layer 48c and a first film substrate for barrier layer (barrier base layer) 48d.

The resin layer 48f, which functions as a resin substrate, imparts mechanical properties, for example, strength, hardness, Young's modulus, and flexural rigidity, required for the laminate 47. A material of the resin layer 48f functioning as a resin substrate may be a polyamide, polypropylene, or poly(ethylene terephthalate).

As a specific example, the resin layer 48f may be a stretched polyamide or a stretched polyester. The stretched polyamide may be a uniaxially stretched polyamide or a biaxially stretched polyamide. It may be a uniaxially stretched nylon or a biaxially stretched nylon. The stretched polyester may be a uniaxially stretched polyester, a biaxially stretched polyester, a uniaxially stretched poly(ethylene terephthalate), or a biaxially stretched poly(ethylene terephthalate).

Stretched polyamides and stretched nylons have a good piercing property, high wear resistance, and high bending resistance. Thus, a stretched polyamide or a stretched nylon can be used for the resin layer 48f to suppress the occurrence of a defect, such as a pinhole or a crack, in the laminate 47. A stretched polyamide or a stretched nylon can be used for the resin layer 48f to reduce the thickness of the laminate 47 while maintaining the strength of the laminate 47. Furthermore, the resin layer 48f containing a stretched polyamide or a stretched nylon can suppress the occurrence of a defect, such as a pinhole or a crack, in one of the barrier layers 48c and 48h even if a defect occurs in the other of the barrier layers 48c and 48h. In this respect, a stretched polyamide and a stretched nylon are very suitable as the resin layer 48f arranged between the two barrier layers 48c and 48h.

As illustrated in FIG. 12B, the laminate 47 may include an inner adhesive layer 48b between the sealant layer 48a and the first barrier layer 48c. The inner adhesive layer 48b may be adjacent to the sealant layer 48a and the first barrier layer 48c. The inner adhesive layer 48b may be bonded to the sealant layer 48a and the first barrier layer 48c. Alternatively, only a layer that does not transmit water vapor, for example, a poly(ethylene terephthalate) layer (PET layer) with a thickness of 9 μm or more and 16 μm or less, may be located between the inner adhesive layer 48b and the first barrier layer 48c. This example can sufficiently suppress the variation in the concentration of water vapor in the container.

As illustrated in FIGS. 12C and 12D, the laminate 47 may further include a first adhesive layer 48e between the first barrier layer 48c and the resin layer 48f and a second adhesive layer 48g between the resin layer 48f and the second barrier layer 48h. The first adhesive layer 48e may contain a cured product of a curable resin composition. The second adhesive layer 48g may contain a cured product of a curable resin composition. FIG. 12C illustrates a laminate formed by adding the adhesive layers 48e and 48g to the laminate illustrated in FIG. 12A. FIG. 12D illustrates a laminate formed by adding the adhesive layers 48e and 48g to the laminate illustrated in FIG. 12B.

Slight bubbling may occur during the curing treatment of a curable resin composition. The bubbles include, for example, carbon dioxide or water vapor. The bubbles cannot pass through the barrier layers 48c and 48h.

On the other hand, the resin layer 48f is composed of, for example, a polyamide, such as nylon, polypropylene, poly(ethylene terephthalate), or the like and has gas permeability. Bubbles generated from the first adhesive layer 48e can pass through one main surface (the main surface on the inner surface 47a side) of the resin layer 48f, advance through the resin layer 48f, and be released from a side end surface of the resin layer 48f to the outside of the container. Bubbles generated from the second adhesive layer 48g can pass through the other main surface (the main surface on the outer surface 47b side) of the resin layer 48f, advance through the resin layer 48f, and be released from a side end surface of the resin layer 48f to the outside of the container. That is, the resin layer 48f constitutes a permeation path for releasing bubbles generated when the adhesive layers 48e and 48g are cured.

Furthermore, the resin layer 48f is located between the first barrier layer 48c and the second barrier layer 48h. Thus, one of the first barrier layer 48c and the second barrier layer 48h can be bonded to the resin layer 48f with the adhesive layer, and then the other of the first barrier layer 48c and the second barrier layer 48h can be bonded to the resin layer 48f with the adhesive layer. One surface of the resin layer 48f bonded to one of the barrier layers with the adhesive layer can expose the other surface. Thus, bubbles generated in the adhesive layer pass through the resin layer 48f and can therefore be quickly removed. In this case, the discharge of bubbles can be further promoted by aging under appropriate conditions.

This can reduce bubble residuals in the high-barrier laminate 47 including the two barrier layers. This can reduce the cloudiness of the high-barrier laminate 47 including the two barrier layers. Furthermore, the visible light transmittance of the laminate 47 is maintained high, and the first container 30 and the liquid medicine L can be clearly observed from the outside of the second container 40. Furthermore, the concentration of oxygen in the second container 40, the concentration of oxygen in the first container 30, and the amount of dissolved oxygen in the liquid medicine L in the first container 30 can be measured with high accuracy from the outside of the second container 40.

From the perspective of suppressing the generation of bubbles in the laminate 47, the resin layer 48f may contain a polyester, such as poly(ethylene terephthalate). The resin layer 48f may contain a polyester, such as poly(ethylene terephthalate), as a main component. The main component refers to a component with the highest mass ratio. The resin layer 48f may contain a polyester film of poly(ethylene terephthalate) or the like. The polyester film may be a uniaxial stretched polyester film, a biaxially stretched polyester film, or a stretched polyester film. It may be a uniaxially stretched nylon film or a biaxially stretched nylon film.

Furthermore, from the perspective of increasing the puncture resistance of the laminate 47, the resin layer 48f may contain a polyamide, such as nylon. The resin layer 48f may contain a polyamide, such as nylon, as a main component. The main component refers to a component with the highest mass ratio. The resin layer 48f may include a polyamide film of nylon or the like. The polyamide film may be a uniaxial stretched polyamide film, a biaxially stretched polyamide film, or a stretched polyamide film. It may be a uniaxially stretched nylon film or a biaxially stretched nylon film.

As illustrated in FIG. 12E, the laminate 47 may include the first film substrate for barrier layer 48d adjacent to the first barrier layer 48c. The laminate 47 may include a second film substrate for barrier layer 48i adjacent to the second barrier layer 48h. The first film substrate for barrier layer 48d may be a resin substrate that supports the first barrier layer 48c. The second film substrate for barrier layer 48i may be a resin substrate that supports the second barrier layer 48h.

In the illustrated example, the first film substrate for barrier layer 48d is located between the first barrier layer 48c and the inner adhesive layer 48b. In this arrangement, the first barrier layer 48c does not come into direct contact with the sealant layer 48a, which is likely to be dimensionally changed or deformed. The first film substrate for barrier layer 48d interposed therebetween can reduce the influence of dimensional change or deformation of the sealant layer 48a on the first barrier layer 48c. This can suppress the occurrence of a defect, such as a crack or a pinhole, in the first barrier layer 48c.

In the illustrated example, the second barrier layer 48h is located between the resin layer 48f and the second film substrate for barrier layer 48i. The second barrier layer 48h is located between the second adhesive layer 48g and the second film substrate for barrier layer 48i. Thus, the second film substrate for barrier layer 48i may be closer to the outer surface 47b than the second barrier layer 48h or may constitute the outer surface 47b. In this arrangement, the second film substrate for barrier layer 48i receives an external force due to contact with the outside or an impact from the outside earlier than the second barrier layer 48h. The second film substrate for barrier layer 48i weakens the external force or impact received by the second barrier layer 48h. This can suppress the occurrence of a defect, such as a crack or a pinhole, in the second barrier layer 48h.

As illustrated in FIG. 12F, the laminate 47 may include three or more barrier layers. In the example illustrated in FIG. 12F, the laminate 47 further includes a second resin layer 48j and a third barrier layer 48k. A laminate including three or more barrier layers can further enhance the oxygen barrier property and the water vapor barrier property of the laminate 47. In FIG. 12F, the second resin layer 48j and the third barrier layer 48k are added to the laminate illustrated in FIG. 12E. Furthermore, the laminate 47 illustrated in FIG. 12F includes a third film substrate for barrier layer 48l. The third film substrate for barrier layer 48l constitutes the outer surface 47b. The third film substrate for barrier layer 48l may be a resin substrate that supports the third barrier layer 48k.

A third adhesive layer may be provided between the second resin layer 48j and the second film substrate for barrier layer 48i. A fourth adhesive layer may be provided between the second resin layer 48j and the third barrier layer 48k. The third adhesive layer and the fourth adhesive layer may be configured in the same manner as the adhesive layers 48e and 48g.

Also in the example illustrated in FIG. 12F, for the reasons described above, the first film substrate for barrier layer 48d may be positioned between the first barrier layer 48c and the inner adhesive layer 48b. Also in the example illustrated in FIG. 12F, for the reason described above, the second barrier layer 48h may be located between the resin layer 48f and the second film substrate for barrier layer 48i or may be located between the second adhesive layer 48g and the second film substrate for barrier layer 48i.

In the example illustrated in FIG. 12F, the third barrier layer 48k may be located between the second resin layer 48j and the third film substrate for barrier layer 48l. The third barrier layer 48k may be located between the fourth adhesive layer and the third film substrate for barrier layer 48l. Thus, the third film substrate for barrier layer 48l may be closer to the outer surface 47b than the third barrier layer 48k or may constitute the outer surface 47b. In this arrangement, the third film substrate for barrier layer 48l receives an external force or an impact due to contact with the outside earlier than the third barrier layer 48k. Thus, the third film substrate for barrier layer 48l weakens the external force or impact received by the third barrier layer 48k. This can suppress the occurrence of a defect, such as a crack or a pinhole, in the third barrier layer 48k.

Each layer that can be included in the laminate 47 is described in more detail below.

The barrier layers 48c, 48h, and 48k may contain a metal or an inorganic oxide. The barrier layer may be formed by a chemical vapor deposition (CVD) method or a physical vapor deposition (PVD) method. The barrier layer may be a vapor-deposited layer. The barrier layer may include a vapor-deposited layer. The vapor-deposited layer is a layer produced by vapor deposition. The vapor-deposited layer may contain a metal or an inorganic oxide. The vapor-deposited layer can provide a thin barrier layer with a good barrier property. The barrier layer may be a transparent vapor-deposited layer. The barrier layer may include a transparent vapor-deposited layer. The transparent vapor-deposited layer is a transparent layer formed by vapor deposition. The barrier layers 48c, 48h, and 48k as the transparent vapor-deposited layers, together with other layers, can provide a transparent laminate 47 including the thin barrier layer with a good barrier property. The transparent laminate 47 can be used for the second container 40 to observe the first container 30 from the outside of the second container 40.

The barrier layers 48c, 48h, and 48k may contain any metal. The metal is, for example, aluminum, tin, chromium, zinc, gold, silver, platinum, or nickel. Each of the barrier layers 48c, 48h, and 48k may contain two or more of these metals.

The barrier layers 48c, 48h, and 48k may contain any inorganic oxide. The inorganic oxide is, for example, an oxide of silicon, aluminum, magnesium, calcium, potassium, tin, sodium, boron, titanium, lead, zirconium, yttrium, or the like. Each of the barrier layers 48c, 48h, and 48k may contain two or more of these inorganic oxides. Specific examples of the inorganic oxide contained in the barrier layers 48c, 48h, and 48k include aluminum oxide and silicon oxide. The inorganic oxide is represented by, for example, MOX, such as AlOX or SiOX. In this formula, “M” denotes an inorganic element. From the perspective of transparency and gas barrier property, when M denotes aluminum (Al), the value of X may be 0.5 or more and 2.0 or less. When M denotes silicon (Si), the value of X may be 1 or more and 2 or less.

The barrier layers 48c, 48h, and 48k may have a thickness of 1 nm or more and 1.0 μm or less, 3 nm or more and 100 nm or less, 5 nm or more and 80 nm or less, or 8 nm or more and 50 nm or less.

The barrier layers 48c, 48h, and 48k may include a plurality of layers. The plurality of layers may include a base barrier layer formed by a chemical vapor deposition (CVD) method or a physical vapor deposition (PVD) method. The base barrier layer may contain a metal or an inorganic oxide. The base barrier layer may be a vapor-deposited layer. The base barrier layer may be a clear vapor-deposited layer or a transparent vapor-deposited layer. The vapor-deposited layer is a layer formed by vapor deposition. The vapor-deposited layer may contain a metal or an inorganic oxide.

The barrier layers 48c, 48h, and 48k may include a base barrier layer and an over layer in this order from the film substrate for barrier layers 48d, 48i, and 48l side. The barrier layers 48c, 48h, and 48k may include a first base barrier layer, an over layer, and a second base barrier layer in this order from the film substrate for barrier layers 48d, 48i, and 48l side. The barrier layers 48c, 48h, and 48k may include a first base barrier layer, a first over layer, a second base barrier layer, and a second over layer in this order from the film substrate for barrier layers 48d, 48i, and 48l side.

The base barrier layer and the first base barrier layer may be directly formed on one surface of the film substrate for barrier layers 48d, 48i, and 48l by a chemical vapor deposition (CVD) method, a physical vapor deposition (PVD) method, or the like. The base barrier layer and the first base barrier layer may be in contact with the film substrate for barrier layers 48d, 48i, and 48l. The second base barrier layer may be directly formed on the first over layer. The second base barrier layer may be in contact with the first over layer.

The over layer, the first over layer, and the second over layer cover and protect any barrier layer. The over layer, the first over layer, and the second over layer may cover the entire barrier layer to be protected. The over layer and the first over layer may be directly formed on the first base barrier layer. The over layer and the first over layer may be in contact with the first base barrier layer. The second over layer may be directly formed on the second base barrier layer. The second over layer may be in contact with the second base barrier layer.

The over layer, the first over layer, and the second over layer may be coating films (coating layers). The over layer, the first over layer, and the second over layer may be a coating film of a resin composition. The over layer, the first over layer, and the second over layer may be formed by solidifying or curing a coating film applied to the barrier layer to be protected.

The over layer, the first over layer, and the second over layer may contain a cured product of a curable resin composition. The curable resin composition may be a two-component curable resin composition, a thermosetting resin composition, or an ionizing radiation curable resin composition. The ionizing radiation curable resin composition may be an electron beam curable resin composition or an ultraviolet curable resin composition. The over layer, the first over layer, and the second over layer may contain the same resin material as a resin material constituting the adhesive layers 48e and 48g.

The over layer, the first over layer, and the second over layer may contain the same resin material as a resin material constituting the resin layers 48f and 48j. They may contain the same resin material as a resin material described later constituting the film substrate for barrier layers 48d, 48i, and 48l.

A material constituting the over layer, the first over layer, and the second over layer may contain an alkoxide. An alkoxide represented by nM(OR2)m can be at least one of a partial hydrolysate of an alkoxide and a hydrolytic condensate of an alkoxide. The partial hydrolysate of the alkoxide is not limited to a partial hydrolysate in which all the alkoxy groups are hydrolyzed, and may be a partial hydrolysate in which one or more alkoxy groups are hydrolyzed, or a mixture thereof, and the hydrolytic condensate may be a dimer or higher oligomer, more specifically, a dimer to hexamer, of a partially hydrolyzed alkoxide.

The over layer, the first over layer, and the second over layer may be formed using a coating agent including a polyvinyl alcohol based resin and a silane compound. An acid catalyst, an alkaline catalyst, a photopolymerization initiator, or the like may be added to the coating agent as necessary.

The barrier layers 48c, 48h, and 48k including a plurality of layers may have a thickness of 20 nm or more and 20 μm or less, 10 nm or more and 10 μm or less, 50 nm or more and 5.0 μm or less, or 100 nm or more and 1.0 μm or less.

The base barrier layer, the first base barrier layer, and the second base barrier layer may have a thickness of 1 nm or more and 1000 nm or less, 3 nm or more and 500 nm or less, 5 nm or more and 500 nm or less, 5 nm or more and 300 nm or less, 8 nm or more and 100 nm or less, or 8 nm or more and 50 nm or less. The over layer, the first over layer, and the second over layer may have a thickness of 10 nm or more and 10 μm or less, 50 nm or more and 5.0 μm or less, 100 nm or more and 1.0 μm or less, or 100 nm or more and less than 1.0 μm.

The first barrier layer 48c, the second barrier layer 48h, and the third barrier layer 48k may have the same configuration. The first barrier layer 48c, the second barrier layer 48h, and the third barrier layer 48k may have different configurations. The first barrier layer 48c, the second barrier layer 48h, and the third barrier layer 48k may have different materials. The first barrier layer 48c, the second barrier layer 48h, and the third barrier layer 48k may be formed by different film-forming methods. The first barrier layer 48c, the second barrier layer 48h, and the third barrier layer 48k may have different thicknesses.

The film substrate for barrier layers 48d, 48i, and 48l serve as substrates when the barrier layers 48c, 48h, and 48k are formed as vapor-deposited layers. The film substrate for barrier layers 48d, 48i, and 48l are not particularly limited. The film substrate for barrier layers 48d, 48i, and 48l may be resin films. A resin material constituting the film substrate for barrier layers 48d, 48i, and 48l as resin films is, for example, a polyolefin, such as polyethylene or polypropylene, a cyclic polyolefin, polystyrene, an acrylonitrile-styrene copolymer (AS), an acrylonitrile-butadiene-styrene copolymer (ABS), a (meth)acrylic resin, a polycarbonate, poly(vinyl alcohol), a saponified ethylene-vinyl ester copolymer, a polyester, such as poly(ethylene terephthalate) or poly(ethylene naphthalate), a polyamide, such as nylon, a polyurethane, an acetal resin, or a cellulose resin. The film substrate for barrier layers 48d, 48i, and 48l may be a laminated film including two or more films of these resin materials. The term “(meth)acrylic” includes both “acrylic” and “methacrylic”.

The film substrate for barrier layers 48d, 48i, and 48l preferably have a high water vapor barrier property, a high gas barrier property, and a high oxygen barrier property. A material of the film substrate for barrier layers 48d, 48i, and 48l can preferably reduce the amount of deformation, such as shrinkage, during vapor deposition. From these perspectives, the film substrate for barrier layers 48d, 48i, and 48l may contain poly(ethylene terephthalate), may contain poly(ethylene terephthalate) as a main component, or may be a poly(ethylene terephthalate) film.

The film substrate for barrier layers 48d, 48i, and 48l may be an unstretched film, a uniaxially stretched film, or a biaxially stretched film. The term “unstretched film” includes not only a film that is not stretched at all but also a film that is slightly stretched due to a tension applied during film formation.

The film substrate for barrier layers 48d, 48i, and 48l may have a thickness of 6 μm or more and 2000 μm or less or 9 μm or more and 100 μm or less.

The first film substrate for barrier layer 48d, the second film substrate for barrier layer 48i, and the third film substrate for barrier layer 48l may have the same configuration. The first film substrate for barrier layer 48d, the second film substrate for barrier layer 48i, and the third film substrate for barrier layer 48l may have different configurations. The first film substrate for barrier layer 48d, the second film substrate for barrier layer 48i, and the third film substrate for barrier layer 48l may contain different materials. The first film substrate for barrier layer 48d, the second film substrate for barrier layer 48i, and the third film substrate for barrier layer 48l may have different thicknesses.

The resin layers 48f and 48j serve to hold the layers included in the laminate 47. The resin layers 48f and 48j are located between the three barrier layers 48c, 48h, and 48k. The resin layers 48f and 48j located between the two barrier layers 48c, 48h, and 48k can effectively suppress curvature of the two barrier layers 48c, 48h, and 48k at a small radius of curvature. This can suppress the occurrence of a defect, such as a crack, in the two barrier layers 48c, 48h, and 48k. Furthermore, the flexibility and resilience of the laminate 47 can be easily adjusted by the resin layers 48f and 48j. Furthermore, as described above, the resin layers 48f and 48j can reduce the cloudiness of the laminate 47 due to bubbles generated when the adhesive layer is cured.

The resin layers 48f and 48j are not particularly limited. The resin layers 48f and 48j may be resin films. A resin material constituting the resin layers 48f and 48j as resin films is, for example, a polyester (chemically recycled polyester, mechanically recycled polyester, fossil fuel polyester, or biomass polyester), a (meth)acrylic resin, a polyolefin, such as polyethylene, polypropylene, or polymethylpentene, a vinyl resin, a cellulose resin, an ionomer resin, or a polyamide, such as nylon 6, nylon 6,6, or poly(m-xylylene adipamide) (MXD6). The resin layers 48f and 48j may be a laminated film including two or more films of these resin materials.

The resin layers 48f and 48j may be an unstretched film or a stretched film. The resin layers 48f and 48j may be a uniaxially stretched film or a biaxially stretched film. The resin layers 48f and 48j, which are stretched films, can impart sufficient mechanical characteristics to the laminate 47.

The resin layers 48f and 48j may contain a thermoplastic resin. The resin layers 48f and 48j may contain a thermoplastic resin as a main component. The resin layers 48f and 48j may be thermoplastic resin films. The resin layers 48f and 48j containing a thermoplastic resin can promote the discharge of bubbles to impart a low transmission haze and a high total light transmittance.

The resin layers 48f and 48j may have a thickness of 5 μm or more and 60 μm or less or 7 μm or more and 30 μm or less. Setting the lower limit of the thickness of the resin layer 48f can impart sufficient mechanical characteristics to the laminate 47 as a resin substrate of the entire laminate 47. Setting an upper limit to the thickness of the resin layer 48f can impart appropriate flexibility to the laminate 47 applied to the second container 40. Setting an upper limit to the thickness of the resin layer 48f can promote discharge of bubbles and impart a low transmission haze and a high total light transmittance.

The resin layer 48f and the second resin layer 48j may have the same configuration. The resin layer 48f and the second resin layer 48j may have different configurations. The resin layer 48f and the second resin layer 48j may contain different materials. The resin layer 48f and the second resin layer 48j may have different thicknesses.

The adhesive layers 48e and 48g are layers for bonding two layers. The adhesive layers 48e and 48g may contain a cured product of a curable resin composition. The curable resin composition may be a two-component curable resin composition, a thermosetting resin composition, or an ionizing radiation curable resin composition. The ionizing radiation curable resin composition may be an electron beam curable resin composition or an ultraviolet curable resin composition. An adhesive agent used for the adhesive layers 48e and 48g may be a one-component or two-component curable adhesive agent for lamination, such as a vinyl-based, (meth)acrylic-based, polyamide-based, polyester-based, polyether-based, polyurethane-based, epoxy-based, or rubber-based. Specific examples of a material used for the adhesive layers 48e and 48g may include a two-component curable polyurethane adhesive agent using an isocyanate compound or the like as a curing agent, and a polyester adhesive agent.

The adhesive layers 48e and 48g may have a thickness of 0.1 μm or more and 20 μm or less, 0.1 μm or more and 10 μm or less, 0.1 μm or more and 4.0 μm or less, 0.1 μm or more and 3.0 μm or less, 0.5 μm or more and 3.0 μm or less, 1.0 μm or more and 2.5 μm or less, or 1.0 μm or more and 2.0 μm or less.

The first adhesive layer 48e, the second adhesive layer 48g, the third adhesive layer, and the fourth adhesive layer may have the same configuration. The first adhesive layer 48e, the second adhesive layer 48g, the third adhesive layer, and the fourth adhesive layer may have different configurations. The first adhesive layer 48e, the second adhesive layer 48g, the third adhesive layer, and the fourth adhesive layer may have different materials. The first adhesive layer 48e, the second adhesive layer 48g, the third adhesive layer, and the fourth adhesive layer may have different thicknesses.

The sealant layer 48a has heat sealability. The sealant layer 48a is not particularly limited and may be a resin film. A material of the sealant layer 48a may be a thermoplastic resin. A thermoplastic resin constituting the sealant layer 48a may be a polyolefin. A thermoplastic resin constituting the sealant layer 48a is, for example, a low-density polyethylene, a medium-density polyethylene, a high-density polyethylene, a linear low-density polyethylene, an ethylene-α-olefin copolymer produced by polymerization using a metallocene catalyst, or an ethylene-propylene copolymer, such as a random or block copolymer of ethylene and propylene.

The sealant layer 48a may be formed by melt extrusion of the resin material. The sealant layer 48a may be formed on the first barrier layer 48c. In this example, the inner adhesive layer 48b may be omitted.

The sealant layer 48a may have a thickness of 10 μm or more and 300 μm or less or 20 μm or more and 100 μm or less.

The inner adhesive layer 48b joins the sealant layer 48a and the first barrier layer 48c. The inner adhesive layer 48b may have a configuration similar to that of the adhesive layers 48e and 48g. The inner adhesive layer 48b may contain a cured product of a curable resin composition. The inner adhesive layer 48b may be formed between the sealant layer 48a and the first barrier layer 48c by melt extrusion of a resin material. The resin material used in the melt extrusion may be selected from the same range as the material of the sealant layer 48a. The thickness of the inner adhesive layer 48b may be selected from the same range as the thicknesses of the adhesive layers 48e and 48g.

Results of experiments performed by the present inventors are described below.

### <Sample F1>

The laminate 47 illustrated in FIG. 12E was produced as a laminate according to a sample F1. The laminate 47 included a sealant layer 48a, an inner adhesive layer 48b, a first film substrate for barrier layer 48d, a first barrier layer 48c, a first adhesive layer 48e, a resin layer 48f, a second adhesive layer 48g, a second barrier layer 48h, and a second film substrate for barrier layer 48i in this order from the inner surface 47a to the outer surface 47b.

A barrier film A formed of an inorganic vapor-deposited layer corresponding to the first barrier layer 48c on a poly(ethylene terephthalate) film corresponding to the first film substrate for barrier layer 48d was used as the first barrier layer 48c and the first film substrate for barrier layer 48d. The barrier film A was IB-PET-PBIR available from Dai Nippon Printing Co., Ltd. The barrier film A had a thickness of 12 μm. The barrier layers 48 included in the IB-PET-PBIR as the barrier film A included a first base barrier layer, a first over layer, a second base barrier layer, and a second over layer in this order from the film substrate for barrier layer side. The first base barrier layer was a transparent vapor-deposited layer containing alumina. The second base barrier layer was a transparent vapor-deposited layer containing alumina.

The barrier film A formed of an inorganic vapor-deposited layer corresponding to the second barrier layer 48h on a poly(ethylene terephthalate) film corresponding to the second film substrate for barrier layer 48i was used as the second barrier layer 48h and the second film substrate for barrier layer 48i. That is, the second barrier layer 48h and the second film substrate for barrier layer 48i were formed of the same barrier film A as that of the first barrier layer 48c and the first film substrate for barrier layer 48d.

The resin layer 48f was Emblem ONMB-RT available from Unitika Ltd. The resin layer 48f was a biaxially stretched nylon film. The resin layer 48f had a thickness of 15 μm. The first adhesive layer 48e and the second adhesive layer 48g were formed using a thermosetting resin Rock Bond RU77T/H-7 available from Rock Paint Co., Ltd. The first adhesive layer 48e and the second adhesive layer 48g each had a thickness of 3 μm.

The sealant layer 48a was TPF-4 available from Okamoto Industries, Inc. The sealant layer 48a had a thickness of 30 μm. The inner adhesive layer 48b was a layer formed using the thermosetting resin Rock Bond RU77T/H-7 available from Rock Paint Co., Ltd. The inner adhesive layer 48b had a thickness of 3 μm.

A laminate was produced from the above materials in the following manner using a dry laminator with a gravure coating unit. First, the resin layer 48f was placed on the barrier film A constituting the first barrier layer 48c and the first film substrate for barrier layer 48d with the first adhesive layer 48e interposed therebetween. The barrier film A constituting the second barrier layer 48h and the second film substrate for barrier layer 48i was placed on the resin layer 48f of the laminate with the second adhesive layer 48g interposed therebetween. The sealant layer 48a was placed on the laminate with the inner adhesive layer 48b interposed therebetween. Thus, the laminate according to the sample F1 was produced.

### <Sample F2>

The laminate 47 illustrated in FIG. 12E was produced as a laminate according to a sample F2 in the same manner as in the laminate according to the sample F1. The laminate according to the sample F2 was different from the laminate according to the sample F1 in that a barrier film B was used in place of the barrier film A of the sample F1. In the laminate according to the sample F2, the sealant layer 48a, the inner adhesive layer 48b, the first adhesive layer 48e, the resin layer 48f, and the second adhesive layer 48g were identical to those of the laminate according to the sample F1. A method for producing the laminate according to the sample F2 was identical to the method for producing the laminate according to the sample F1 except that the barrier film was different.

In the laminate according to the sample F2, the barrier film B formed of an inorganic vapor-deposited layer corresponding to the first barrier layer 48c on a poly(ethylene terephthalate) film corresponding to the first film substrate for barrier layer 48d was used as the first barrier layer 48c and the first film substrate for barrier layer 48d. The barrier film B was IB-PET-PXB2 available from Dai Nippon Printing Co., Ltd. The barrier film B had a thickness of 12 μm. The barrier layer included in the IB-PET-PXB2 as the barrier film B included a first base barrier layer, a first over layer, a second base barrier layer, and a second over layer in this order from the film substrate for barrier layer side. The first base barrier layer was a transparent vapor-deposited layer containing alumina. The second base barrier layer was a transparent vapor-deposited layer containing alumina.

In the laminate according to the sample F2, the barrier film B formed of an inorganic vapor-deposited layer corresponding to the second barrier layer 48h on a poly(ethylene terephthalate) film corresponding to the second film substrate for barrier layer 48i was used as the second barrier layer 48h and the second film substrate for barrier layer 48i. That is, the second barrier layer 48h and the second film substrate for barrier layer 48i were IB-PET-PXB2 in the same manner as the first barrier layer 48c and the first film substrate for barrier layer 48d.

### <Sample F3>

The laminate 47 illustrated in FIG. 12E was produced as a laminate according to a sample F3 in the same manner as the laminate according to the sample F1. The laminate according to the sample F3 was different from the sample F1 in terms of the resin film used for the sealant layer 48a and was identical to the sample F1 in other respects.

In the laminate according to the sample F3, the sealant layer 48a was CF7601A available from Toray Advanced Film Co., Ltd. The sealant layer 48a had a thickness of 30 μm.

A method for producing the laminate according to the sample F3 was identical to the method for producing the laminate according to the sample F3 except that the resin film used for the sealant layer was different.

### <Sample F4>

The laminate 47 illustrated in FIG. 12E was produced as a laminate according to a sample F4 in the same manner as the laminate according to the sample F1. The laminate according to the sample F4 was different from the sample F1 in terms of the resin film used for the resin layer 48f and was identical to the sample F1 in other respects.

In the laminate according to the sample F4, the resin layer 48f was E5102 available from Toyobo Co., Ltd. The resin layer 48f was a biaxially stretched poly(ethylene terephthalate) film. The resin layer 48f had a thickness of 16 μm.

A method for producing the laminate according to the sample F4 was identical to the method for producing the laminate according to the sample F1 except that the resin film used for the resin layer was different.

### <Evaluation F1 (Oxygen Permeation Rate)>

The oxygen permeation rates (mL/(m²×day×atm)) of the laminates according to the samples F1 to F4 and the samples F5 and F6 described later were measured. The oxygen permeation rates were measured in an environment with a temperature of 23° C. and a relative humidity of 40% using the permeability measuring instrument OXTRAN (2/21) manufactured by MOCON, Inc., U.S.A. The results are shown in the column of “Evaluation F1” in Tables 5 and 6.

### <Evaluation F2 (Water Vapor Permeation Rate)>

The water vapor permeation rates (g/(m²×day)) of the laminates according to the samples F1 to F4 were measured. The water vapor permeation rates were determined by measuring the change in weight of a container containing calcium chloride as described below. First, the laminates according to the samples F1 to F4 were used to produce test containers with a four-sided seal portion illustrated in FIG. 4A. The internal space of the test container had a 10 cm×10 cm quadrangular shape in a plan view in a state where the container was flatly unfolded. The test container had an inner surface area of 200 cm². The test container contained 50 g of calcium chloride. Immediately after the test container was closed, the test container was stored in a test environment with a temperature of 40° C. and a relative humidity of 90% for 14 days. The weight increase of the test container due to placement in the test environment was measured as the water vapor permeation amount (g) per 200 cm² of the laminate. The water vapor permeation rates (g/(m²·day)) of the laminates according to the samples F1 to F4 were determined from the measurement results. The results are shown in the column of “Evaluation F2” in Table 5.

### <Evaluation F3 (Transmission Haze)>

5 cm×10 cm samples were cut out from the laminates according to the samples F1 to F4. It was visually confirmed that the samples had no abnormality, such as dust or scratches. The transmission haze of the laminate according to each example was measured by the above method. The incident surface for the measurement was the inner surface 47a. A haze meter “HM-150” manufactured by Murakami Color Research Laboratory was used for the measurement of the transmission haze. The measurement results of the transmission haze are shown in the column of “Evaluation F3” in Table 5.

### <Evaluation F4 (Presence or Absence of Bubbles)>

The presence or absence of bubbles in the laminates according to the samples F1 to F4 was examined. The laminates were observed with the naked eye without using a microscope or the like. The evaluation criteria were as described below. The evaluation results are shown in the column of “Evaluation F4” in Table 5.

A: Acceptable because although fine bubbles were observed with a microscope, bubbles were not observed with the naked eye at a distance of 30 cm from the laminates.
B: Unacceptable because bubbles were observed with the naked eye at a distance of 30 cm from the laminates.

TABLE 5
Evaluation results

| | Sample | Sample | Sample | Sample |
|---|---|---|---|---|
| | F1 | F 2 | F 3 | F 4 |
| Evaluation F1: oxygen | 0.14 | 0.04 | 0.14 | 0.04 |
| permeation rate (mL/ | | | | |
| (m² × day × atm)) | | | | |
| Evaluation F2: water | 0.04 | 0.02 | 0.04 | 0.02 |
| vapor permeation rate | | | | |
| (g/(m² × day)) | | | | |
| Evaluation F3: | 11.7 | 12.9 | 56.2 | 12.1 |
| transmission haze (%) | | | | |
| Evaluation F4: bubbles | A | A | A | A |

The following evaluation was further performed with respect to the appearance.

### <Sample F5>

A laminate according to a sample F5 was produced by removing the sealant layer 48a and the inner adhesive layer 48b from the laminate 47 illustrated in FIG. 12E. It included the first film substrate for barrier layer 48d, the first barrier layer 48c, the first adhesive layer 48e, the resin layer 48f, the second adhesive layer 48g, the second barrier layer 48h, and the second film substrate for barrier layer 48i in this order from the inner surface 47a to the outer surface 47b.

In the laminate according to the sample F5, the barrier film B formed of an inorganic vapor-deposited layer corresponding to the first barrier layer 48c on a poly(ethylene terephthalate) film corresponding to the first film substrate for barrier layer 48d was used as the first barrier layer 48c and the first film substrate for barrier layer 48d. The barrier film B was IB-PET-PXB2 available from Dai Nippon Printing Co., Ltd. The barrier film B had a thickness of 12 μm. The first barrier layer 48c was a transparent vapor-deposited layer containing alumina.

In the laminate according to the sample F5, the barrier film B formed of an inorganic vapor-deposited layer corresponding to the second barrier layer 48h on a poly(ethylene terephthalate) film corresponding to the second film substrate for barrier layer 48i was used as the second barrier layer 48h and the second film substrate for barrier layer 48i. That is, the second barrier layer 48h and the second film substrate for barrier layer 48i were IB-PET-PXB2 in the same manner as the first barrier layer 48c and the first film substrate for barrier layer 48d.

The resin layer 48f was Emblem ONMB-RT available from Unitika Ltd. The resin layer 48f was a biaxially stretched nylon film. The resin layer 48f had a thickness of 15 μm. The first adhesive layer 48e and the second adhesive layer 48g were formed using a thermosetting resin Rock Bond RU77T/H-7 available from Rock Paint Co., Ltd. The first adhesive layer 48e and the second adhesive layer 48g each had a thickness of 3 μm.

A laminate was produced from the above materials as described below. First, the resin layer 48f was placed on the barrier film B constituting the first barrier layer 48c and the first film substrate for barrier layer 48d with the first adhesive layer 48e interposed therebetween. The barrier film B constituting the second barrier layer 48h and the second film substrate for barrier layer 48i was placed on the resin layer 48f of the laminate with the second adhesive layer 48g interposed therebetween. The adhesive layer was applied with a bar coater. A pressure of approximately 10 MPa was applied to the laminate using a pressing machine to bring them into close contact with each other. It was then stored in an oven at 40° C. for 72 hours to cure the adhesive layer. Thus, the laminate according to the sample F5 was produced.

### <Sample F6>

A laminate according to a sample F6 was produced in the same manner as the laminate according to the sample F5 by removing the sealant layer 48a and the inner adhesive layer 48b from the laminate 47 illustrated in FIG. 12E. The laminate according to the sample F6 was different from the sample F5 in terms of the resin film used for the resin layer 48f and was identical to the sample F5 in other respects. In the laminate according to the sample F6, E5102 available from Toyobo Co., Ltd. was used as a resin layer instead of Emblem ONMB-RT used as a resin layer in the sample F5. The resin layer 48f was a biaxially stretched poly(ethylene terephthalate) film. The resin layer 48f had a thickness of 16 μm. A method for producing the laminate according to the sample F6 was identical to the method for producing the laminate according to the sample F5 except that the resin layer was different.

### <Evaluation F5 (Cloudiness)>

The presence or absence of cloudiness of the laminates according to the samples F5 and F6 was examined. The laminates were observed with the naked eye without using a microscope or the like. The evaluation criteria were as described below. The evaluation results are shown in the column of “Evaluation F5” in Table 6.

AA: Acceptable because no cloudiness was observed.
A: Acceptable because although cloudiness was observed, the cloudiness was slight.
B: Unacceptable because cloudiness was observed.

### <Evaluation F6 (Puncture Resistance)>

The puncture resistance is measured in accordance with the puncture strength test of JIS Z 1707: 2019. A test specimen was fixed with a jig, and the outer surface thereof (the surface constituted by the second film substrate for barrier layer) was pierced with a semicircular needle with a diameter of 1.0 mm and a tip shape radius of 0.5 mm at a test speed of 50±5 mm/min to measure the maximum force (N) until the needle penetrated. Since there was no sealant in the target samples F5 and F6, the puncture resistance in the outer surface 47b direction was evaluated. The maximum force (N) as the evaluation result was the arithmetic mean of measured values at five positions. The evaluation results are shown in the column of “Evaluation F6” in Table 6.

TABLE 6
Evaluation results

| | Sample F5 | Sample F6 |
|---|---|---|
| Evaluation F1: oxygen permeation rate | 0.04 | 0.04 |
| (mL/(m² × day × atm)) | | |
| Evaluation F5: appearance (cloudiness) | A | AA |
| Evaluation F6: puncture resistance (N) | 25.6 | 23.1 |

In the samples F5 and F6, the appearance (cloudiness) was improved by disposing the resin layer between the two barrier layers. It is thought that the formation of bubbles in the samples F2 and F4 could be effectively suppressed by a phenomenon similar to the evaluation results.

The sample F5 in which the biaxially stretched nylon film was used as the resin layer had high puncture resistance.

The sample F6, in which the biaxially stretched poly(ethylene terephthalate) film was used as the resin layer, was able to more effectively suppress cloudiness. Due to the good results of the appearance (cloudiness) of the sample F6, the production speed could be further increased during the production of the sample F4.

Although the embodiments have been described with reference to specific examples, the specific examples do not limit the embodiments. The embodiments can be implemented in various other specific examples, and various omissions, substitutions, changes, additions, and the like can be made without departing from the gist of the embodiments.

The first container 30 may include a label 37 (see FIG. 1A). The label 37 may display information related to the liquid medicine L. The label 37 may be affixed to the container body 32. The label 37 may not extend over the entire perimeter to allow the inside of the container body 32 to be observed. The label 37 may face the second container 40 to allow observation of the description on the label 37. In the case that the first container 30 is a vial, the container body 32 may be exposed by 10 mm or more, preferably 20 mm or more, between the label 37 and the stopper 34 and the fixture 36. The liquid medicine L in the first container 30 can be observed through the transparent container body 32. The amount of oxygen in the first container 30 can be measured by light irradiation through the transparent container body 32. In this case, in addition to the neck portion 32c of the container body 32, the trunk portion 32b may be exposed between the label 37 and the stopper 34 and the fixture 36.

To maintain the relative position between the oxygen absorber 22 or the oxygen-absorbing member 20 and the oxygen-permeable portion of the first container 30, the oxygen absorber 22 or the oxygen-absorbing member 20 may be fixed to the first container 30 by heat sealing or using a bonding material. The oxygen absorber 22 or the oxygen-absorbing member 20 may be fixed to a portion other than the oxygen-permeable portion of the first container 30. When the oxygen-absorbing member 20 is fixed to the stopper 34, the oxygen-absorbing member 20 may be fixed to a portion of the stopper 34. The oxygen-absorbing member 20 may be fixed to the fixture 36 to secure a gap between the oxygen-absorbing member 20 and the stopper 34. These configurations can maintain an appropriate relative positional relationship between the oxygen absorber 22 or the oxygen-absorbing member 20 and the oxygen-permeable portion of the first container 30 and stably promote the movement of oxygen from the inside to the outside of the first container 30.

In the examples illustrated in FIGS. 4D and 4F, the container body 32 and the fixture 36 have an oxygen barrier property, and the stopper 34 has oxygen permeability. In the examples indicated by the dash-dot-dot line in FIGS. 4D and 4F, the oxygen-absorbing member 20 with the oxygen absorber 22 is disposed to face the stopper 34 with oxygen permeability. The oxygen-absorbing member 20 with the oxygen absorber 22 may be in contact with the stopper 34 with oxygen permeability. The oxygen-absorbing member 20 with the oxygen absorber 22 may be in contact with only a portion of the stopper 34 with oxygen permeability. The oxygen-absorbing member 20 with the oxygen absorber 22 may be disposed with a gap from the stopper 34 with oxygen permeability. In the oxygen absorber 22 and the oxygen-absorbing member 20 indicated by the dash-dot-dot line in FIGS. 4D and 4F, the movement of oxygen from the inside to the outside of the first container 30 can be promoted. Furthermore, the second container 40 with flexibility and an oxygen barrier property can suppress the contact between the first container 30 and the stopper 34 with oxygen permeability.

### EXAMPLES

Although the above embodiments are described in more detail in the following examples, the embodiments are not limited to these examples.

In Examples 1 to 8, a combined container containing water was produced using the first container illustrated in FIG. 1C. In Examples 1 to 8, the rubber stopper of the first container was a rubber of a compound with a main backbone of a siloxane bond. Different permeabilities were imparted to the rubber stoppers used in Examples 1 to 8 by changing the material composition, the polymerization conditions, the vulcanization conditions, or the like.

### Example 1

A vial with a volume of approximately 9.2 mL was prepared as a first container. The first container had the configuration illustrated in FIG. 1C. The vial serving as the first container had a container body made of glass. The first container contained approximately 1.2 mL of water. The opening portion of the container body containing water was closed with a rubber stopper. The rubber stopper was a rubber of a compound with a main backbone of a siloxane bond. An aluminum seal was fixed to the head portion of the container body using a hand clipper to prepare a first container containing water. The aluminum seal served as the fixture illustrated in FIG. 1C. That is, the aluminum seal prevented the rubber stopper from coming off from the container body. In the state after sealing with the aluminum seal, the space between the container body and the rubber stopper was air-tight. A headspace not filled with water for injection remained in the first container. The first container was closed in air. Thus, the headspace of the first container 30 contained air. The concentration of oxygen in the headspace of the first container 30 was 21.0%. The amount of dissolved oxygen in the water for injection contained in the first container was 8.84 mg/L.

The first oxygen permeability of a material constituting the stopper measured by the method described with reference to FIG. 2A was 0.0001 (cc×mm/(mm²×day)) at a temperature of 23° C. and a relative humidity of 50%. The first water vapor permeability of a material constituting the stopper measured by the method described with reference to FIG. 2B was 1 (mg×mm/(mm²×day)) at a temperature of 40° C. and a relative humidity of 90%.

The second oxygen permeability of the first container in the first state measured by the method described with reference to FIGS. 10A and 10B was 0.01 (cc/day) at a temperature of 23° C. and a relative humidity of 50%. The second oxygen permeability of the stopper of the first container measured by the method described with reference to FIG. 10A was 0.01 (cc/day) at a temperature of 23° C. and a relative humidity of 50%.

The second water vapor permeability of the first container in the first state measured by the method described with reference to FIGS. 10C and 10D was 20 (mg/day) at a temperature of 40° C. and a relative humidity of 90%. The second water vapor permeability of the stopper of the first container measured by the method described with reference to FIG. 10C was 20 (mg/day) at a temperature of 40° C. and a relative humidity of 90%.

The combined medical container illustrated in FIGS. 1A and 1B was produced using the first container containing water described above. A second container included a first film and a second film. The first film and the second film had a length of 20 cm in the first direction and a length of 11 cm in the second direction in a state of being flatly unfolded. The seal portion had a width of 10 mm. A second container 40 had an inner surface area of 280 cm². As illustrated in FIGS. 1A and 1B, the first container was stored in the second container such that the container body faced the bent first seal portion.

As illustrated in FIGS. 1A and 1B, an oxygen-absorbing member containing an oxygen absorber and an oxygen detection member were placed at positions facing the stopper of the first container. The oxygen-absorbing member was Ageless “ZH-100” available from Mitsubishi Gas Chemical Co., Inc. The oxygen-absorbing member contained a deoxidizer for absorbing 100 mL of oxygen. The oxygen detection member 28 was Ageless Eye “Eye-LS” available from Mitsubishi Gas Chemical Co., Inc.

All materials, members, and the like used in Example 1 were sterilized. Storage of water in the first container, closing of the first container, storage of the first container containing water, the oxygen-absorbing member, and the oxygen detection member in the second container, and closing of the second container were performed in an isolator in a sterile state. The use of the sterilized material and the operation in an isolator in a sterile state were the same in Comparative Examples 1 and 2 described later.

### Example 2

In a combined container containing water according to Example 2, the rubber stopper that closed the opening portion of the container body of the first container was different from the rubber stopper of the combined container containing water according to Example 1. The combined container containing water according to Example 2 had the same configuration as the combined container containing water according to Example 1 except for the rubber stopper.

In the combined container containing water according to Example 2, the first oxygen permeability of a material constituting the stopper measured by the method described with reference to FIG. 2A was 0.00075 (cc×mm/(mm²×day)) at a temperature of 23° C. and a relative humidity of 50%. The first water vapor permeability of a material constituting the stopper measured by the method described with reference to FIG. 2B was 0.25 (mg×mm/(mm²×day)) at a temperature of 40° C. and a relative humidity of 90%.

In the combined container containing water according to Example 2, the second oxygen permeability of the first container in the first state measured by the method described with reference to FIGS. 10A and 10B was 0.1 (cc/day) at a temperature of 23° C. and a relative humidity of 50%. The second oxygen permeability of the stopper of the first container measured by the method described with reference to FIG. 10A was 0.1 (cc/day) at a temperature of 23° C. and a relative humidity of 50%.

In the combined container containing water according to Example 2, the second water vapor permeability of the first container in the first state measured by the method described with reference to FIGS. 10C and 10D was 15 (mg/day) at a temperature of 40° C. and a relative humidity of 90%. The second water vapor permeability of the stopper of the first container measured by the method described with reference to FIG. 10C was 15 (mg/day) at a temperature of 40° C. and a relative humidity of 90%.

### Example 3

In a combined container containing water according to Example 3, the rubber stopper that closes the opening portion of the container body of the first container was different from the rubber stopper of the combined container containing water according to Example 1. The combined container containing water according to Example 3 had the same configuration as the combined container containing water according to Example 1 except for the rubber stopper.

In the combined container containing water according to Example 3, the first oxygen permeability of a material constituting the stopper measured by the method described with reference to FIG. 2A was 0.0823 (cc×mm/(mm²×day)) at a temperature of 23° C. and a relative humidity of 50%. The first water vapor permeability of a material constituting the stopper measured by the method described with reference to FIG. 2B was 0.105 (mg×mm/(mm^{z}×day)) at a temperature of 40° C. and a relative humidity of 90%.

In the combined container containing water according to Example 3, the second water vapor permeability of the first container in the first state measured by the method described with reference to FIGS. 10C and 10D was 4.59 (mg/day) at a temperature of 40° C. and a relative humidity of 90%. The second water vapor permeability of the stopper of the first container measured by the method described with reference to FIG. 10C was 4.59 (mg/day) at a temperature of 40° C. and a relative humidity of 90%.

### Example 4

In the combined container containing water according to Example 4, the rubber stopper that closes the opening portion of the container body of the first container was different from the rubber stopper of the combined container containing water according to Example 1. The combined container containing water according to Example 4 had the same configuration as the combined container containing water according to Example 1 except for the rubber stopper.

In the combined container containing water according to Example 4, the first oxygen permeability of a material constituting the stopper measured by the method described with reference to FIG. 2A was 0.0871 (cc×mm/(mm²×day)) at a temperature of 23° C. and a relative humidity of 50%. The first water vapor permeability of a material constituting the stopper measured by the method described with reference to FIG. 2B was 0.127 (mg×mm/(mm²×day)) at a temperature of 40° C. and a relative humidity of 90%.

In the combined container containing water according to Example 4, the second oxygen permeability of the first container in the first state measured by the method described with reference to FIGS. 10A and 10B was 1.95 (cc/day) at a temperature of 23° C. and a relative humidity of 50%. The second oxygen permeability of the stopper of the first container measured by the method described with reference to FIG. 10A was 1.95 (cc/day) at a temperature of 23° C. and a relative humidity of 50%.

In the combined container containing water according to Example 4, the second water vapor permeability of the first container in the first state measured by the method described with reference to FIGS. 10C and 10D was 6.23 (mg/day) at a temperature of 40° C. and a relative humidity of 90%. The second water vapor permeability of the stopper of the first container measured by the method described with reference to FIG. 10C was 6.23 (mg/day) at a temperature of 40° C. and a relative humidity of 90%.

### Example 5

In a combined container containing water according to Example 5, the rubber stopper that closes the opening portion of the container body of the first container was different from the rubber stopper of the combined container containing water according to Example 1. The combined container containing water according to Example 5 had the same configuration as the combined container containing water according to Example 1 except for the rubber stopper.

In the combined container containing water according to Example 5, the first oxygen permeability of a material constituting the stopper measured by the method described with reference to FIG. 2A was 0.0755 (cc×mm/(mm²×day)) at a temperature of 23° C. and a relative humidity of 50%. The first water vapor permeability of a material constituting the stopper measured by the method described with reference to FIG. 2B was 0.089 (mg×mm/(mm²×day)) at a temperature of 40° C. and a relative humidity of 90%.

In the combined container containing water according to Example 5, the second oxygen permeability of the first container in the first state measured by the method described with reference to FIGS. 10A and 10B was 1.68 (cc/day) at a temperature of 23° C. and a relative humidity of 50%. The second oxygen permeability of the stopper of the first container measured by the method described with reference to FIG. 10A was 1.68 (cc/day) at a temperature of 23° C. and a relative humidity of 50%.

In the combined container containing water according to Example 5, the second water vapor permeability of the first container in the first state measured by the method described with reference to FIGS. 10C and 10D was 3.91 (mg/day) at a temperature of 40° C. and a relative humidity of 90%. The second water vapor permeability of the stopper of the first container measured by the method described with reference to FIG. 10C was 3.91 (mg/day) at a temperature of 40° C. and a relative humidity of 90%.

### Example 6

In a combined container containing water according to Example 6, the rubber stopper that closes the opening portion of the container body of the first container was different from the rubber stopper of the combined container containing water according to Example 1. The combined container containing water according to Example 6 had the same configuration as the combined container containing water according to Example 1 except for the rubber stopper.

In the combined container containing water according to Example 6, the first oxygen permeability of a material constituting the stopper measured by the method described with reference to FIG. 2A was 0.0569 (cc×mm/(mm²×day)) at a temperature of 23° C. and a relative humidity of 50%. The first water vapor permeability of a material constituting the stopper measured by the method described with reference to FIG. 2B was 0.083 (mg×mm/(mm²×day)) at a temperature of 40° C. and a relative humidity of 90%.

In the combined container containing water according to Example 6, the second oxygen permeability of the first container in the first state measured by the method described with reference to FIGS. 10A and 10B was 0.72 (cc/day) at a temperature of 23° C. and a relative humidity of 50%. The second oxygen permeability of the stopper of the first container measured by the method described with reference to FIG. 10A was 0.72 (cc/day) at a temperature of 23° C. and a relative humidity of 50%.

In the combined container containing water according to Example 5, the second water vapor permeability of the first container in the first state measured by the method described with reference to FIGS. 10C and 10D was 2.60 (mg/day) at a temperature of 40° C. and a relative humidity of 90%. The second water vapor permeability of the stopper of the first container measured by the method described with reference to FIG. 10C was 2.60 (mg/day) at a temperature of 40° C. and a relative humidity of 90%.

### Example 7

In a combined container containing water according to Example 7, the rubber stopper that closes the opening portion of the container body of the first container was different from the rubber stopper of the combined container containing water according to Example 1. The combined container containing water according to Example 7 had the same configuration as the combined container containing water according to Example 1 except for the rubber stopper.

In the combined container containing water according to Example 7, the first oxygen permeability of a material constituting the stopper measured by the method described with reference to FIG. 2A was 0.0274 (cc×mm/(mm²×day)) at a temperature of 23° C. and a relative humidity of 50%. The first water vapor permeability of a material constituting the stopper measured by the method described with reference to FIG. 2B was 0.062 (mg×mm/(mm²×day)) at a temperature of 40° C. and a relative humidity of 90%.

In the combined container containing water according to Example 7, the second oxygen permeability of the first container in the first state measured by the method described with reference to FIGS. 10A and 10B was 0.48 (cc/day) at a temperature of 23° C. and a relative humidity of 50%. The second oxygen permeability of the stopper of the first container measured by the method described with reference to FIG. 10A was 0.48 (cc/day) at a temperature of 23° C. and a relative humidity of 50%.

In the combined container containing water according to Example 7, the second water vapor permeability of the first container in the first state measured by the method described with reference to FIGS. 10C and 10D was 2.72 (mg/day) at a temperature of 40° C. and a relative humidity of 90%. The second water vapor permeability of the stopper of the first container measured by the method described with reference to FIG. 10C was 2.72 (mg/day) at a temperature of 40° C. and a relative humidity of 90%.

### Example 8

In a combined container containing water according to Example 8, the rubber stopper that closes the opening portion of the container body of the first container was different from the rubber stopper of the combined container containing water according to Example 1. The combined container containing water according to Example 8 had the same configuration as the combined container containing water according to Example 1 except for the rubber stopper

In the combined container containing water according to Example 8, the first oxygen permeability of a material constituting the stopper measured by the method described with reference to FIG. 2A was 0.1551 (cc×mm/(mm²×day)) at a temperature of 23° C. and a relative humidity of 50%. The first water vapor permeability of a material constituting the stopper measured by the method described with reference to FIG. 2B was 0.411 (mg×mm/(mm²×day)) at a temperature of 40° C. and a relative humidity of 90%.

In the combined container containing water according to Example 8, the second oxygen permeability of the first container in the first state measured by the method described with reference to FIGS. 10A and 10B was 2.72 (cc/day) at a temperature of 23° C. and a relative humidity of 50%. The second oxygen permeability of the stopper of the first container measured by the method described with reference to FIG. 10A was 2.72 (cc/day) at a temperature of 23° C. and a relative humidity of 50%.

In the combined container containing water according to Example 8, the second water vapor permeability of the first container in the first state measured by the method described with reference to FIGS. 10C and 10D was 18.0 (mg/day) at a temperature of 40° C. and a relative humidity of 90%. The second water vapor permeability of the stopper of the first container measured by the method described with reference to FIG. 10C was 18.0 (mg/day) at a temperature of 40° C. and a relative humidity of 90%.

### Comparative Example 1

A first container containing water was produced in the same manner as in Example 1. This first container containing water was used in Comparative Example 1. That is, in Comparative Example 1, the second container, the oxygen-absorbing member, and the oxygen detection member were omitted. The rubber stopper of the first container was the same rubber stopper as the rubber stopper used in Example 1.

### Comparative Example 2

In Comparative Example 2, the rubber stopper that closed the opening portion of the container body of the first container was composed of butyl rubber. The combined container containing water according to Comparative Example 2 was different from the combined container containing water according to Example 1 in this point and was otherwise the same as the combined container containing water according to Example 1. The butyl rubber constituting the rubber stopper in Comparative Example 2 had a first oxygen permeability of less than 0.000001 (cc×mm/(mm²×day)). The first container in Comparative Example 2 had a second oxygen permeability of less than 0.0001 (cc/day).

### <Evaluation 1>

In Examples 1 to 8 and Comparative Example 2, after the second container was closed, the combined container containing water was stored for 14 days. In Comparative Example 1, after the first container was closed, the first container containing water was stored for 14 days. Examples 1 to 8 and Comparative Examples 1 and 2 were stored in an air atmosphere with a temperature of 20° C. and a relative humidity of 50% at atmospheric pressure. After 14 days, the amount of dissolved oxygen (mg/L) in water and the concentration of oxygen (%) in the first container were measured. The amount of dissolved oxygen (mg/L) in water and the concentration of oxygen (%) in the first container were measured with a nondestructive, non-contact, and high-sensitivity oxygen meter OXY-1 SMA trace manufactured by PreSens, Germany. The oxygen meter OXY-1 SMA trace was used to measure the amount of dissolved oxygen (mg/L) in water in the first container and the concentration of oxygen (%) in the first container from the outside of the container without breaking the container. Table 7 shows the measured values of the amount of dissolved oxygen (mg/L) in water and the concentration of oxygen (%) in the first container after 14 days. The detection limit of the oxygen concentration by the oxygen meter OXY-1 SMA trace was 0.03%. The detection limit of the amount of dissolved oxygen by the oxygen meter OXY-1 SMA trace was 0.015 mg/L.

### <Evaluation 2>

The water vapor permeability of the first container was evaluated in accordance with “7.02 Test Methods for Plastic Containers” of “7. Tests for Containers and Packing Materials” specified in “The Japanese Pharmacopoeia 18th edition, General Notices, General Tests”. In the test method, the method specified in “1.5.1 Method 1” was adopted to measure the mass change of water. More specifically, the following measurement was performed to evaluate the water vapor permeability of the first container.

After storage for 14 days, the mass of the first container containing water was measured as a mass A. In Examples 1 to 8 and Comparative Example 2, the second container was opened to measure the mass of the first container containing water taken out from the second container. In Examples 1 to 8 and Comparative Example 2, the mass of the first container containing water was measured as a mass B immediately before the second container was closed. In Comparative Example 1, the mass of the first container containing water was measured as a mass B immediately after the first container was closed. Furthermore, the mass of the first container before storing water was measured as a mass C. The rate of change (%) of water in the first container after 14 days was determined using the following formula.

$$Rate of change ( \% ) = ( \vert mass A - mass B \vert / ( mass B - mass C ) ) \times 100$$

The rate of change was evaluated as described below on the basis of 0.20% specified in “2.1 Polyethylene or polypropylene containers for aqueous injections (3) Water vapor permeability” of “7. Tests for Containers and Packing Materials” in “The Japanese Pharmacopoeia 18th edition, General Notices, General Tests”. The evaluation results are shown in the column of “Water vapor permeability” in Table 7.

AA: Acceptable because the rate of change was 0.15% or less.
A: Acceptable because the rate of change was more than 0.15% and 0.20% or less.
B: Unacceptable because the rate of change was more than 0.20%.

TABLE 7
Evaluation results

| | | | Second oxygen | Second water vapor | Evaluation 1: | Evaluation 1: | |
|---|---|---|---|---|---|---|---|
| | | | permeability | permeability | concentration | amount of | |
| | First oxygen | First water vapor | in first state | in first state | of oxygen | dissolved | |
| | permeability | permeability | in first | in first | in first | oxygen in | Evaluation 2: |
| | (cc × mm/ | (cc × mm/ | container | container | container | water | water vapor |
| | (mm² × day)) | (mm² × day)) | (cc/day) | (mg/day) | (%) | (mg/L) | permeability |
| Eexample 1 | 0.0001 | 1 | 0.01 | 20 | undetected | undetected | A |
| Eexample 2 | 0.00075 | 0.25 | 0.1 | 15 | undetected | undetected | AA |
| Eexample 3 | 0.0823 | 0.105 | 1.86 | 4.59 | undetected | undetected | AA |
| Eexample 4 | 0.0871 | 0.127 | 1.95 | 6.23 | undetected | undetected | AA |
| Eexample 5 | 0.0755 | 0.089 | 1.68 | 3.91 | undetected | undetected | AA |
| Eexample 6 | 0.0569 | 0.083 | 0.72 | 2.60 | undetected | undetected | AA |
| Eexample 7 | 0.0274 | 0.062 | 0.48 | 2.72 | undetected | undetected | AA |
| Eexample 8 | 0.1551 | 0.411 | 2.72 | 18.0 | undetected | undetected | AA |
| Comparative | 0.0001 | 1 | 0.01 | 20 | 20.83 | 8.56 | — |
| example 1 | | | | | | | |
| Comparative | below detection | below detection | below detection | below detection | 21.02 | 8.48 | AA |
| example 2 | limit | limit | limit | limit | | | |

### REFERENCE SIGNS LIST

D1 first direction
D2 second direction
D3 third direction
L liquid medicine
HS headspace
L30 length
S storage space
10 combined medical container
10L combined medical container containing liquid medicine
15 medical container set
20 oxygen-absorbing member
21 oxygen-absorbing film
22 oxygen absorber
23 package
25 base material
28 oxygen detection member
28a display portion
30 first container
30X test sheet
30Y test sheet
30L first container containing liquid medicine
32 container body
33 opening portion
34 stopper
34a plate-like portion
34b insertion protrusion
34c tubular portion
34d insertion closing portion
34e through-hole
34f recessed portion
34g to-be-punctured portion
35 second stopper
36 fixture
37 label
29 cover
38 stopper holder
38a outside screw
39 stopper member
40 second container
40a opening portion
41a first film
41b second film
41bx bent top portion
41x folded-back portion
42 container body
44 lid
46 laminate
47 laminate
47a inner surface
47b outer surface
48a sealant layer
48b inner adhesive layer
48c first barrier layer
48d first film substrate for barrier layer
48e first adhesive layer
48f resin layer
48g second adhesive layer
48h second barrier layer
48i second film substrate for barrier layer
48j second resin layer
48k third barrier layer
481 third film substrate for barrier layer
49 seal portion
49a first seal portion
49b first side seal portion
49c second side seal portion
49d second seal portion
49X main seal portion
49Y auxiliary seal portion
49Ya first auxiliary seal portion
49Yb second auxiliary seal portion
50a main portion
50b extension portion
55 outer case
56 bottom portion
57 top portion
58 side wall portion
60 syringe
61 fixing component
62 cylinder
63 cylinder body
63a protruding tip
63b cylinder holder
63c inside screw
64 needle
65 holding tube portion
66 piston
67 piston body
68 gasket
69 cap
70 test container
71 partition wall portion
71A first flow path
71B second flow path
72 main wall portion
72A through-hole
73 barrier bonding material
74 oxygen meter
75 test chamber
75A supply path
75B discharge path
76 test container
76X test storage portion
76XA opening portion
77 test container
78 test storage portion
78A opening portion
79 calcium chloride

1. A combined medical container containing a liquid medicine, comprising:
a first container containing the liquid medicine;
a second container storing the first container and having an oxygen barrier property; and
an oxygen absorber for absorbing oxygen in the second container,
wherein the first container includes a container body with an opening portion and a stopper that closes the opening portion,
wherein a material constituting the stopper has a first oxygen permeability of 0.00010 (cc×mm/(mm²×day)) or more at a temperature of 23° C. and a relative humidity of 50%, and
the material constituting the stopper has a first water vapor permeability of 1.0 (mg×mm/(mm²×day)) or less at a temperature of 40° C. and a relative humidity of 90%.

2. The combined medical container containing a liquid medicine according to claim 1, wherein the stopper has a type A durometer hardness of 25 or more and 60 or less.

3. The combined medical container containing a liquid medicine according to claim 1, wherein the stopper has a type A durometer hardness of 25 or more and 45 or less.

4. The combined medical container containing a liquid medicine according to claim 1, wherein a portion of the stopper facing the opening portion has an average thickness of 0.5 mm or more and 10 mm or less.

5. The combined medical container containing a liquid medicine according to claim 1, wherein the opening portion has an area of 25 mm² or more and 1000 mm² or less.

6. The combined medical container containing a liquid medicine according to claim 1, wherein the stopper contains a compound with a main backbone of a siloxane bond.

7. The combined medical container containing a liquid medicine according to claim 1, wherein
the first container includes a vial, and
the container body includes a glass bottle.

8. The combined medical container containing a liquid medicine according to claim 1, wherein
the first container includes a syringe, and
the syringe includes a cylinder that contains the liquid medicine and constitutes the container body, and a piston that is inserted into the cylinder.

9. The combined medical container containing a liquid medicine according to claim 8, wherein the piston includes a gasket that is inserted into the cylinder and constitutes the stopper.

10. The combined medical container containing a liquid medicine according to claim 8, wherein
the cylinder includes a cylinder body into which the piston is inserted, and a needle that is coupled to the cylinder body and has the opening portion, and
the stopper is punctured with the needle and closes the opening portion of the needle.

11. The combined medical container containing a liquid medicine according to claim 8, wherein
the cylinder includes a cylinder body into which the piston is inserted and that has the opening portion, and a needle that can be fixed to the cylinder body to cover the opening portion, and
the stopper is fixably attached to the cylinder body to close the opening portion.

12-17. (canceled)

18. A medical container set comprising:
a first container for containing a liquid medicine;
a second container for storing the first container, and
an oxygen absorber for absorbing oxygen in the second container,
wherein the second container has an oxygen barrier property,
the first container includes a container body with an opening portion and a stopper that closes the opening portion,
a material constituting the stopper has a first oxygen permeability of 0.00010 (cc×mm/(mm²×day)) or more at a temperature of 23° C. and a relative humidity of 50%, and
the material constituting the stopper has a first water vapor permeability of 1.0 (mg×mm/(mm²×day)) or less at a temperature of 40° C. and a relative humidity of 90%.

19-20. (canceled)

21. A method for producing the combined medical container containing a liquid medicine according to claim 1, the method comprising the steps of:
closing the opening portion of the container body of the first container containing the liquid medicine with a stopper to prepare the first container containing the liquid medicine; and
storing the first container containing the liquid medicine in the second container.

22. A method for producing the combined medical container containing a liquid medicine according to claim 1, the method comprising the steps of:
storing the first container in the second container; and
closing the second container.

23. A method for producing a container containing a liquid medicine using the combined medical container containing a liquid medicine according to claim 1, the method comprising the steps of:
closing the second container storing the first container;
absorbing oxygen in the second container with the oxygen absorber to adjust an oxygen concentration; and
covering the stopper of the first container with a second stopper, or closing the container body of the first container with a second stopper with an oxygen barrier property instead of the stopper of the first container,
wherein in the step of adjusting the oxygen concentration, oxygen in the first container permeates the first container, moves to an outside of the first container, and is absorbed by the oxygen absorber in the second container.
